(19) United States
(12) Patent Application Publication
(10) Pub. No.: US 2026/0208645 A1
(43) Pub. Date: Jul. 23, 2026

(54) ARMREST FOR VEHICLE SEAT

(71) Applicant: Nivel Parts & Manufacturing Co., LLC, Jacksonville, FL (US)

(72) Inventors: Matthew Brian Fields, Yulee, FL (US); Zachary Tivis Cantrell, Jacksonville, FL (US); Walter Wagner, Jacksonville, FL (US); Joseph Anastacio Higuera, Jacksonville, FL (US)

(21) Appl. No.: 19/451,606

(22) Filed: Jan. 16, 2026

Related U.S. Application Data
(60) Provisional application No. 63/746,478, filed on Jan. 17, 2025.

(51) Int. Cl. B60N 2/75; B60N 2/68; B60N 2/90

(52) U.S. Cl. CPC B60N 2/753; B60N 2/68; B60N 2/90

(57) ABSTRACT

A seat assembly for a vehicle includes a seat frame assembly, an armrest assembly coupled to the seat frame assembly and including a mounting bracket coupled to the seat frame assembly and an armrest pivotably mounted on the mounting bracket and configured to be moved between a deployed position and a stowed position. The armrest assembly further includes an actuator or an elastic member mounted on the armrest and on at least one of the seat frame assembly or the mounting bracket. The actuator or the elastic member is configured to move the armrest to the deployed position in response to the armrest having been moved away from the deployed position to the stowed position or any position between the stowed position and the deployed position.

### CROSS-REFERENCE TO RELATED APPLICATIONS

This non-provisional application claims the benefit and priority, under 35 U.S.C. § 119(e) and any other applicable laws and statutes, to U.S. Provisional Application Ser. No. 63/746,478 filed on Jan. 17, 2025, the entire disclosure of which is incorporated herein by reference.

### BACKGROUND

The present disclosure relates to vehicular seating arrangements and assemblies, in particular for armrests and hip restraints for vehicle seats.

### SUMMARY

According to a first aspect of the present disclosure, a seat assembly for a vehicle includes a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket.

The first armrest assembly further includes at least one of a first actuator or a first elastic member mounted on the pivot rod of the first armrest and on at least one of the seat frame assembly or the mounting bracket, the at least one of the first actuator or the first elastic member configured to move the first armrest to the deployed position in response to the first armrest having been moved away from the deployed position to the stowed position or any position between the stowed position and the deployed position.

In some embodiments, the at least one of the first actuator or the first elastic member is movable between a starting position in which the first armrest is in the deployed position and an engaged position in which the first armrest is in the stowed position or any position between the stowed position and the deployed position.

In some embodiments, the at least one of the first actuator or the first elastic member is configured to generate a force on the first armrest in response to being in the engaged position as to bias the first armrest toward the deployed position, and, in response to the force being greater than a movement force being applied to the first armrest for moving the first armrest from the deployed position toward the stowed position, the at least one of the first actuator or the first elastic member moves the first armrest into the deployed position.

In some embodiments, the pivot rod rotates in a first rotational direction in response to the first armrest moving toward the stowed position, and the pivot rod rotates in a second rotational direction opposite the first rotational direction in response to the first armrest moving toward the deployed position.

In some embodiments, the at least one of the first actuator or the first elastic member is configured to generate the force on the first armrest in the second rotational direction in response to being in the engaged position as to bias the first armrest to the deployed position.

In some embodiments, the at least one of the first actuator or the first elastic member includes a gas spring.

In some embodiments, the gas spring includes a hollow cylinder, a piston arranged within the hollow cylinder and movable therein, and a piston rod coupled to the piston and extending outwardly away from the hollow cylinder.

In some embodiments, the first armrest is configured to return to the deployed position via the biasing of the gas spring in response to a compression force of the gas spring being greater than a movement force being applied to the first armrest for moving the first armrest from the deployed position toward the stowed position.

In some embodiments, the pivot rod further includes a connection plate, a first end of the connection plate is coupled to and extends radially away from the pivot rod, the first actuator or the first elastic member includes a first end and a second end opposite the first end, the second end of the first actuator or the first elastic member is spaced apart in a rearward direction from the pivot rod, and the connection plate further includes a second end opposite the first end that is coupled to the second end of the first actuator or the first elastic member.

In some embodiments, the second end of the first actuator or the first elastic member is pivotably coupled to the second end of the connection plate so as to enable to the connection plate to pivot relative to the first actuator or the first elastic member during movement of the first armrest between the deployed and stowed positions.

In some embodiments, the mounting bracket includes a first wall, a second wall spaced apart from the first wall, and a forward wall extending between and interconnecting the first and second walls, and the first support bar of the seat back frame is coupled to at least one of the first and second walls.

In some embodiments, the first support bar of the seat back frame extends between the first and second walls and is coupled to both of the first and second walls so as to couple the mounting bracket to the seat back frame.

In some embodiments, the first and second walls include corresponding openings formed therethrough, and the pivot rod of the first armrest extends through the openings of the first and second walls such that the first armrest is configured to pivot relative to the mounting bracket.

According to a further aspect of the present disclosure, an armrest assembly for a vehicle includes a mounting bracket configured to be coupled to a seat frame assembly of the vehicle, a first armrest pivotably mounted on the mounting bracket and configured to be moved between a deployed position and a stowed position, the first armrest including a pivot rod extending through the mounting bracket so as to enable pivoting of the first armrest relative to the mounting bracket, and at least one of a first actuator or a first elastic member mounted on the pivot rod of the first armrest and configured to be mounted on at least one of the seat frame assembly of the vehicle or the mounting bracket, the at least one of the first actuator or the first elastic member configured to move the first armrest to the deployed position in response to the first armrest having been moved away from the deployed position to the stowed position or any position between the stowed position and the deployed position.

In some embodiments, the at least one of the first actuator or the first elastic member is configured to generate a force on the first armrest in response to being in the engaged position as to bias the first armrest toward the deployed position, and, in response to the force being greater than a movement force being applied to the first armrest for moving the first armrest from the deployed position toward the stowed position, the at least one of the first actuator or the first elastic member moves the first armrest into the deployed position.

In some embodiments, the at least one of the first actuator or the first elastic member includes a gas spring, and the first armrest is configured to return to the deployed position via the biasing of the gas spring in response to a compression force of the gas spring being greater than a movement force being applied to the first armrest for moving the first armrest from the deployed position toward the stowed position.

In some embodiments, the at least one of the first actuator or the first elastic member includes a linear actuator, the linear actuator includes a hollow cylinder, a piston rod extending outwardly away from the hollow cylinder, and a motor configured to move the piston rod away from and toward the hollow cylinder, and the motor is operably connected to the piston rod and is configured to selectively move the piston rod away from and toward the hollow cylinder, and, in response to the first armrest having been moved away from the deployed position to the stowed position or any position between the stowed position and the deployed position, the motor is configured to move the piston rod away from the hollow cylinder until the first armrest returns to the deployed position.

In some embodiments, the at least one of the first actuator or the first elastic member includes a tension spring, a first end of the tension spring is coupled to the seat back frame and a second end of the tension spring opposite the first end is coupled to a connection plate that is coupled to and extends radially away from the pivot rod, and, in response to the first armrest being in the deployed position, the tension spring is in the starting position in which the spring is at rest and a first connection point at which the first end of the tension spring is coupled to the seat back frame is a first distance from a second connection point at which the second end of the tension spring is coupled to the connection plate, in response to the first armrest being in the stowed position, the tension spring is in the engaged position in which the tension spring is stretched such that the first connection point is located a second distance away from the first connection point, and the first distance is less than the second distance.

In some embodiments, the at least one of the first actuator or the first elastic member includes a torsion spring, the torsion spring includes a central coil that is wrapped around the pivot rod and includes a first end and a second end opposite the first end, and the first armrest is configured to return to the deployed position via the biasing of the torsion spring in response to a spring force of the torsion spring being greater than a movement force being applied to the first armrest for moving the first armrest from the deployed position toward the stowed position.

According to a further aspect of the present disclosure, a method includes providing a seat frame assembly of a vehicle including a seat bottom frame and a seat back frame extending upwardly away from the seat bottom frame, the seat back frame including a first support bar, coupling a mounting bracket of a first armrest assembly to the first support bar of the seat back frame, pivotably mounting a first armrest of the first armrest assembly on the mounting bracket, the first armrest being configured to be moved between a deployed position and a stowed position, the first armrest including a pivot rod extending through the mounting bracket so as to enable pivoting of the first armrest relative to the mounting bracket, and mounting at least one of a first actuator or a first elastic member on the pivot rod of the first armrest and on at least one of the seat frame assembly or the mounting bracket, the at least one of a first actuator or a first elastic member configured to move the first armrest to the deployed position in response to the first armrest having been moved away from the deployed position to the stowed position or any position between the stowed position and the deployed position.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

FIG. 1 is a perspective partial cutaway view of a seat assembly for a vehicle according to a first aspect of the present disclosure, showing that the seat assembly includes a seat frame assembly and an armrest assembly coupled to the seat frame assembly, the armrest assembly including an armrest and at least one of an actuator or an elastic member mounted on the pivot rod of the armrest and on at least one of the seat frame assembly or a mounting bracket, the actuator or elastic member being configured to move the armrest to the deployed position in response to the armrest having been moved away from the deployed position to the stowed position or any position between the stowed position and the deployed position;

FIG. 2A is a perspective view of the seat assembly of FIG. 1, showing the armrest in the stowed position and an actuator in an engaged position in which the actuator is configured return the armrest to the deployed position;

FIG. 2B is a perspective view of the seat assembly of FIG. 1, showing the armrest in the deployed position;

FIG. 3 is as perspective view of a vehicle with which the seat assembly of FIG. 1 may be utilized, showing as a non-limiting example the vehicle being a golf cart and an occupant seated on the seat assembly;

FIG. 4A is a perspective view of the seat assembly of FIG. 1, showing a seat back and a seat bottom and armrests on outer sides of the seat back arranged in the deployed position;

FIG. 4B is a perspective view of the seat assembly of FIG. 4A, showing one of the armrests in the stowed position;

FIG. 5A is a side view of the seat assembly of FIG. 1, showing a seat back frame of the seat frame assembly and the armrest pivotably coupled to the seat back frame via a mounting bracket, and showing the armrest in the deployed position;

FIG. 5B is a side view of the seat assembly of FIG. 5A, showing the armrest in the stowed position;

FIG. 6A is a perspective view of the armrest of the seat assembly of FIG. 1, showing a cushioned cover of the armrest which has a main portion and a cantilevered portion extending away from the main portion;

FIG. 6B is a front view of the armrest of FIG. 6A, showing that the armrest further includes a pivot rod extending inwardly away from the main portion of the armrest;

FIG. 6C is a top view of the armrest of FIG. 6B;

FIG. 6D is a cutaway perspective view of the armrest of FIG. 6A, showing that the cushioned cover is supported by an inner frame member having a main portion and a cantilevered portion extending away from the main portion, the main portion and the cantilevered portion being shaped complimentarily to each other;

FIG. 6E is a side view of the inner frame member of the armrest of FIG. 6D;

FIG. 7A is a side view of the seat assembly of FIG. 1, showing the seat back frame and the armrest pivotably coupled to the seat back frame via the mounting bracket, showing the armrest in the deployed position, and showing a gas spring as the first actuator, the gas spring being in a starting position;

FIG. 7B is a side view of the seat assembly of FIG. 7A, showing the armrest having been moved to the stowed position, and showing the gas spring in an engaged position in which it is loaded to return the armrest to the deployed position once a movement force being applied to the armrest to move the armrest to the stowed position is overcome by the force of the gas spring;

FIG. 8A is a perspective view of the seat assembly of FIG. 1, showing an inner perspective view of the seat back frame, the first armrest assembly including the armrest in the deployed position, the pivot rod of the armrest extending through the mounting bracket which is coupled to a support bar of the seat back frame, and the gas spring being coupled to the pivot rod via a connection plate;

FIG. 8B is a perspective view of the seat assembly of FIG. 8A, showing an inner perspective view with the armrest having been moved to the stowed position and the gas spring in the engaged position;

FIG. 9A is a rear view of the mounting bracket of the armrest assembly of FIG. 1, showing that the mounting bracket includes tabs extending inwardly from first and second walls of the mounting bracket that are configured to delimit movement of the armrest in a first rotational direction toward the stowed position via a movement delimiting extension extending away from the pivot rod contacting one of the tabs;

FIG. 9B is a side view of the mounting bracket of FIG. 9A, showing that the first and second walls include corresponding openings formed therethrough, the pivot rod of the first armrest being configured to extend through the openings;

FIG. 10A is a perspective view of the mounting bracket and gas spring of the seat assembly of FIG. 1, showing the pivot rod extending through the mounting bracket and the mounting bracket including a forward wall that has openings formed therethrough, and showing the movement delimiting extension extending away from the pivot rod contacting a bottom side of an opening in response to the pivot rod, and thus the first armrest, being in the deployed position;

FIG. 10B is a top view of the mounting bracket and pivot rod of the seat assembly of FIG. 10A, showing the movement delimiting extension contacting the bottom side of an opening;

FIG. 10C is a perspective view of the mounting bracket and gas spring of the seat assembly of FIG. 10A, showing the movement delimiting extension contacting one of the tabs of the mounting bracket in response to the pivot rod, and thus the first armrest, being in the deployed position;

FIG. 10D is a top view of the mounting bracket and pivot rod of the seat assembly of FIG. 10C, showing the movement delimiting extension contacting one of the tabs of the mounting bracket;

FIG. 11A is a front view of the seat assembly of FIG. 1 when the armrest is in the deployed position;

FIG. 11B is a rear view of the seat assembly of FIG. 1 when the armrest is in the deployed position;

FIG. 11C is a front view of the seat assembly of FIG. 1 when the armrest is in the stowed position;

FIG. 11D is a rear view of the seat assembly of FIG. 1 when the armrest is in the stowed position;

FIG. 12A is a side view of details of the gas spring, the connection plate, and the pivot rod of the first armrest assembly of the seat assembly of FIG. 1, showing these components when the armrest is in the deployed position, and showing that a bottom end of the gas spring is coupled to the seat back frame below the armrest;

FIG. 12B is a side view of details of the gas spring, the connection plate, and the pivot rod of the first armrest assembly of the seat assembly of FIG. 12A, showing these components when the armrest is in the stowed position;

FIG. 13A is a side view of an alternative position of the gas spring of the seat assembly of FIG. 12A, showing the armrest in the deployed position, the gas spring in the starting position, and the bottom end of the gas spring being coupled to a seat bottom frame of the seat frame assembly as opposed to the seat back frame as shown in FIG. 12A;

FIG. 13B is a side view of the seat assembly of FIG. 13A, showing the gas spring in the engaged position and the armrest is in the stowed position;

FIG. 14A is a side view of an alternative position of the gas spring of the seat assembly of FIG. 12A, showing the armrest in the deployed position, the gas spring in the starting position, and the bottom end of the gas spring being coupled to the seat back frame above the armrest as opposed to below the armrest as shown in FIG. 12A;

FIG. 14B is a side view of the seat assembly of FIG. 14A, showing the gas spring in the engaged position and the armrest is in the stowed position;

FIG. 15A is a side view of an alternative position of the gas spring of the seat assembly of FIG. 12A, showing the armrest in the deployed position, the gas spring in the starting position, and the bottom end of the gas spring being coupled to a rear frame assembly spaced apart from the seat back frame in the rearward direction as opposed to the seat back frame as shown in FIG. 12A;

FIG. 15B is a side view of the seat assembly of FIG. 15A, showing the gas spring in the engaged position and the armrest is in the stowed position;

FIG. 16A is a side view of an alternative position of the gas spring of the seat assembly of FIG. 12A, showing the armrest in the deployed position, the gas spring in the starting position, and the bottom end of the gas spring being coupled to the pivot rod as opposed to the seat back frame as shown in FIG. 12A;

FIG. 16B is a side view of the seat assembly of FIG. 16A, showing the gas spring in the engaged position and the armrest is in the stowed position;

FIG. 17A is a side view of an alternative position of the gas spring of the seat assembly of FIG. 12A, showing the armrest in the deployed position, the gas spring in the starting position, and the armrest assembly being arranged on a first support post that is part of the seat bottom frame and extends upwardly away from a first support bar of the seat bottom frame as opposed to the seat back frame as shown in FIG. 12A, and showing that a bottom end of the gas spring being coupled to the first support bar of the seat bottom frame of the seat frame assembly;

FIG. 17B is a side view of the seat assembly of FIG. 17A, showing the gas spring in the starting position and the armrest is in the deployed position;

FIG. 17C is a side view of the seat assembly of FIG. 17A, showing the gas spring in the engaged position and the armrest is in the stowed position;

FIG. 18A is a perspective view of a seat assembly for a vehicle according to a further aspect of the present disclosure, showing that the seat assembly includes a seat frame assembly and an armrest assembly coupled to the seat frame assembly, the armrest assembly including an armrest and at least one of an actuator or an elastic member mounted on the pivot rod of the armrest and on at least one of the seat frame assembly or a mounting bracket, the actuator or elastic member being configured to move the armrest to the deployed position in response to the armrest having been moved away from the deployed position to the stowed position or any position between the stowed position and the deployed position, and showing that the at least one of the actuator or the elastic member includes a linear actuator mounted on the seat back frame, the linear actuator being in a starting position and the armrest being in the deployed position;

FIG. 18B is a perspective view of the seat assembly of FIG. 18A, showing the linear actuator in an engaged position and the armrest in the stowed position;

FIG. 19A is a side view of a seat assembly for a vehicle according to a further aspect of the present disclosure, showing that the seat assembly includes a seat frame assembly and an armrest assembly coupled to the seat frame assembly, the armrest assembly including an armrest and at least one of an actuator or an elastic member mounted on the pivot rod of the armrest and on at least one of the seat frame assembly or a mounting bracket, the actuator or elastic member being configured to move the armrest to the deployed position in response to the armrest having been moved away from the deployed position to the stowed position or any position between the stowed position and the deployed position, and showing that the at least one of the actuator or the elastic member includes a rotary motor mounted on the mounting bracket, the rotary motor being in a starting position and the armrest being in the deployed position;

FIG. 19B is a side view of the seat assembly of FIG. 19A, showing the rotary motor in an engaged position and the armrest in the stowed position;

FIG. 19C is a perspective view of the seat assembly of FIG. 19A;

FIG. 20A is a perspective view of a seat assembly for a vehicle according to a further aspect of the present disclosure, showing that the seat assembly includes a seat frame assembly and an armrest assembly coupled to the seat frame assembly, the armrest assembly including an armrest and at least one of an actuator or an elastic member mounted on the pivot rod of the armrest and on at least one of the seat frame assembly or a mounting bracket, the actuator or elastic member being configured to move the armrest to the deployed position in response to the armrest having been moved away from the deployed position to the stowed position or any position between the stowed position and the deployed position, and showing that the at least one of the actuator or the elastic member includes a tension spring mounted on an upper portion of the seat back frame above the armrest, the tension spring being in a starting position and the armrest being in the deployed position;

FIG. 20B is a rear view of the seat assembly of FIG. 20A;

FIG. 20C is a perspective view of the seat assembly of FIG. 20A, showing the tension spring in an engaged position in which the tension spring is tensioned and the armrest in the stowed position;

FIG. 21A is a perspective view of a seat assembly for a vehicle according to a further aspect of the present disclosure, showing that the seat assembly includes a seat frame assembly and an armrest assembly coupled to the seat frame assembly, the armrest assembly including an armrest and at least one of an actuator or an elastic member mounted on the pivot rod of the armrest and on at least one of the seat frame assembly or a mounting bracket, the actuator or elastic member being configured to move the armrest to the deployed position in response to the armrest having been moved away from the deployed position to the stowed position or any position between the stowed position and the deployed position, and showing that the at least one of the actuator or the elastic member includes a torsion spring mounted inside the mounting bracket on the pivot rod of the armrest, the torsion spring being in a starting position and the armrest being in the deployed position;

FIG. 21B is a bottom view of the seat assembly of FIG. 21A, showing one end of the torsion spring contacting and engaging first and second inner protrusions of the mounting bracket;

FIG. 21C is a perspective view of the seat assembly of FIG. 21A with the mounting bracket removed, showing that an opposing end of the torsion spring includes a looped portion that loops around and is coupled to a forward-facing surface of a first protrusion of the pivot rod;

FIG. 21D is a side view of the seat assembly of FIG. 21A, showing the torsion spring in a starting position and the armrest in the deployed position, and showing the looped end of the torsion spring coupled to the first protrusion of the pivot rod and the other end of the torsion spring contacting and engaging one of the protrusions of the mounting bracket, shown in phantom;

FIG. 21E is a side view of the seat assembly of FIG. 21A, showing the torsion spring in an engaged position and the armrest in the stowed position, and showing the looped end of the torsion spring coupled to the first protrusion of the pivot rod and the other end of the torsion spring contacting and engaging one of the protrusions of the mounting bracket, shown in phantom, so as to bias the torsion spring in a second rotational direction toward the deployed position of the armrest;

FIG. 21F is a perspective view of the seat assembly of FIG. 21E, showing the torsion spring in the engaged position and the armrest in the stowed position;

FIG. 22A is a perspective view of a seat assembly for a vehicle according to a further aspect of the present disclosure, showing that the seat assembly includes a seat frame assembly and an armrest assembly coupled to the seat frame assembly, the armrest assembly including an armrest and at least one of an actuator or an elastic member mounted on the pivot rod of the armrest and on at least one of the seat frame assembly or a mounting bracket, the actuator or elastic member being configured to move the armrest to the deployed position in response to the armrest having been moved away from the deployed position to the stowed position or any position between the stowed position and the deployed position, and showing that the at least one of the actuator or the elastic member includes a clock spring mounted inside the mounting bracket on the pivot rod of the armrest, the clock spring being in a starting position and the armrest being in the deployed position;

FIG. 22B is a side view of the seat assembly of FIG. 22A;

FIG. 22C is a side view of the seat assembly of FIG. 22A, showing the clock spring in the engaged position and the armrest in the stowed position;

FIG. 23A is a perspective view of a seat assembly for a vehicle according to a further aspect of the present disclosure, showing that the seat assembly includes a seat frame assembly and an armrest assembly coupled to the seat frame assembly, the armrest assembly including an armrest and at least one of an actuator or an elastic member mounted on the pivot rod of the armrest and on at least one of the seat frame assembly or a mounting bracket, the actuator or elastic member being configured to move the armrest to the deployed position in response to the armrest having been moved away from the deployed position to the stowed position or any position between the stowed position and the deployed position, and showing that the at least one of the actuator or the elastic member includes a guided coil spring, the guided coil spring being in a starting position and the armrest being in the deployed position;

FIG. 23B is a perspective view of the seat assembly of FIG. 23A, showing the guided coil spring in the engaged position and the armrest in the stowed position;

FIG. 24A is perspective view of a seat assembly for a vehicle according to a further aspect of the present disclosure, showing a control system having a controller operably connected to sensors arranged throughout the seat assembly, such as, for example, in the seat bottoms, the seat backs, or adjacent to the armrests, and showing that the control system is also operably connected to an engine ignition and a drivetrain of the vehicle, the control system being configured to control movement of the armrest, the engine ignition, and the drivetrain in response to the presence of an occupant in the vehicle;

FIG. 24B is perspective view of the seat assembly of the FIG. 24A, showing that additional sensors such as a camera can be positioned in the vehicle; and

FIG. 24C is a schematic view of a controller and related components configured to be utilized with the seat assemblies described herein.

### DETAILED DESCRIPTION

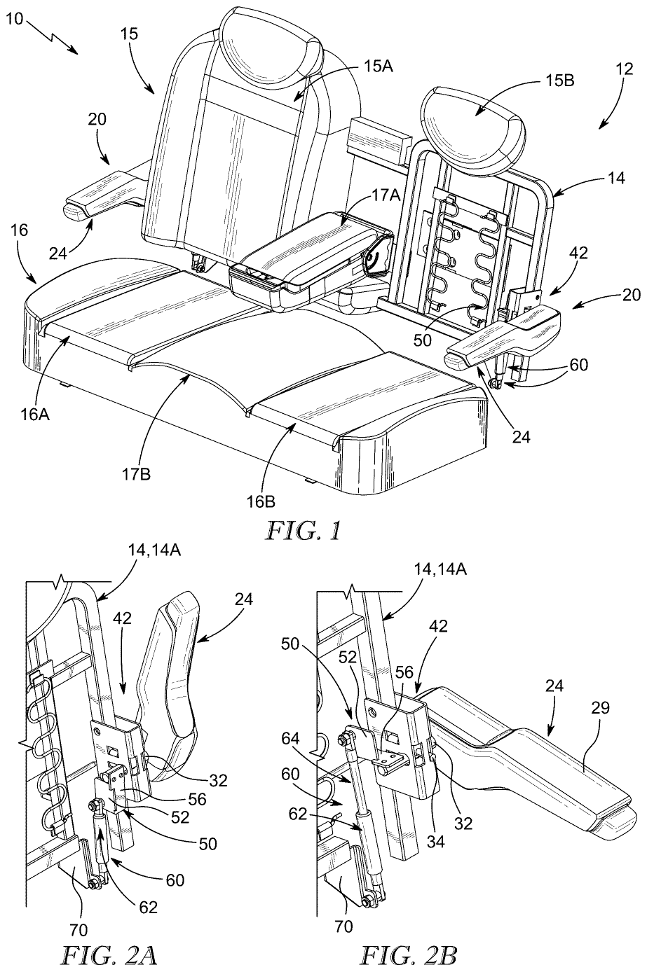

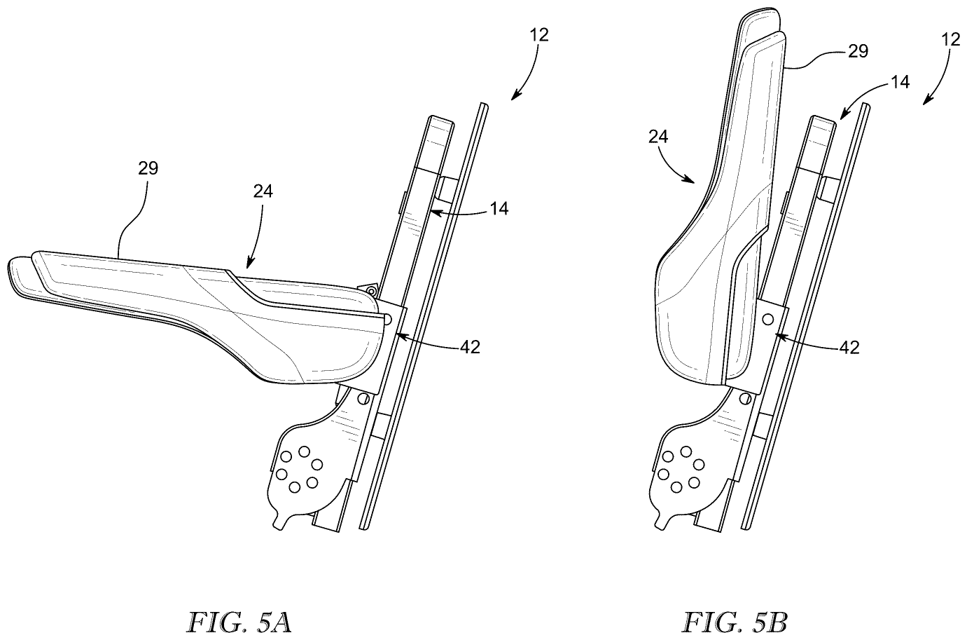

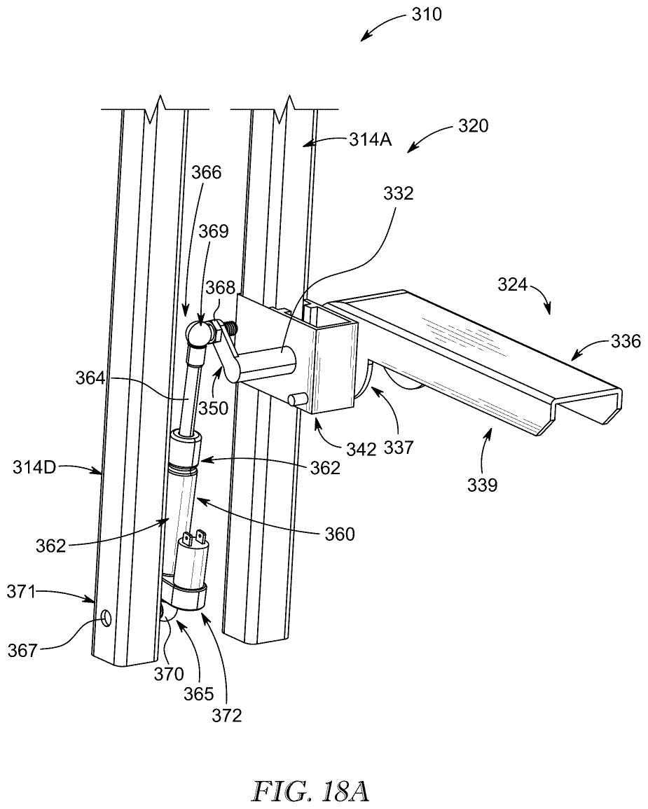

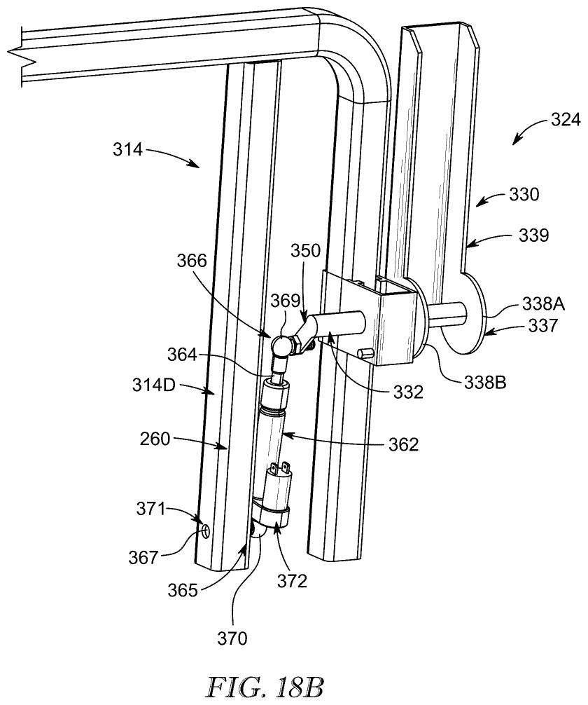

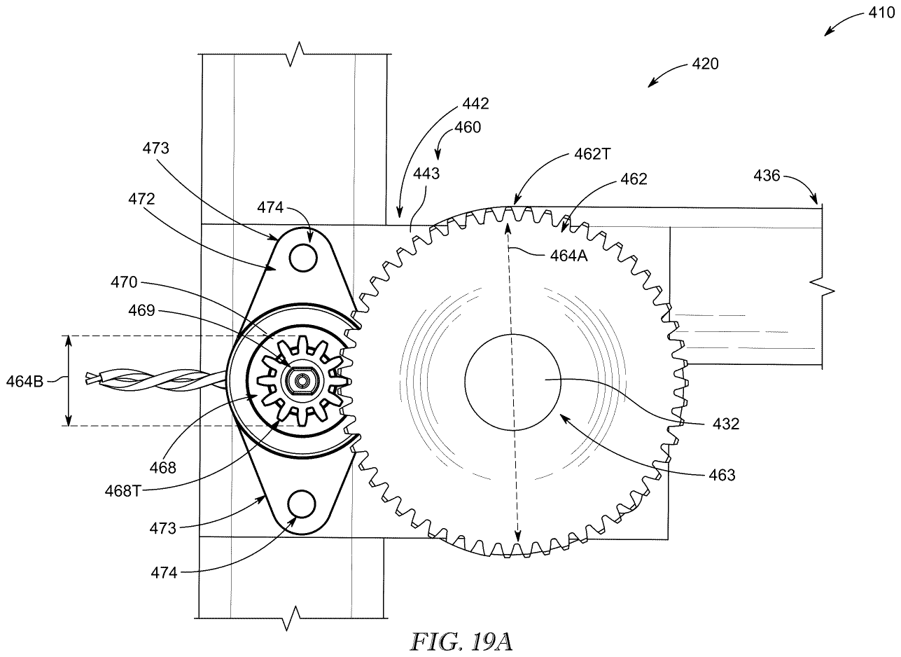

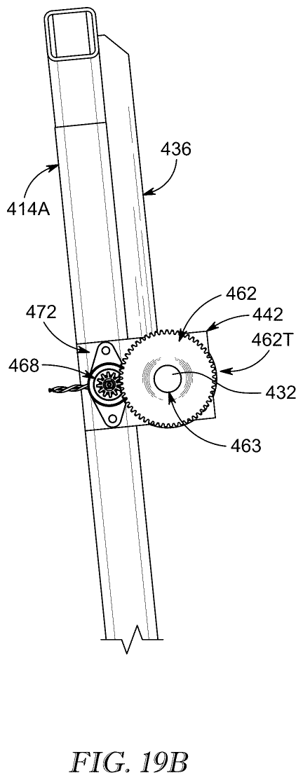

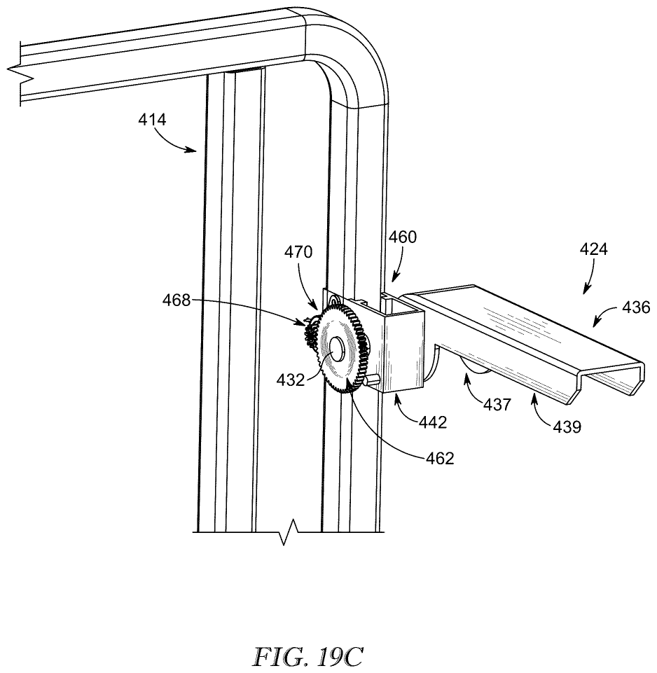

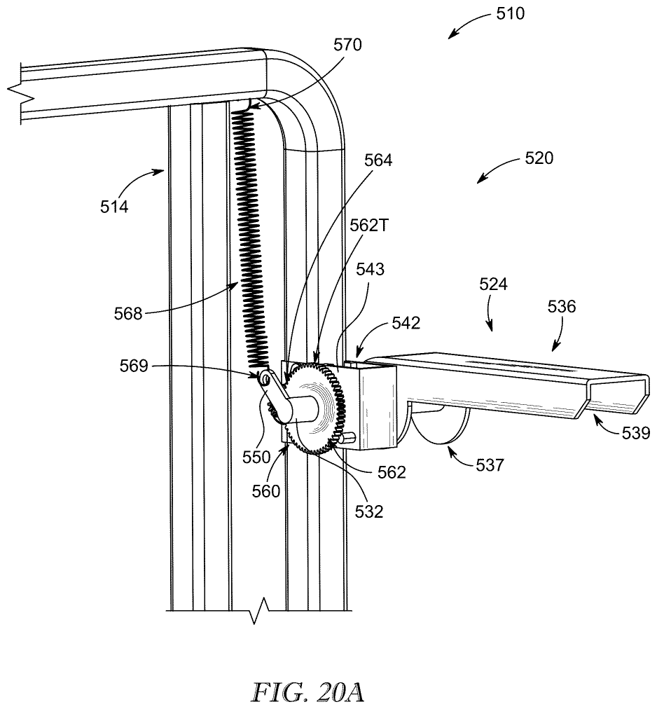

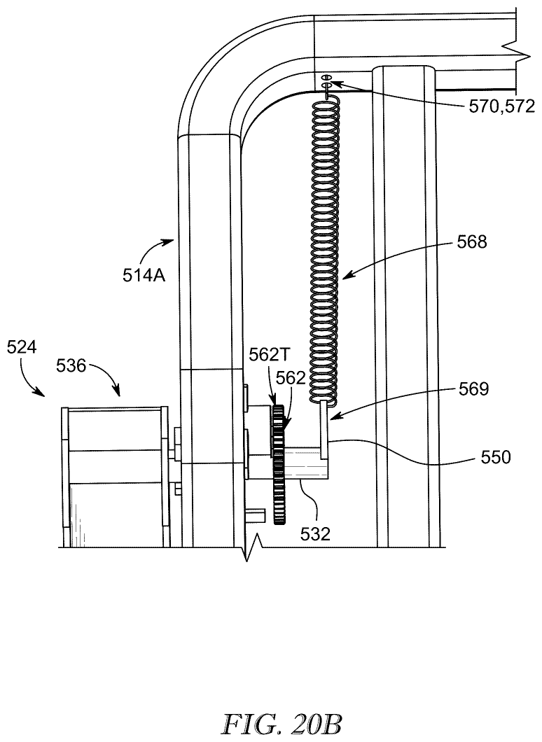

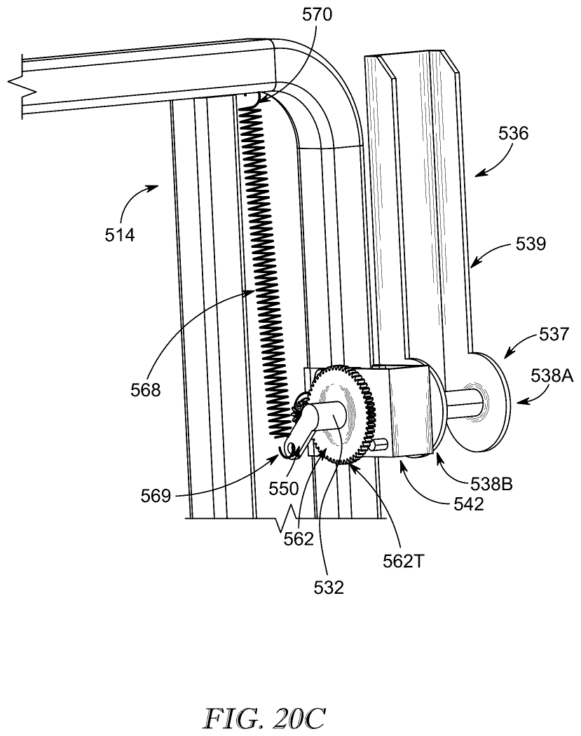

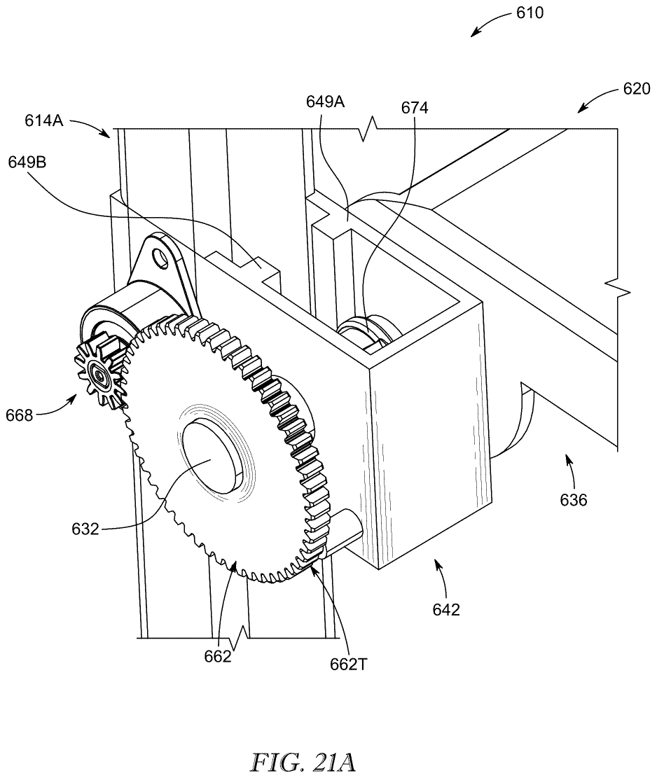

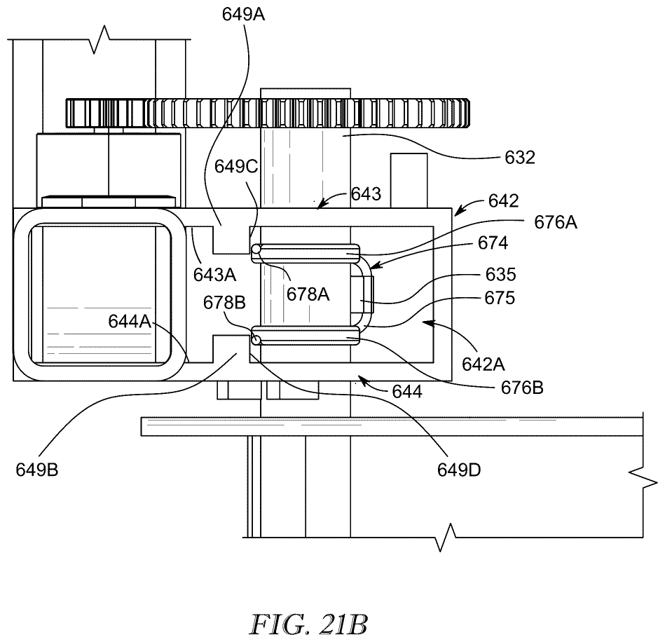

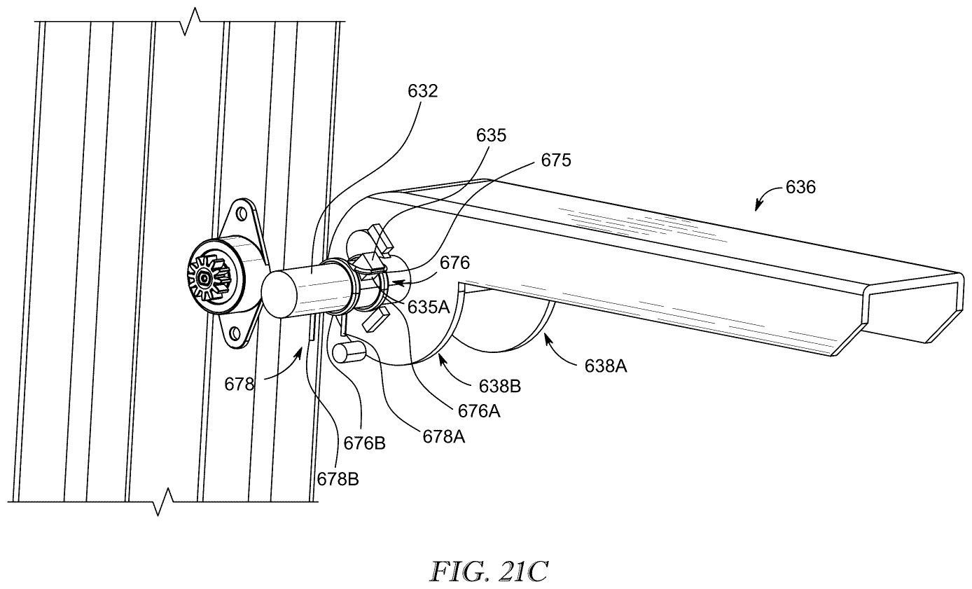

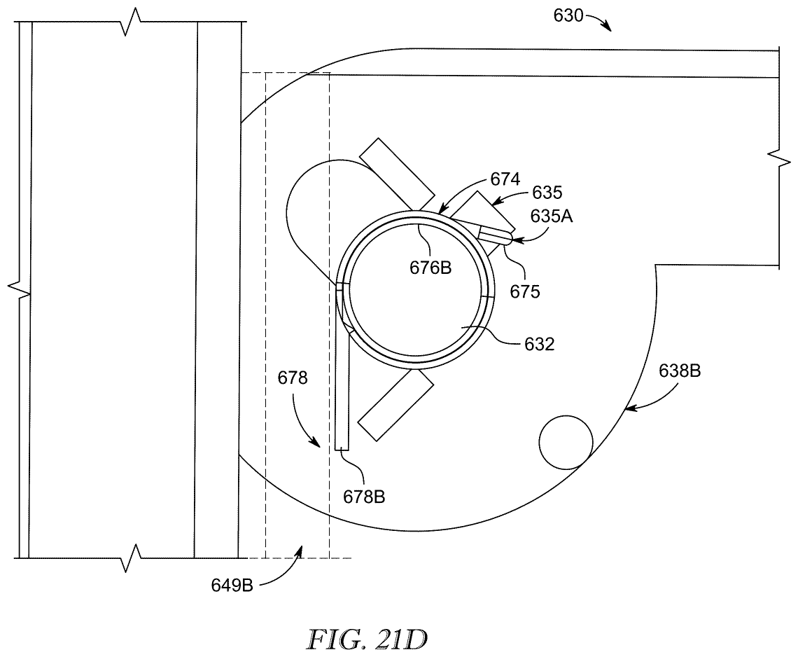

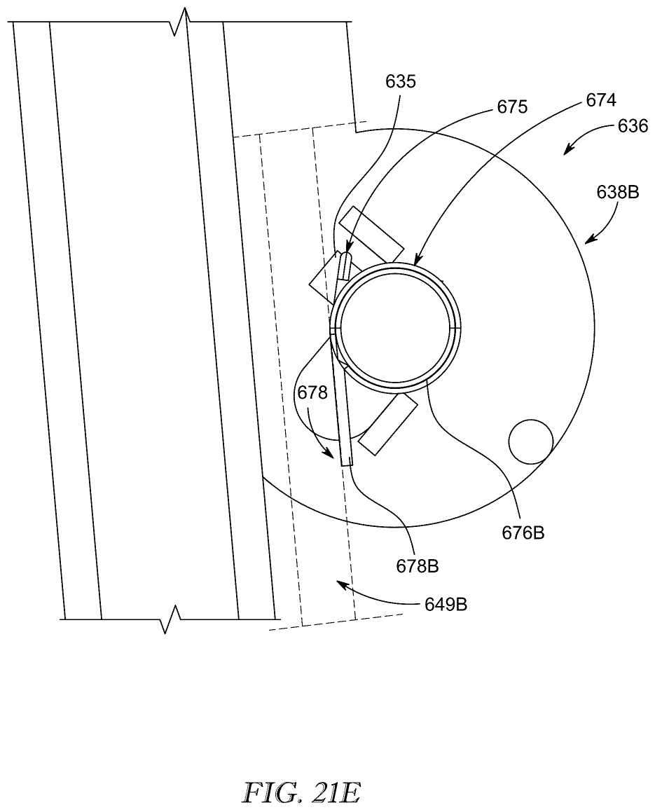

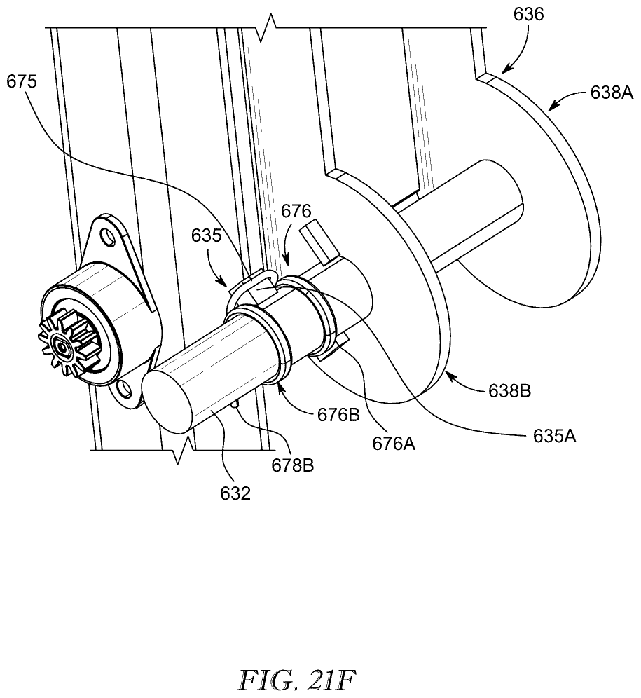

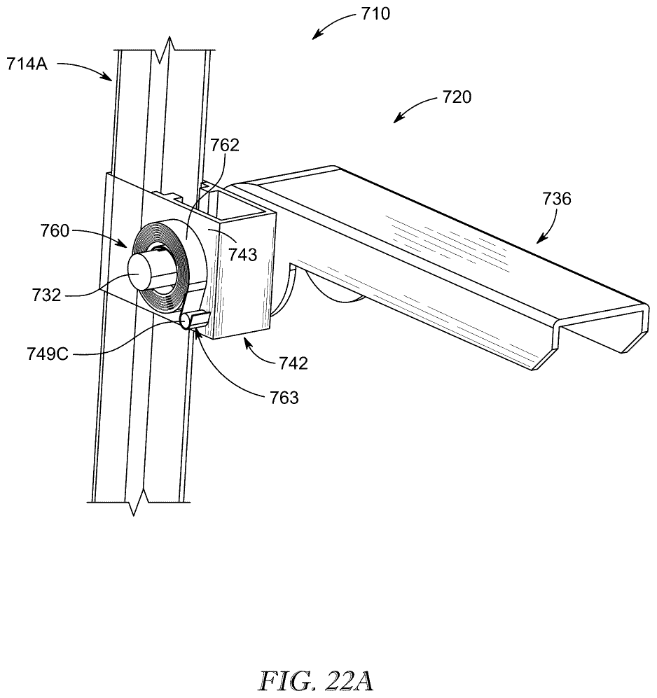

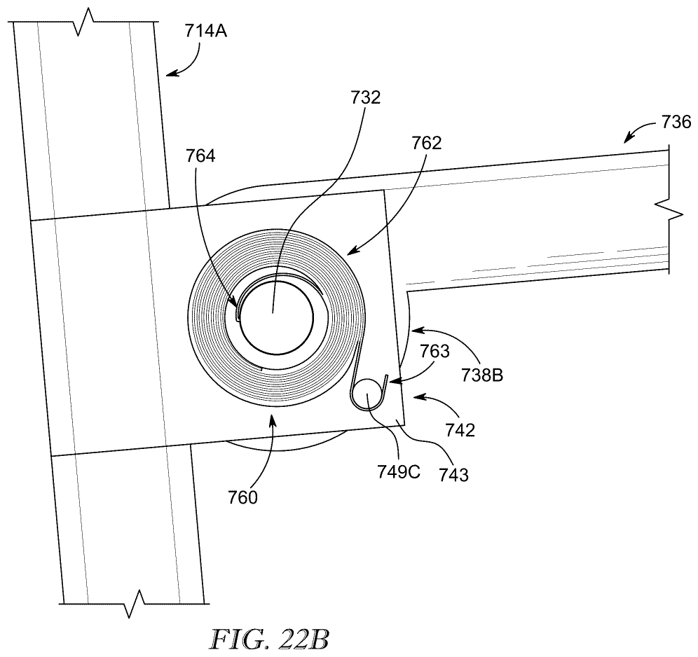

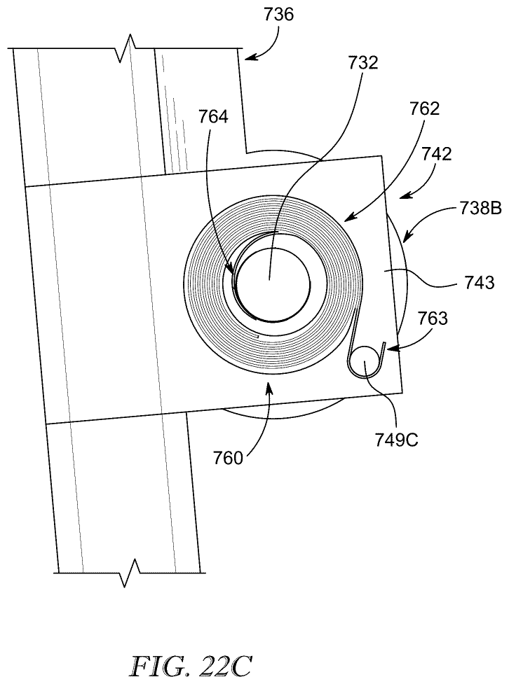

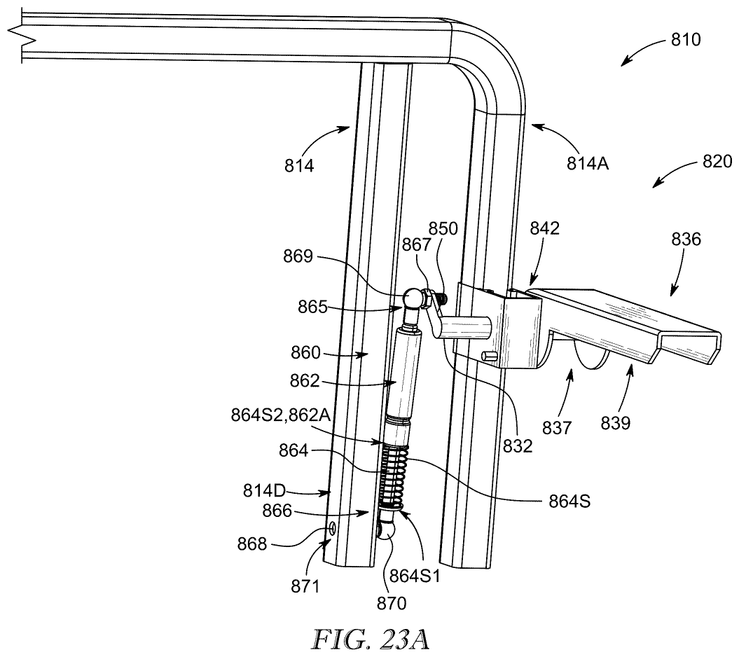

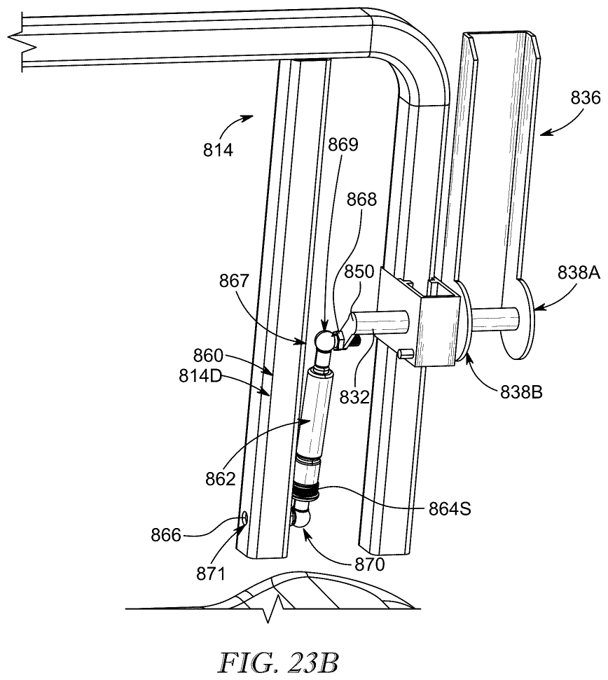

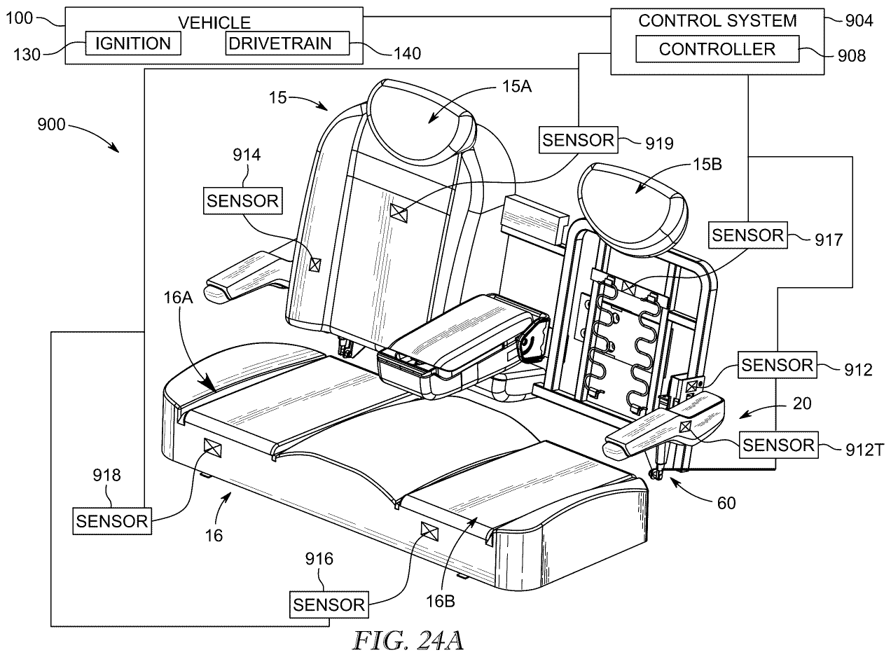

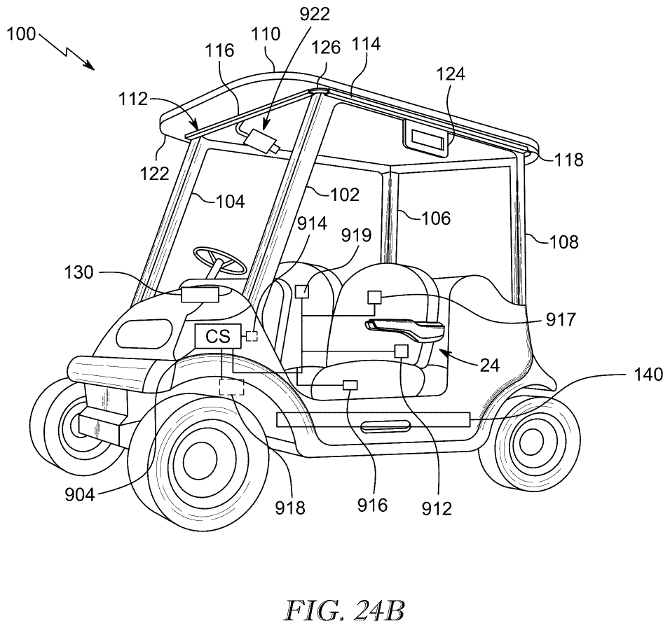

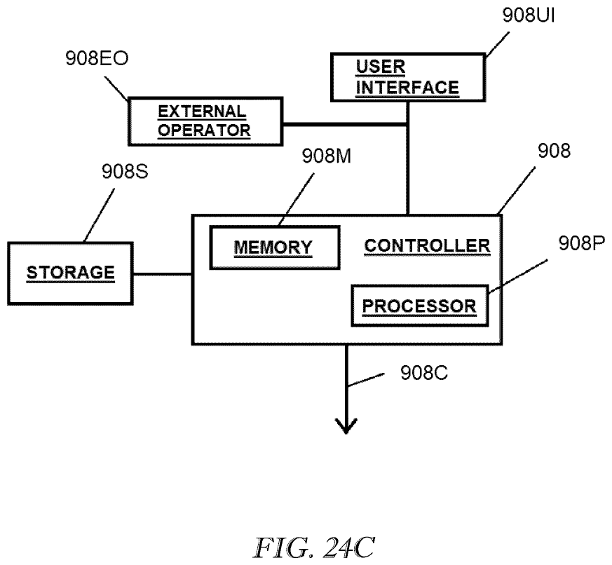

A seat assembly 10 including an armrest assembly 20 according to a first aspect of the present disclosure is shown in FIGS. 1-17C. A seat assembly 310 including an armrest assembly 320 according to a further aspect of the present disclosure is shown in FIGS. 18A and 18B. A seat assembly 410 including an armrest assembly 420 according to a further aspect of the present disclosure is shown in FIGS. 19A-19C. A seat assembly 510 including an armrest assembly 520 according to a further aspect of the present disclosure is shown in FIGS. 20A-20C. A seat assembly 610 including an armrest assembly 620 according to a further aspect of the present disclosure is shown in FIGS. 21A-21F. A seat assembly 710 including an armrest assembly 720 according to a further aspect of the present disclosure is shown in FIGS. 22A and 22B. A seat assembly 810 including an armrest assembly 820 according to a further aspect of the present disclosure is shown in FIGS. 23A and 23B. A seat assembly 900 including a control system 904 for controlling various components of any of the embodiments of seat assemblies described or envisioned herein is shown in FIGS. 24A-24C.

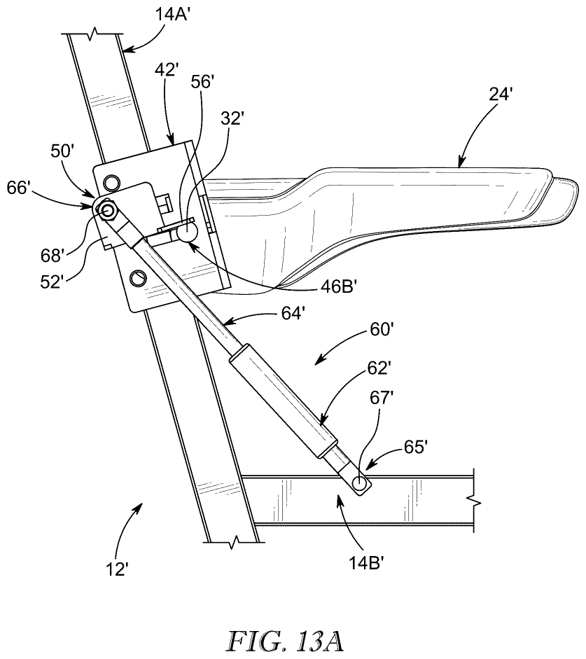

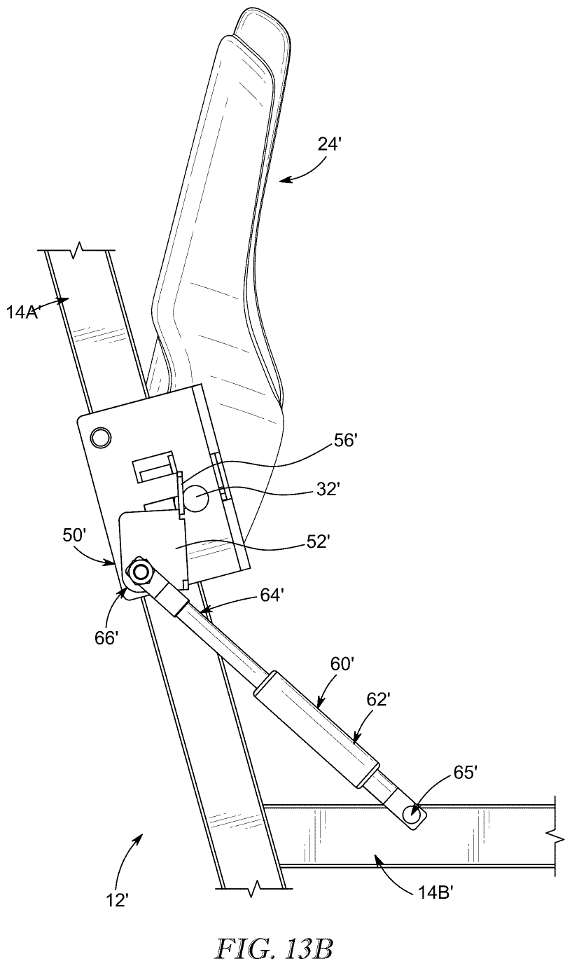

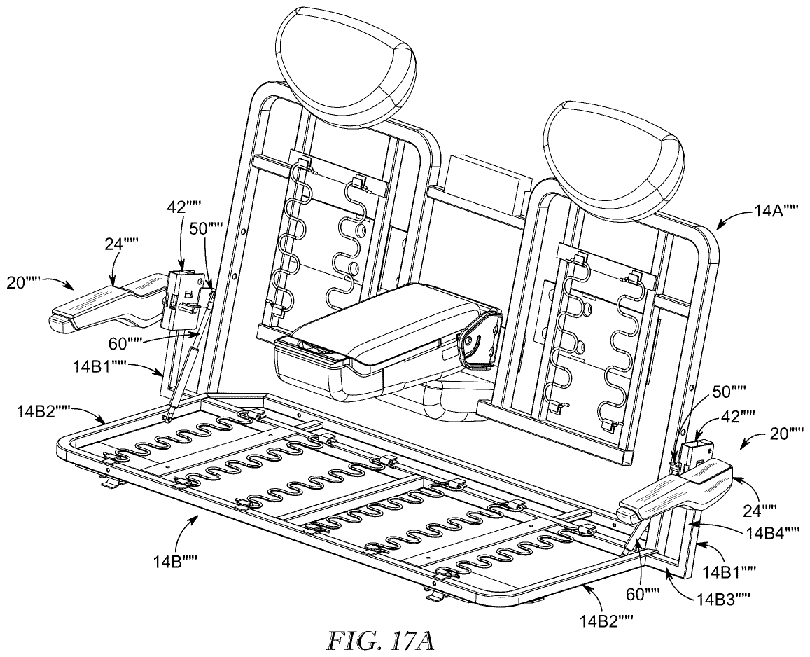

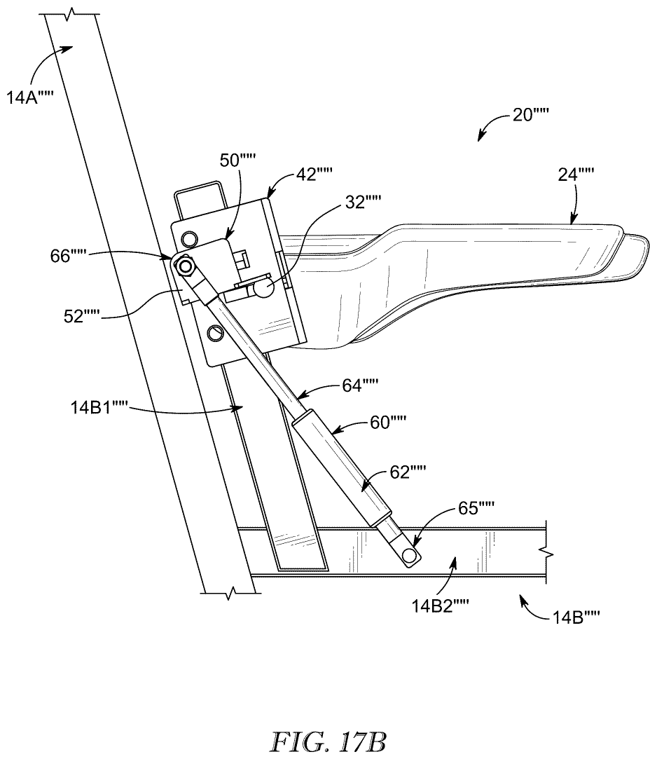

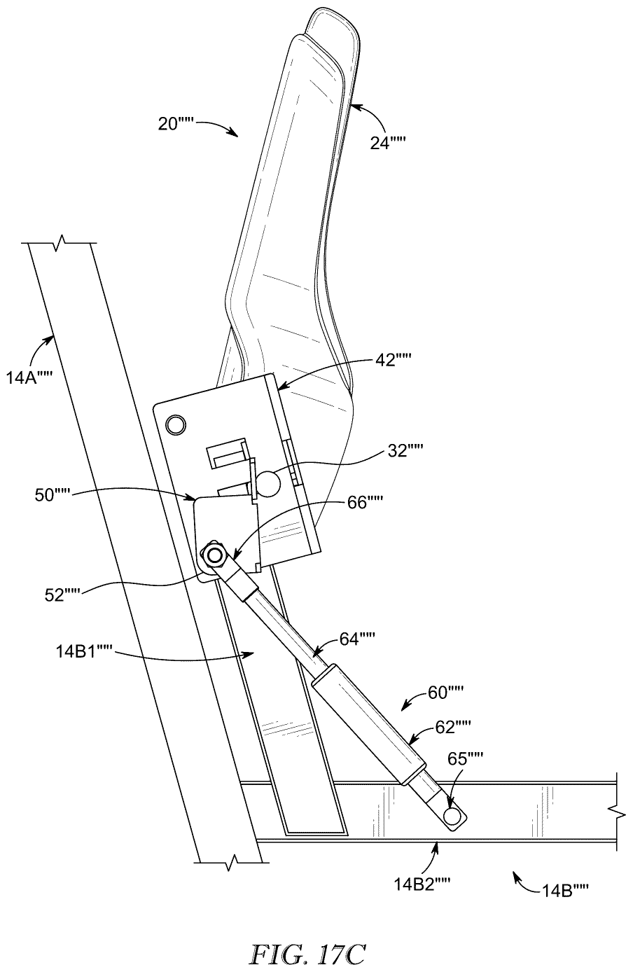

As can be seen in FIGS. 1-2B, the seat assembly 10 for a vehicle 100 includes a seat frame assembly 12 having a seat back frame 14 and a seat bottom frame (not shown in FIG. 1, shown in full in FIG. 17A by reference numeral 14B″″′ and partially shown in FIGS. 13A and 13B by reference numeral 14B′, the seat bottom frame being arranged within the seat bottom cushioned covers 16 similar to the seat back frame 14 arrangement within the seat back cushioned covers 15A, 15B). The seat back frame 14 extends upwardly away from the seat bottom frame. A first armrest assembly 20 is coupled to the seat frame assembly 12 and including a mounting bracket 42 coupled to the seat back frame 14 and a first armrest 24 pivotably mounted on the mounting bracket 42 and configured to be moved between a deployed position (FIG. 2B) and a stowed position (FIG. 2A).

For certain utility vehicles such as golf carts and the like, safety regulations require that any type of side restraint, such as a hip restraint or armrest, be in a lowered, deployed position during operation of the vehicle. Due to the typical lack of seat belts in these types of vehicles, having the side restraints in a deployed position is an important safety measure to ensure occupants of the vehicle do not slide out of or fall from the vehicle while the vehicle is moving.

Some vehicles that utilize armrests may include armrests that cannot be raised from a deployed position to ensure that these safety regulations are met. If armrests that could be moved away from the deployed position to a raised, stowed position or any position therebetween were utilized, it would run the risk of the vehicle being operated with the armrests not in the deployed position.

To ensure that the vehicle is only operated with the armrests in the deployed position, the armrest assembly 20 further includes at least one of an actuator 60 or an elastic member 60 mounted on a pivot rod 32 of the first armrest 24 and on at least one of the seat frame assembly 12 or the mounting bracket 42. The actuator 60 or the elastic member 60 is configured to move the armrest 24 to the deployed position in response to the armrest 24 having been moved away from the deployed position to the stowed position or any position between the stowed position and the deployed position. In some embodiments, such as in the seat assembly 900, sensors may be utilized to detect positions of the armrest 24 or presence of an occupant in the vehicle and control movement of the armrest 24 or operation of the vehicle.

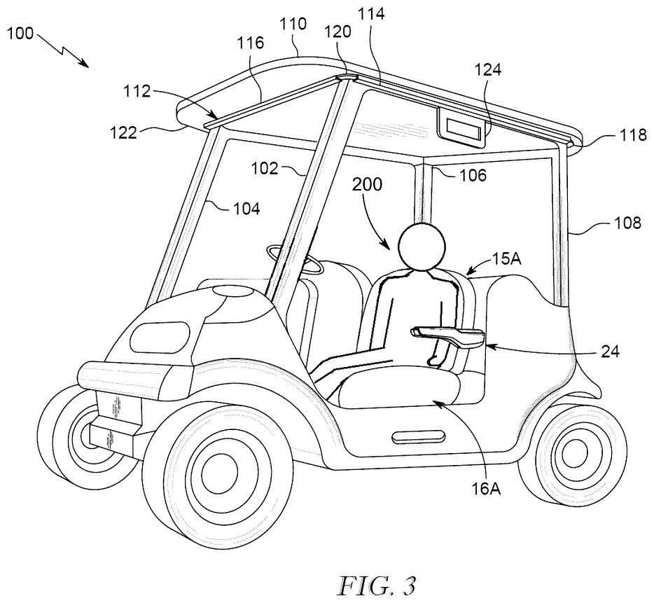

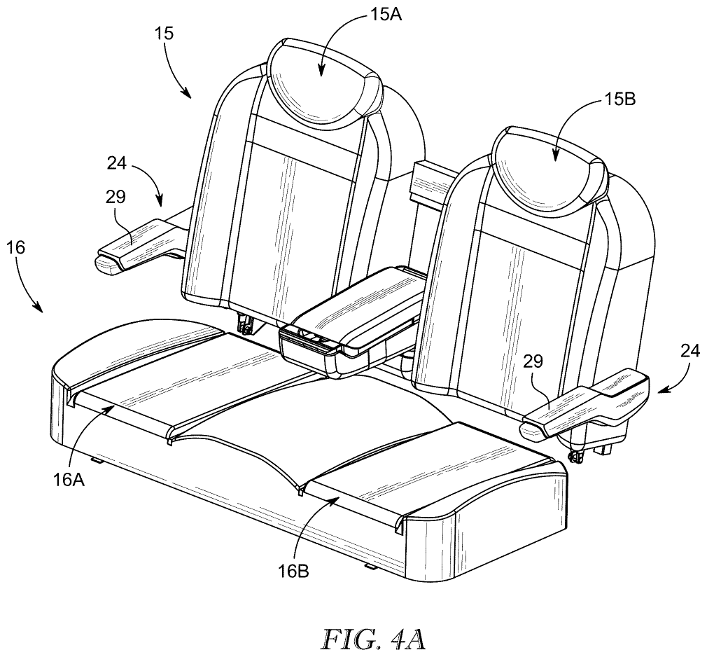

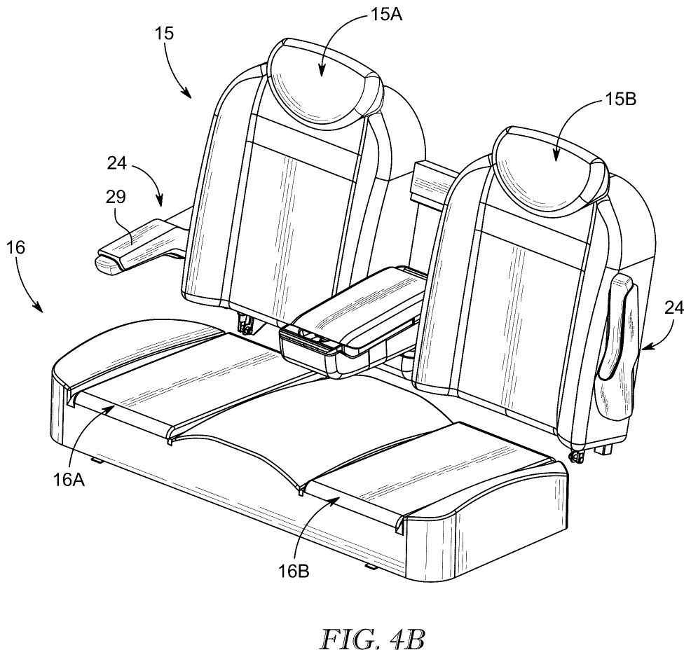

The seat assemblies 10, 310, 410, 510, 610, 710, 810, 900 described herein are configured to be utilized in a vehicle 100, in particular, for example, a utility vehicle or golf cart 100, as shown in FIG. 3. The utility vehicle or golf cart 100 may include four struts 102, 104, 106, 108 that support a roof assembly 110 of the cart 100. The roof assembly 110 may include a top frame 112 arranged between the struts 102, 104, 106, 108 and a roof 122 that includes side frame bars 114, a forward frame bar 116, and a rear frame bar 118. An occupant 200 may be seated in one of the passenger side or the driver side of the cart 100 (driver side seating shown in FIG. 3).

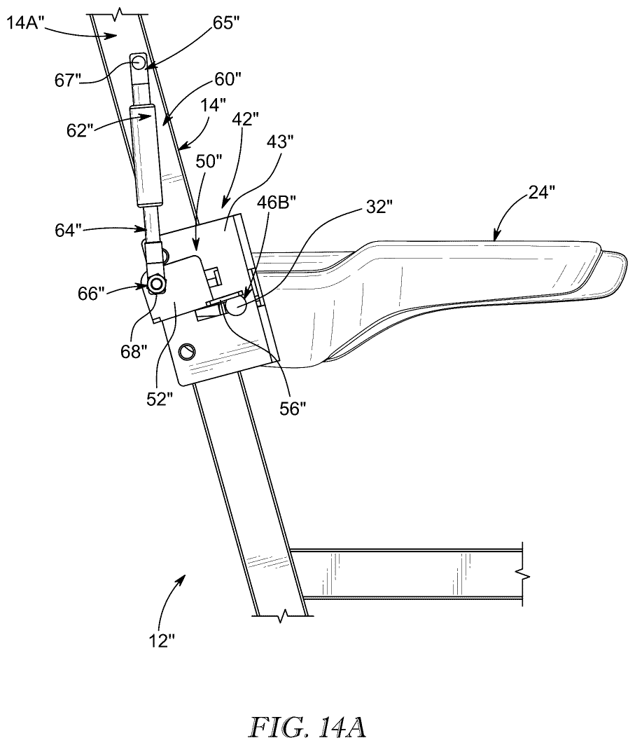

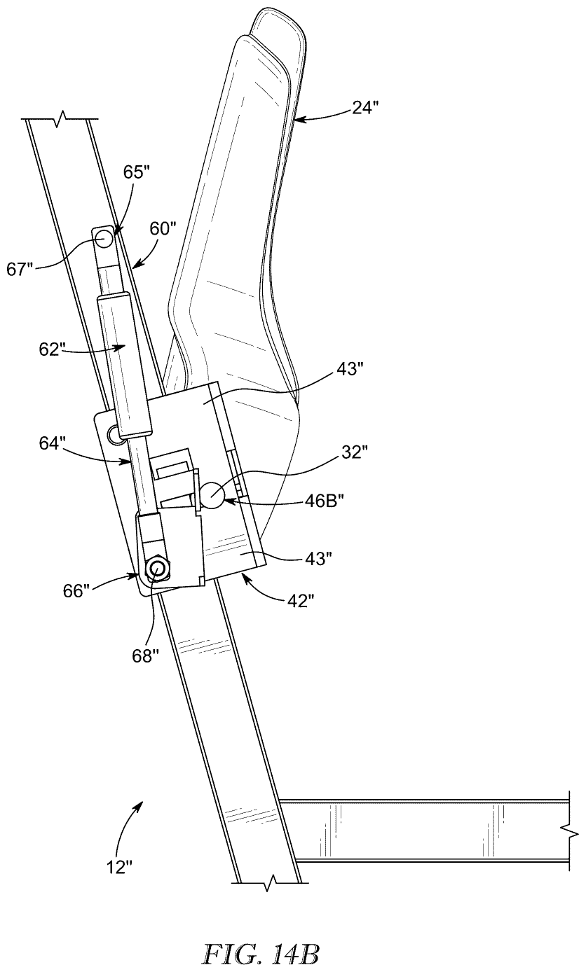

As shown in FIGS. 1-4B, the seat assembly 10 includes the seat frame assembly 12 which includes the seat back frame 14 defining a seat back 15 and the seat bottom frame (14B″″′ in FIGS. 17A-17C and 14B′ in FIGS. 13A and 13B) defining a seat bottom 16. The seat frame assembly 12 further includes a passenger side seat back cushioned cover 15A and a driver side seat back cushioned cover 15B. The seat frame assembly 12 further includes a passenger side seat bottom cushioned cover 16A and a driver side seat bottom cushioned cover 16B. A central elbow rest 17A can be arranged between the passenger and driver side seat back cushioned covers 15A, 15B. It should be understood that, although the components of the armrest assembly 20 are described with regard to the driver side of the seat assembly 10, the same components can be utilized on the passenger side of the seat assembly 10 as well.

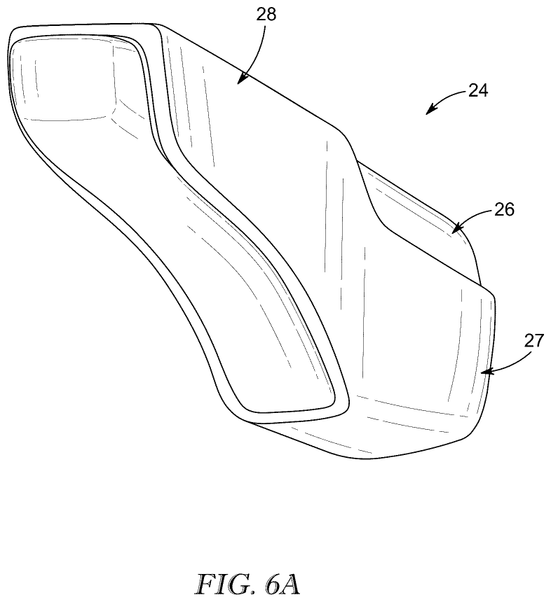

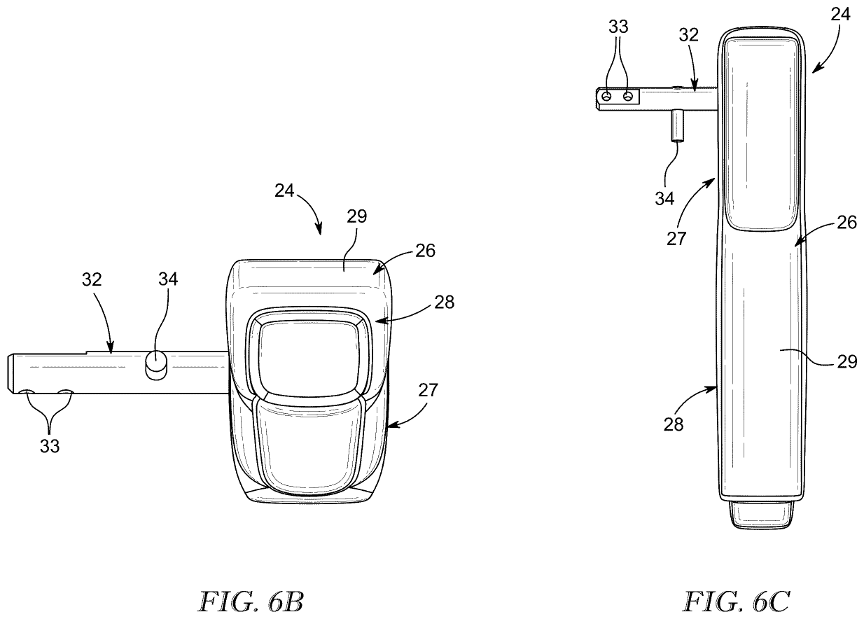

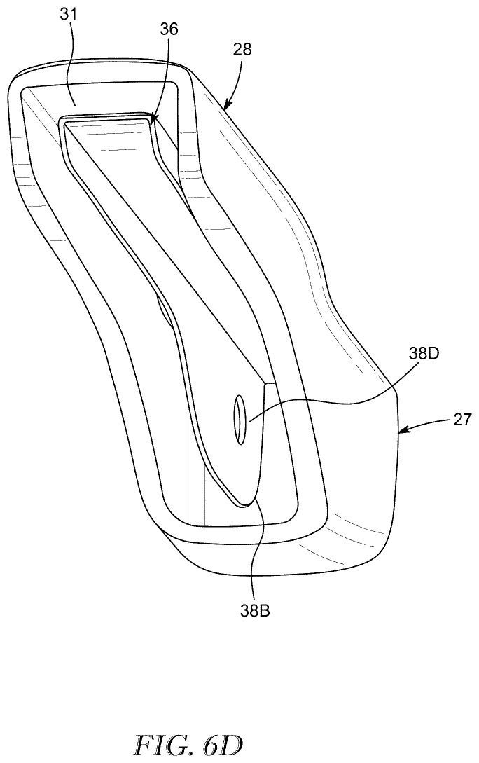

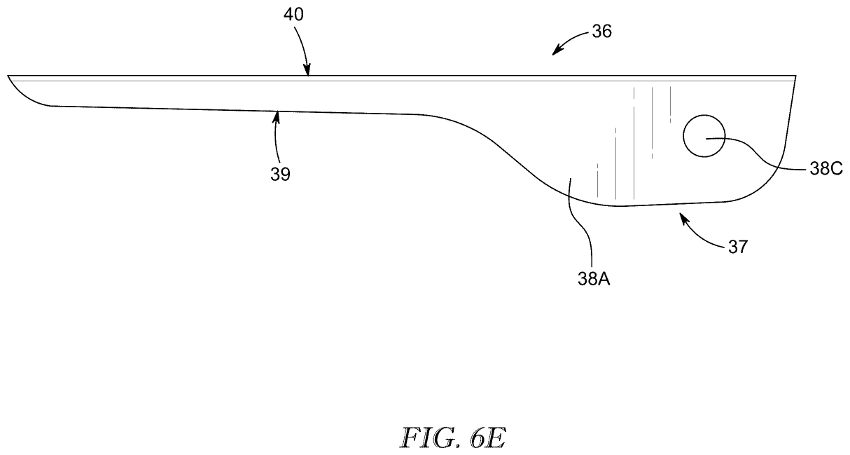

As used herein, the seat frame assembly 12 may refer to only the seat back frame 14, only the seat bottom frame 14B′, 14B″″′, or both the seat back frame 14 and the seat bottom frame 14B′, 14B″″′. In some embodiments, the armrest assembly 20 may be coupled to the seat back frame 14, the seat bottom frame 14B′, 14B″″′, or a combination of both, as shown in the embodiments of FIGS. 13A-17C. In some embodiments, the seat back frame 14 and the seat bottom frame 14B′, 14B″″′ may be formed as a single, integrally-formed, monolithic piece, as shown, for example, in FIGS. 17A-17C. In other embodiments, the seat back frame 14 may be formed separately from the seat bottom frame 14B′, 14B″″′. As shown in FIGS. 5A-6E, the armrest 24 includes a cover 26, which may be cushioned, and an inner frame member 36. The cover 26 includes a main portion 27, a cantilevered portion 28 extending away from the main portion 27, and a top surface 29 for an occupant to rest their arm or elbow on. The inner frame member 36 includes a main portion 37, a cantilevered portion 39 extending away from the main portion 37, and a top surface 40. The cover 26 is shaped complimentarily to the inner frame member 36 and encloses the inner frame member 36. The cover 26 can be mounted on the upper surface 40 of the inner frame member 36. The main portion 37 includes flanges 38A, 38B extending downwardly from the top surface 40 that each include openings 38C, 38D. The pivot rod 32 of the armrest 24 extends through the openings 38C, 38D and is fixedly coupled therein such that movement of the armrest 24 between the deployed and stowed positions rotates the pivot rod 32.

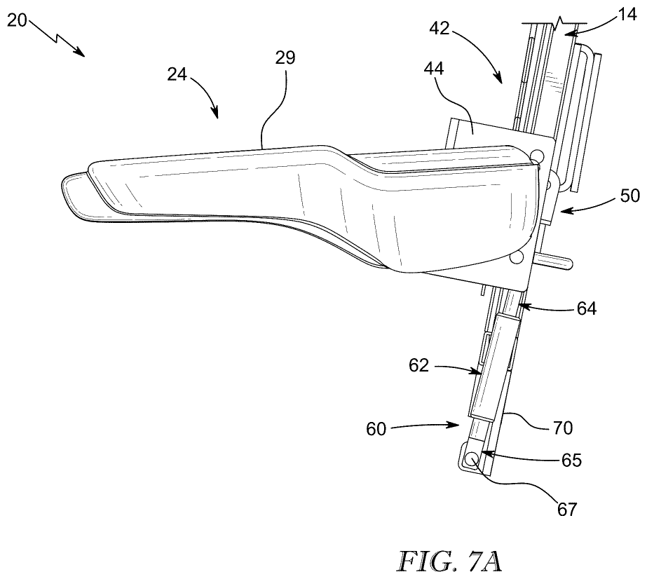

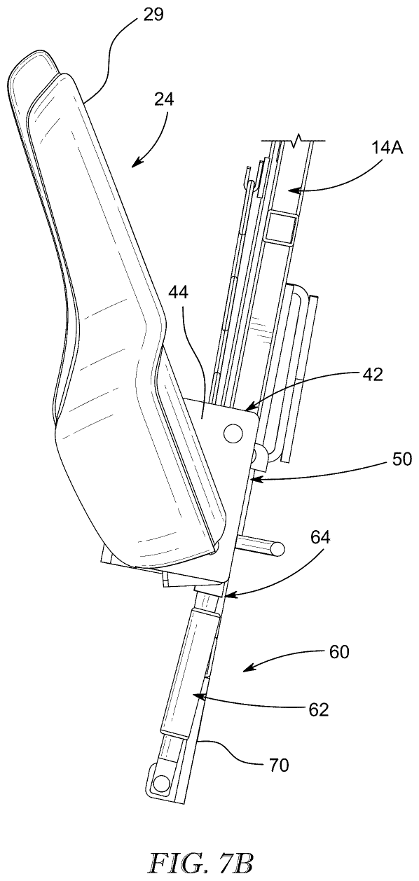

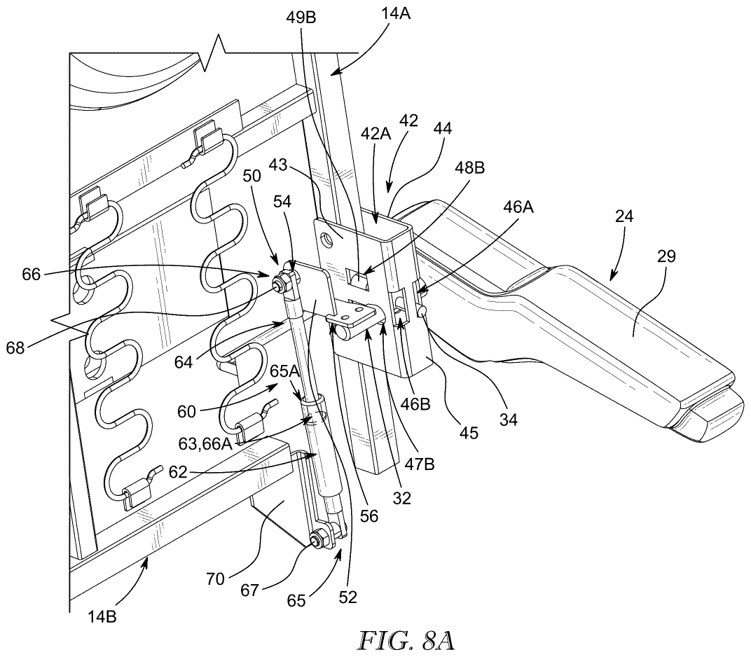

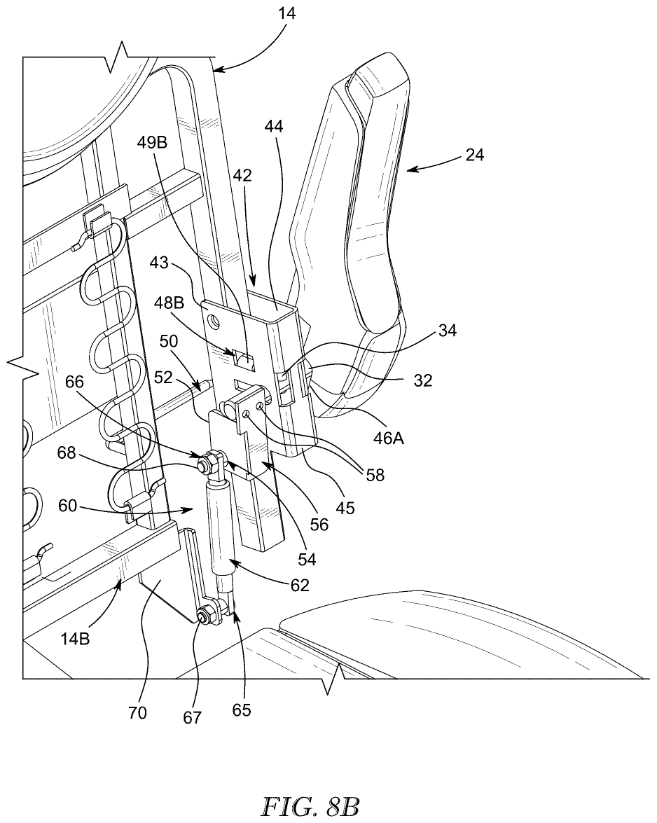

As shown in detail in FIGS. 7A-8B, the armrest assembly 20 is coupled to the seat frame assembly 12. Illustratively, the armrest assembly 20 is coupled to the seat back frame 14, the seat back frame 14 having a first support bar 14A. The first support bar 14A is arranged on an outer side of the seat back frame 14 such that the armrest 24 can be positioned on an outer side of the vehicle 100 where an occupant 200 can place their arm or elbow. The armrest 24 is pivotably coupled to the seat back frame 14 via a mounting bracket 42 of the armrest assembly 20. The mounting bracket 42 is coupled to the first support bar 14A of the seat back frame 14 and the armrest 24 is pivotably mounted on the mounting bracket 42 and configured to be moved between a deployed position (FIGS. 7A, 8A) and a stowed position (FIGS. 7B, 8B). As will be described in more detail below, the pivot rod 32 of the armrest 24 extends through the mounting bracket 42 so as to enable pivoting of the armrest 20 relative to the mounting bracket 42.

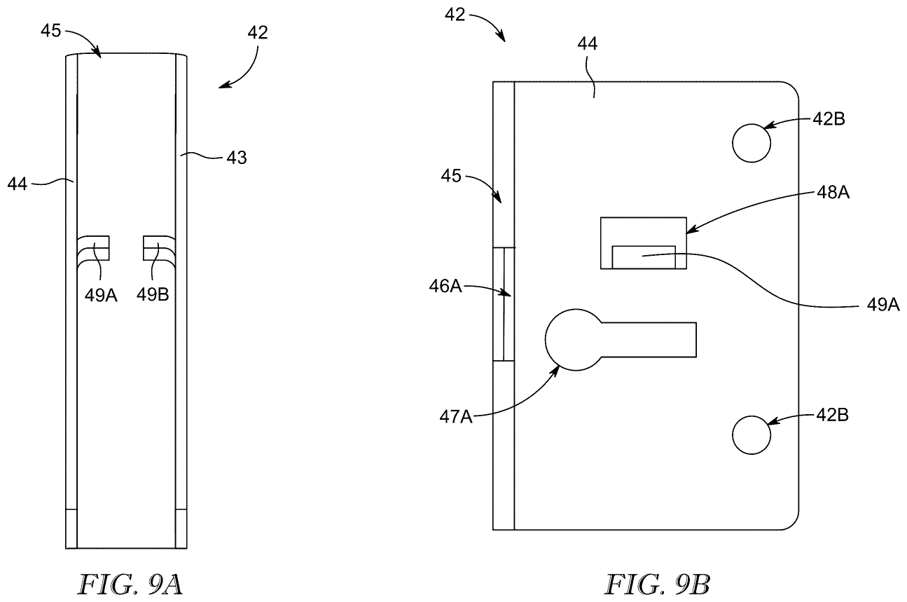

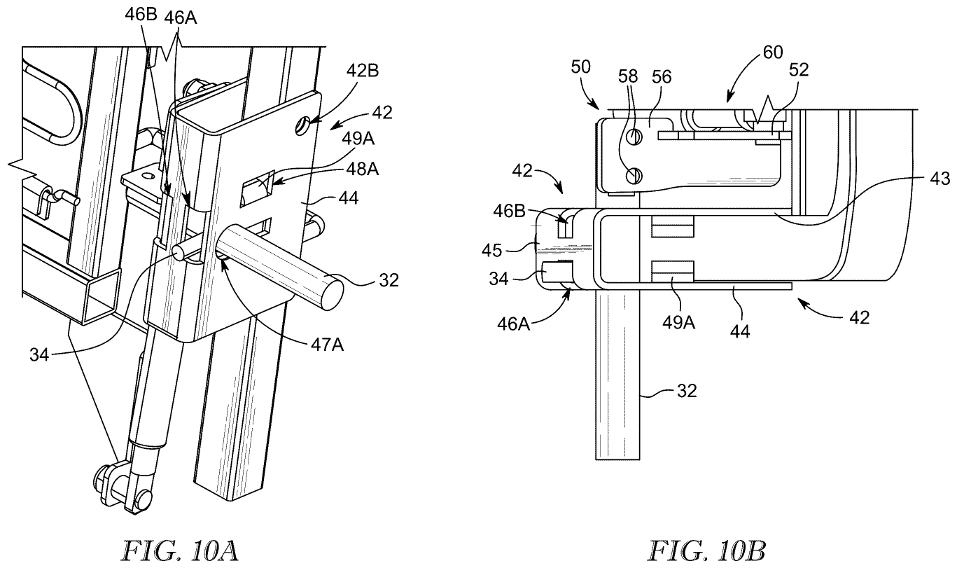

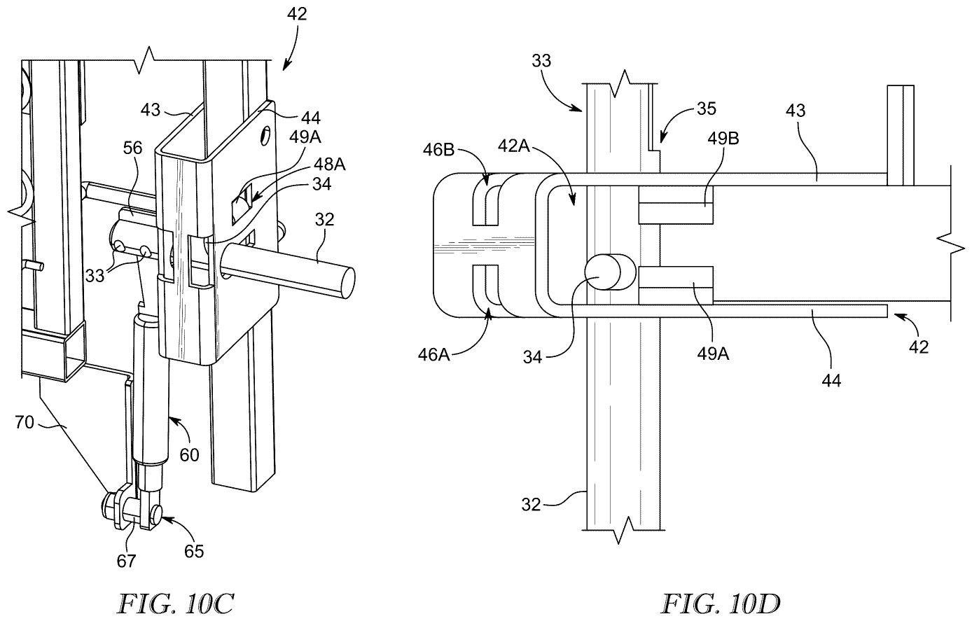

Details of the mounting bracket 42 are shown in FIGS. 9A-10D. Illustratively, the mounting bracket 42 includes a first wall 43, a second wall 44 spaced apart from the first wall 43, and a forward wall 45 extending between and interconnecting the first and second walls 43, 44. The first support bar 14A of the seat back frame 14 extends between the first and second walls 43, 44 and is coupled to at least one of the first and second walls 43, 44. In some embodiments, as shown in FIGS. 9A-12B, the walls 43, 44 may include upper and lower openings 42A, 43A, 42B, 43B through which fasteners may extend so as to couple the mounting bracket 42 to the first support bar 14A. The first and second walls 42, 43 further include corresponding pivot rod openings 47A, 47B formed therethrough, as shown in FIGS. 9A-12B. The pivot rod 32 of the armrest 24 extends through the openings 47A, 47B such that the armrest 24 is configured to pivot relative to the mounting bracket 42.

Illustratively, at least one of the walls 43, 44 that corresponds to a position of a movement delimiting extension 34 formed on the pivot rod 32 includes a first tab 49A, 49B extending inwardly away from the respective wall 43, 44, as can be seen in FIGS. 9A-12B. In one particular example, the outer wall 44 may include the first tab 49A extending therefrom. In some embodiments, the tab 49A, 49B may be curved and extend inwardly from an opening 48A, 48B formed in the wall 43, 44. The pivot rod 32 includes a movement delimiting extension 34 extending away from an outer surface of the pivot rod 32. The tab 49A extends into a path along which the movement delimiting extension 34 moves during movement of the armrest 24 in a first rotational direction from the deployed position to the stowed position. Because the tab 49A is in the path of the movement delimiting extension 34, the movement delimiting extension 34 engages the tab 49A in response to the armrest 24 reaching the stowed position such that the tab 49A delimits movement of the armrest 24 in the first rotational direction at the stowed position. In some embodiments, the pivot rod 32 can include two movement delimiting extensions that engage a corresponding tab 49A, 49B.

As shown in FIGS. 9A-12B, the forward wall 45 includes forward openings 46A, 46B, also referred to herein as second openings, formed therethrough. One of the openings 46A is aligned with the movement delimiting extension 34. The movement delimiting extension 34 engages a bottom side of the opening 46A in response to the armrest 24 being in the deployed position such that the opening 46A delimits movement of the armrest 24 in a second rotational direction opposite the first rotational direction at the deployed position, the second rotational direction being in a direction from the stowed position toward the deployed position. The openings 46A, 46B are formed to be long enough in the vertical direction to allow the movement delimiting extension 34 to pass beyond an upper side of the opening 46A without contacting the upper side.

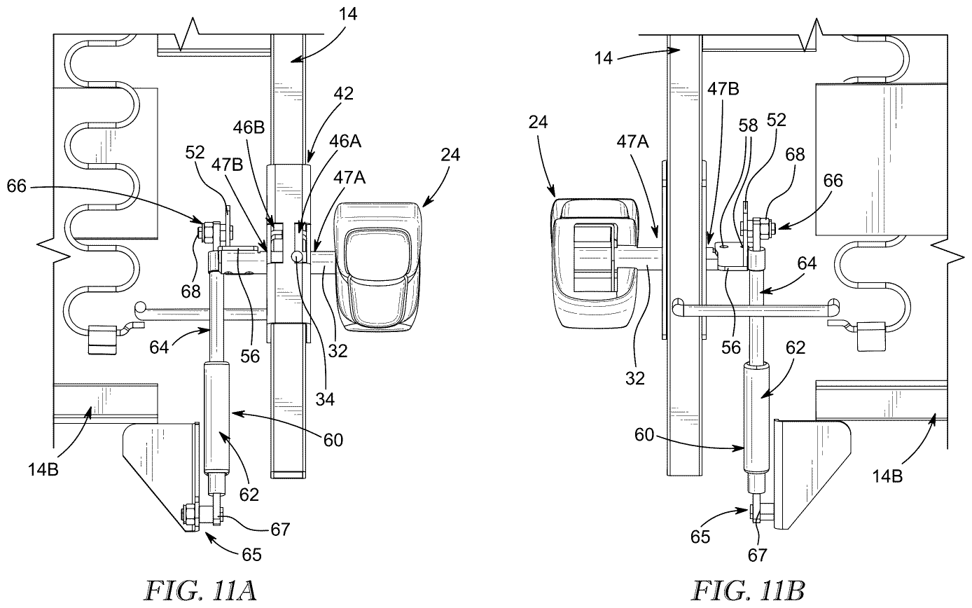

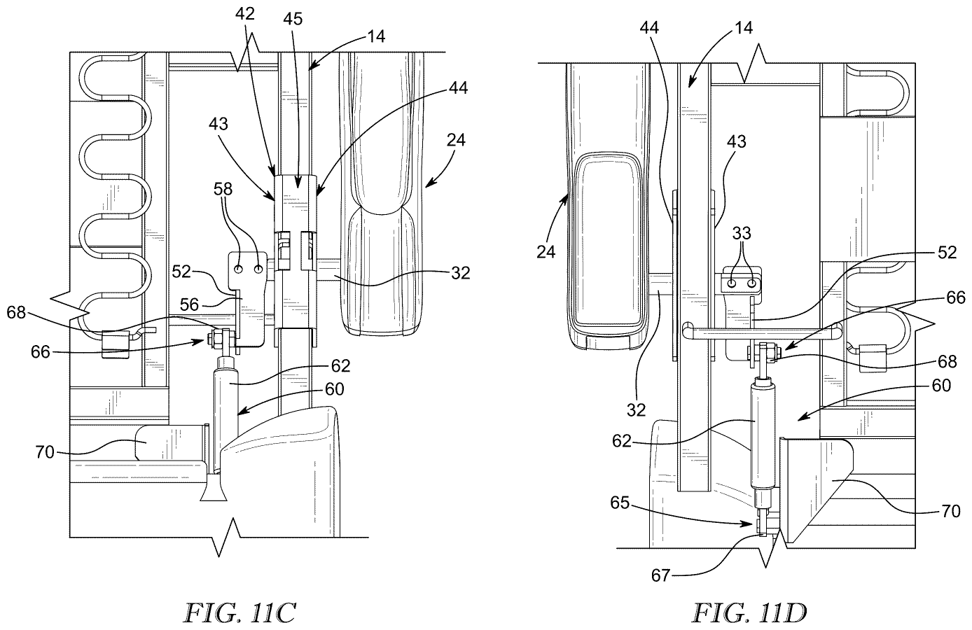

As can be seen in FIGS. 7A-8B as well FIGS. 11A-11D, the pivot rod 32 further includes a connection plate 50 connected thereto. The connection plate 50 is formed as a plate or sheet and includes a vertical plate 52 extending upwardly away from a base plate 56, the base plate 56 being fixedly coupled to an inner terminal end of the pivot rod 32 via fasteners being inserted through fastener holes 58 formed in the base plate 56 and corresponding fastener holes 33 formed in the pivot rod 32. In some embodiments, the vertical plate 52 is located on an inner side of the base plate 56.

A first end of the connection plate 50, in particular the forward end of the base plate 56 at which the fastener holes 58 are located, is coupled to and extends radially away from the pivot rod 32, as shown in FIGS. 7A-8B as well FIGS. 11A-11D. A second end of the connection plate 50 is defined at a rear end of the vertical plate 52 at which a pivot opening 54 is formed for pivotably coupling the actuator 60 or elastic member 60 thereto.

The armrest assembly 20 further includes at least one of an actuator 60 or an elastic member 60. Although this component is described with reference to the embodiments shown in FIGS. 1-16B, in particular with the actuator 60 being a gas spring 60, additional embodiments are contemplated herein in the remaining description and figures. A person skilled in the art will understand that various combinations and implementations of these embodiments are within the spirit of this disclosure.

As shown in FIGS. 7A-12B, the actuator 60 or the elastic member 60 is mounted on the pivot rod 32 of the armrest 24 and on at least one of the seat frame assembly 12 or the mounting bracket 42, and in particular, inwardly relative to the armrest 24. The mounting bracket 42, the connection plate 50, and the actuator 60 or the elastic member 60 may be arranged inwardly enough such that these components are covered by the cushioned cover 15B. In some embodiments, the hollow cylinder 62 is movably coupled to the seat back frame 14 at a first connection point (i.e. at the fastener 67), and the second end 66 of the piston rod 64 is coupled to the connection plate 50 at a second connection point (i.e. at the fastener 68). The first connection point is located below the second connection point at all positions of the connection plate 50 as it rotates relative to the seat back frame 14 during movement of the armrest 24. As will be described below, the ends 65, 66 of the gas spring 60 may be arranged in other configurations relative to the seat frame assembly 12.

Illustratively, as shown in FIGS. 7A-12B, the actuator 60 is arranged on the seat back frame 14. The actuator 60 or the elastic member 60 is configured to move the armrest 24 to the deployed position in response to the armrest 24 having been moved away from the deployed position to the stowed position or any position between the stowed position and the deployed position. The actuator 60 or the elastic member 60 is movable between a starting position (e.g., FIG. 8A) in which the armrest 24 is in the deployed position and an engaged position (e.g., FIG. 8B) in which the armrest 24 is in the stowed position or any position between the stowed position and the deployed position.

In order to return the armrest 24 to the deployed position after it has been moved away from the deployed position, the actuator 60 or the elastic member 60 is configured to generate a force on the armrest 24 in response to being in the engaged position as to bias the armrest 24 toward the deployed position. In response to the force being greater than a movement force being applied to the armrest 24 for moving the armrest 24 from the deployed position toward the stowed position, the actuator 60 or the elastic member 60 moves the armrest 24 into the deployed position. Illustratively, the actuator 60 or the elastic member 60 generates the force on the armrest 24 in the second rotational direction (i.e. in a direction from the stowed position to the deployed position) in response to being in the engaged position as to bias the armrest 24 to the deployed position.

As shown in FIGS. 7A-12B, the at least one of the first actuator 60 or the first elastic member 60 includes a gas spring 60. The gas spring 60 includes a hollow cylinder 62, a piston 63 (shown in phantom in FIG. 8A) arranged within the hollow cylinder 62 and movable therein, and a piston rod 64 coupled to the piston 63 and extending outwardly away from the hollow cylinder 62. A first end 66A of the piston rod 64 is movably coupled to the piston 63 and a second end 66 of the piston rod 64 opposite the first end 66A, which is also a second end 66 of the gas spring 60, is coupled to the pivot rod 32 of the armrest 24 via the connection plate 50. Specifically, the second end 66 of the piston rod 64 is pivotably coupled to the vertical plate 52 of the connection plate 50 via a fastener 68 extending through the pivot opening 54, as shown in FIG. 8A.

The piston rod 64 extends outwardly from a first end 65A of the hollow cylinder 62, and a second end 65 of the hollow cylinder 62 opposite the first end 65A, which is also a second end 65 of the gas spring 60, is movably coupled to the seat back frame 14, as shown in FIGS. 8A and 8B. In some embodiments, the second end 65 of the hollow cylinder 62 is pivotably coupled to a mounting plate 70 that is fixedly coupled to a second support bar 14B of the seat back frame 14 via a fastener 67 extending through the mounting plate 70.

In response to the armrest 24 being in the deployed position, the gas spring 60 is in the starting position (FIGS. 7A, 8A) in which the piston rod 64 is extended away from the hollow cylinder 62 such that the second end 66 of the piston rod 64 is located a first distance away from the hollow cylinder 62. In response to the armrest 24 being in the stowed position, the gas spring 60 is in the engaged position (FIGS. 7B, 8B) in which the piston rod 64 is compressed toward the hollow cylinder 62 such that the second end 66 of the piston rod 64 is located a second distance away from the hollow cylinder 62 that is less than the first distance. The operation of the gas spring 60 would be understood by a person skilled in the art. In particular, movement of the armrest 24 toward the stowed position progressively compresses the second end 66 of the piston rod 64 toward the hollow cylinder 62 such that, in response to the armrest 24 having been moved away from the deployed position to the stowed position or any position between the stowed position and the deployed position, the compression of the piston rod 64 biases the piston rod 64 toward the starting position so as to bias the armrest 24 toward the deployed position. As a result, the armrest 24 is configured to return to the deployed position via the biasing of the gas spring 60 in response to a compression force of the gas spring 60 being greater than a movement force being applied to the armrest 24 for moving the armrest 24 from the deployed position toward the stowed position. In some embodiments, the gas spring 60 may be selectively actuatable, which can be controlled by the controller 908 described below.

FIGS. 13A-16B show alternative arrangements of the gas spring 60 relative to the seat frame assembly 12. The components associated with these arrangements are shown with reference numerals including prime (') symbols and correspond directly with the same reference numerals shown in FIGS. 1-12B. FIGS. 13A and 13B show deployed and stowed positions of a first alternative arrangement of the gas spring 60′ in which the second end 65′ of the hollow cylinder 62′ is pivotably coupled to the seat bottom frame 14B′ as opposed to the seat back frame 14. The connection point at which the second end 65′ of the hollow cylinder 62′ is pivotably coupled to the seat bottom frame 14B′ is forward of the connection point of the piston rod 64′ to the connection plate 50′ at all positions of the connection plate 50′ as it rotates relative to the seat back frame 14′ during movement of the armrest 24′.

FIGS. 14A and 14B show deployed and stowed positions of a second alternative arrangement of the gas spring 60″ in which the second end 65″ of the hollow cylinder 62″ is pivotably coupled to the seat back frame 14″ at a location (i.e. “connection point”) above the connection point of the piston rod 64″ to the connection plate 50″ at all positions of the connection plate 50″ as it rotates relative to the seat back frame 14″ during movement of the armrest 24″. Because the gas spring 60″ is flipped vertically as compared to the gas spring 60, the piston rod 64″ is fully retracted in the deployed position of the armrest 24″ and is fully extended in the stowed position of the armrest 24″.

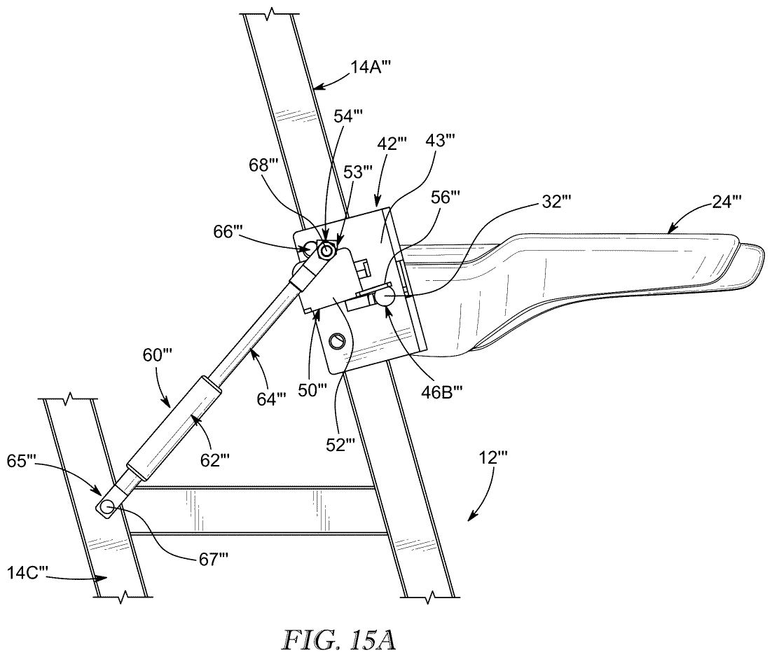

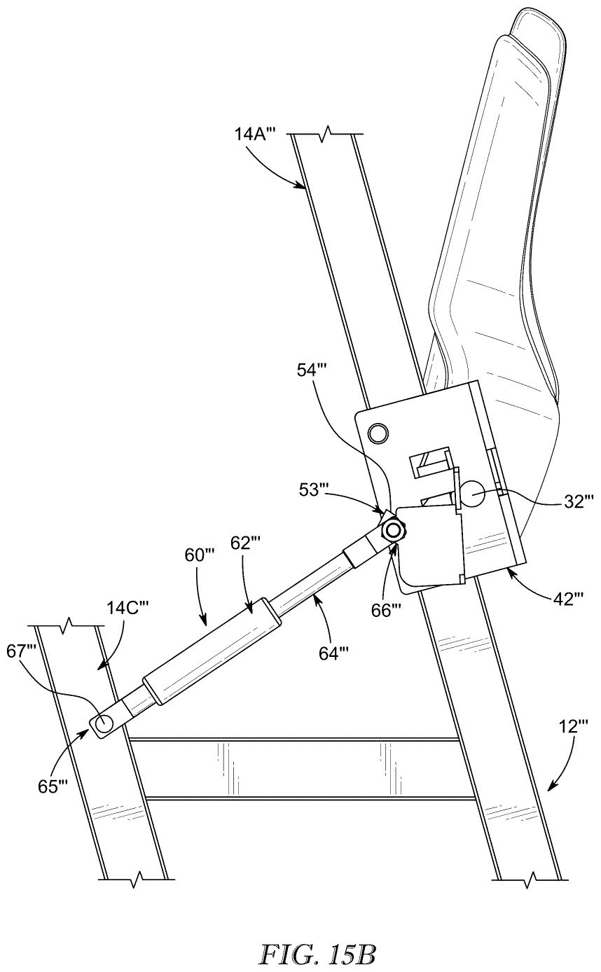

FIGS. 15A and 15B show deployed and stowed positions of a third alternative arrangement of the gas spring 60″′ in which the second end 65″′ of the hollow cylinder 62″′ is pivotably coupled to a rear frame assembly 14C″′ of the seat frame assembly 12″′ that is located rearward of the seat back frame 14″′. The connection point of the second end 65″′ to the rear frame assembly 14C″′ is located rearward of the connection point of the piston rod 64″′ to the connection plate 50″′ at all positions of the connection plate 50″′ as it rotates relative to the seat back frame 14″′ during movement of the armrest 24″′. In some embodiments, the connection plate 50″′ may include an tab 53″′ through which a hole 54″′ is formed for pivotably coupling the second end 66″′ of the gas spring 60″′ thereto. The tab 53″′ allows for a less resistant pivoting movement of the pivot rod 32″′ due to the hole 54″′ being closer to an arc defined around the pivot point (center of the pivot rod 32) as opposed to the hole 54″′ being in the position shown in FIGS. 7A-12B.

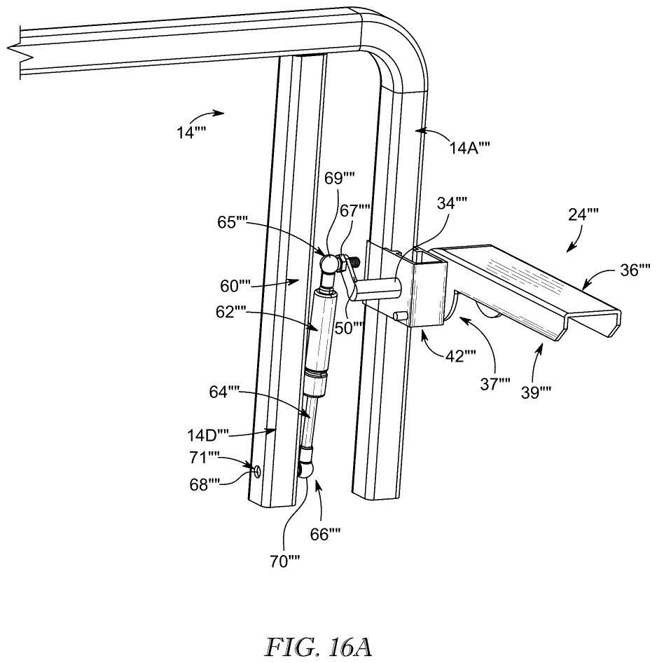

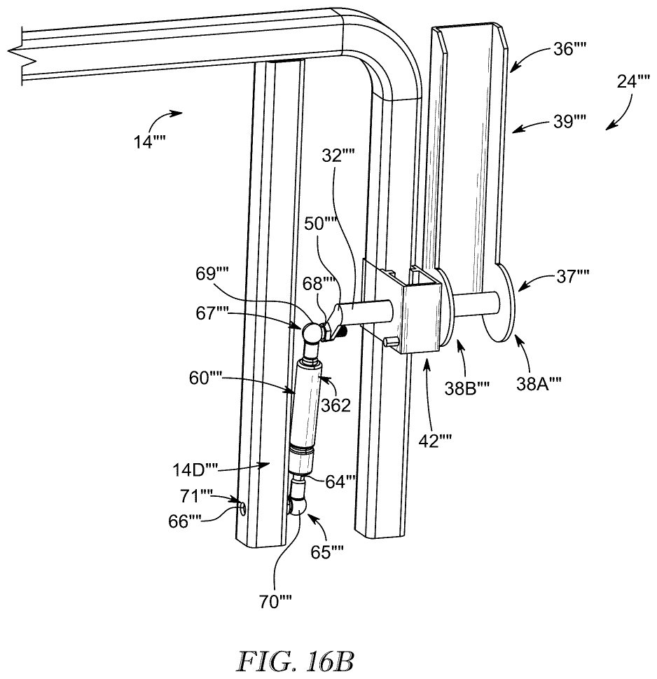

FIGS. 16A and 16B show deployed and stowed positions of a fourth alternative arrangement of the gas spring 60″″ in which the second end 65″″ of the hollow cylinder 65″″ is pivotably coupled to the connection plate 50″″ as opposed to the seat back frame 14″″ (i.e. vertically flipped as compared to the gas spring 60). In some embodiments, the first end 66″″ of the piston rod 64″″ is pivotably coupled to a second support bar 14D″″ that extends parallel to and inwardly spaced apart from the first support bar 14A″″. Each end 65″″, 66″″ can include a spherical bearing 69″″, 70″″ to aid in the pivoting of the gas spring 60″″ relative to the connection plate 50″″ and the second support bar 14D″″.

FIGS. 17A-17C show deployed and stowed positions of a fifth alternative arrangement of the gas spring 60′″″ in which the components of the armrest assembly 20′″″ are coupled to the seat bottom frame 14B″″′ as opposed to the seat back frame 14′″″ (specifically the first support bar 14A′″″ of the seat back frame 14′″″). As shown in detail in FIGS. 17B and 17C, the mounting bracket 42′″″ is coupled to a first support post 14B1′″″ that extends slightly outwardly from a first support member 14B2′″″ of the seat bottom frame 14B″″′ (a small first portion 14B3′″″ extends away from the first support member 14B2′″″) and then bends upwardly away from the seat bottom frame 14B″″′ (a vertical portion 14B4′″″ extends upwardly away from a terminal end of the first portion 14B3′″″). In some embodiments, the vertical portion 14B4′″″ of the first support post 14B1′″″ is parallel to the first support bar 14A′″″ of the seat back frame 14′″″ so that the armrest assembly 20′″″ is positioned in the same orientation as it would be on the first support bar 14A′″″ of the seat back frame 14′″″.

As can be seen in FIGS. 17B and 17C, the other components of the armrest assembly 20′″″ are arranged on the mounting bracket 42′″″ in the same manner as the embodiments described above, and thus, the entire armrest assembly 20′″″ is arranged on the seat bottom frame 14B″″′ (i.e. the first support post 14B1′″″) instead of the seat back frame 14′″″. Additionally, the second end 65′″″ of the hollow cylinder 62′″″ is pivotably coupled to the first support bar 14B2′″″ as opposed to the seat back frame 14′″″. In this way, the entirety of the armrest assembly 20′″″ is arranged on the seat bottom frame 14B″″′ as opposed to the seat back frame 14′″″.

Another embodiment of a seat assembly 310 is shown in FIGS. 18A and 18B. The seat assembly 310 is similar to the seat assembly 10 shown in FIGS. 1-17C, and described herein. Accordingly, similar reference numbers in the 300 series indicate features that are common between the seat assembly 310 and the seat assembly 10. The description of the seat assembly 10 is incorporated by reference to apply to the seat assembly 310, except in instances when it conflicts with the specific description and the drawings of the seat assembly 310. A person skilled in the art will understand that the components of the seat assembly 310, such as the armrest assembly 320, may be utilized in place of the components of the previously described seat assemblies, or in conjunction therewith. Also, the components of the seat assembly 310, such as the armrest assembly 320, may be utilized on an opposing side of the previously described seat assemblies (i.e. one type of armrest assembly on the passenger side and a different type of armrest assembly on the driver side).

As shown in FIGS. 18A and 18B, the seat assembly 310 is formed similarly to the seat assembly 10 described above, in particular with the components such as the armrest assembly 320, the mounting plate 342, and the connection plate 350 being formed similarly. It is noted that simplified versions of the inner frame member 336, the mounting bracket 342, and the connection plate 350 are shown for the purposes of emphasizing the differences between the seat assembly 310 and the seat assembly 10. The seat assembly 310 differs from the seat assembly 10 in that the at least one of the first actuator 360 or the first elastic member 360 includes a linear actuator 360.

The linear actuator 360 includes a hollow cylinder 362, a piston rod 364 extending outwardly away from the hollow cylinder 362, and a motor 372 operably connected to the piston rod 364 and configured to drive the piston rod 364 away from and toward the hollow cylinder 362. A first end 366 of the piston rod 364 is coupled to a connection plate 350 of the pivot rod 332 of the armrest 324. The piston rod 364 extends outwardly from a first end of the hollow cylinder 362, and a second end 365 of the hollow cylinder 362 opposite the first end is movably coupled to a second support bar 314D of the seat back frame 314.

In response to the armrest 324 being in the deployed position, the linear actuator 360 is in the starting position in which the piston rod 364 is extended away from the hollow cylinder 362 such that the second end 366 of the piston rod 364 is located a first distance away from the hollow cylinder 362. In response to the armrest 324 being in the stowed position, the linear actuator 360 is in the engaged position in which the piston rod 364 is retracted toward the hollow cylinder 362 such that the second end 366 of the piston rod 364 is located a second distance away from the hollow cylinder 362 that is less than the first distance. The motor 372 is arranged adjacent to the hollow cylinder 362 and is operably connected to the piston rod 364. The motor 372 is configured to selectively drive the piston rod 364 away from and toward the hollow cylinder 362. As a result, in response to the armrest 324 having been moved away from the deployed position to the stowed position or any position between the stowed position and the deployed position, the motor 372 is configured to move the piston rod 364 away from the hollow cylinder 362 until the armrest 324 returns to the deployed position.

In some embodiments, the motor 372 is configured to automatically move the armrest 324 to the deployed position in response to the armrest 324 having been moved away from the deployed position to the stowed position or any position between the stowed position and the deployed position and in response to a movement force being applied to the armrest 324 for moving the armrest 324 from the deployed position toward the stowed position is below a predetermined force value. In other words, an occupant may apply a movement force to the armrest 324 to move it toward the stowed position (e.g., when entering the vehicle 100), and once the movement force is reduced or removed beyond the predetermined force value, the motor 372 may drive the piston rod 364 to return the armrest 324 to the deployed position. In some embodiments, the motor 372 may be operably connected to the controller 908 of the control system 904, as described below, which can be configured to control the automatic actuation of the motor 372 in response to the movement force being less than the predetermined force value. In some embodiments, the predetermined force value may be preset via the controller 908. In some embodiments, the predetermined force value may be zero (i.e. an occupant completely letting go of the armrest 324 and allowing it to return to the deployed position).

Another embodiment of a seat assembly 410 is shown in FIGS. 19A-19C. The seat assembly 410 is similar to the seat assemblies 10, 310 shown in FIGS. 1-18B, and described herein. Accordingly, similar reference numbers in the 400 series indicate features that are common between the seat assembly 410 and the seat assemblies 10, 310. The descriptions of the seat assemblies 10, 310 are incorporated by reference to apply to the seat assembly 410, except in instances when they conflicts with the specific description and the drawings of the seat assembly 410. A person skilled in the art will understand that the components of the seat assembly 410, such as the armrest assembly 420, may be utilized in place of the components of the previously described seat assemblies, or in conjunction therewith. Also, the components of the seat assembly 410, such as the armrest assembly 420, may be utilized on an opposing side of the previously described seat assemblies (i.e. one type of armrest assembly on the passenger side and a different type of armrest assembly on the driver side).

As shown in FIGS. 19A-19C, the seat assembly 410 is formed similarly to the seat assemblies 10, 310 described above, in particular with the components such as the armrest assembly 420, the mounting plate 442, and the connection plate 450 being formed similarly. It is noted that simplified versions of the inner frame member 436, the mounting bracket 442, and the connection plate 450 are shown for the purposes of emphasizing the differences between the seat assembly 410 and the seat assemblies 10, 310. The seat assembly 410 differs from the seat assemblies 10, 310 in that the at least one of the first actuator 460 or the first elastic member 460 includes a rotary motor 460.

The rotary motor 460 includes a drive motor 470 operably connected to the pivot rod 432 of the armrest 324 and configured to selectively rotate the pivot rod 332 in a first rotational direction toward the stowed position of the armrest 324 and in a second rotational direction opposite the first rotational direction toward the deployed position of the armrest 324.

Illustratively, as shown in detail in FIG. 19A, the mounting bracket 442 includes a gear rod 469 extending away from an inner wall 443 of the mounting bracket 442 and parallel to the pivot rod 432. A gear 468, also referred to as a second gear herein, is arranged on the gear rod 469, and the drive motor 470 is operably coupled to the second gear 468 such that rotation of the drive motor 470 rotates the second gear 468. The second gear 468 includes a plurality of gear teeth 468T and defines a second diameter 464B. A mounting plate 472 that is configured to fixedly receive the drive motor 470 can be mounted on the inner wall 443 so as to affix the drive motor 470 to the inner wall 443. The mounting plate 472 includes opposing ends 473 having fastener openings 474 for fastening the mounting plate 472 and thus the drive motor 470 to the inner wall 443.

The rotary motor 460 further includes a first gear 462 having a central opening 463 within which the pivot rod 432 is fixedly coupled. The first gear 462 includes a plurality of gear teeth 462T, and defines a first diameter 464A. The first diameter 464A is greater than the second diameter 464B and has more gear teeth 462T than the second gear 468 (gear teeth 468T). The second gear 468 engages the first gear 462 via the gear teeth 462T, 468T such that rotation of the second gear 468 in the second rotational direction rotates the first gear 462 in the first rotational direction and rotation of the second gear 468 in the first rotational direction rotates the first gear 462 in the second rotational direction. As a result, activation of the drive motor 470 can thus move the armrest 424 toward and into the deployed position after it has been moved away from the deployed position.

Specifically, in response to the armrest 424 having been moved away from the deployed position to the stowed position or any position between the stowed position and the deployed position, the drive motor 470 is configured to rotate the pivot rod 432 in the second rotational direction until the armrest 424 returns to the deployed position. In some embodiments, the drive motor 470 is configured to automatically move the armrest 424 to the deployed position in response to the armrest 424 having been moved away from the deployed position to the stowed position or any position between the stowed position and the deployed position and in response to a movement force being applied to the armrest 424 for moving the armrest 424 from the deployed position toward the stowed position is below a predetermined force value. In other words, an occupant may apply a movement force to the armrest 424 to move it toward the stowed position (e.g., when entering the vehicle 100), and once the movement force is reduced or removed beyond the predetermined force value, the drive motor 470 may rotate the gears 462, 468 in order to return the armrest 424 to the deployed position. In some embodiments, the drive motor 470 may be operably connected to the controller 908 of the control system 904, as described below, which can be configured to control the automatic actuation of the drive motor 470 in response to the movement force being less than the predetermined force value. In some embodiments, the predetermined force value may be preset via the controller 908. In some embodiments, the predetermined force value may be zero (i.e. an occupant completely letting go of the armrest 424 and allowing it to return to the deployed position).

Another embodiment of a seat assembly 510 is shown in FIGS. 20A-20C. The seat assembly 510 is similar to the seat assemblies 10, 310, 410 shown in FIGS. 1-19C, and described herein. Accordingly, similar reference numbers in the 500 series indicate features that are common between the seat assembly 510 and the seat assemblies 10, 310, 410. The descriptions of the seat assemblies 10, 310, 410 are incorporated by reference to apply to the seat assembly 510, except in instances when they conflict with the specific description and the drawings of the seat assembly 510. A person skilled in the art will understand that the components of the seat assembly 510, such as the armrest assembly 520, may be utilized in place of the components of the previously described seat assemblies, or in conjunction therewith. Also, the components of the seat assembly 510, such as the armrest assembly 520, may be utilized on an opposing side of the previously described seat assemblies (i.e. one type of armrest assembly on the passenger side and a different type of armrest assembly on the driver side).

As shown in FIGS. 20A-20C, the seat assembly 510 is formed similarly to the seat assemblies 10, 310, 410 described above, in particular with the components such as the armrest assembly 520, the mounting plate 542, and the connection plate 550 being formed similarly. It is noted that simplified versions of the inner frame member 436, the mounting bracket 442, and the connection plate 450 are shown for the purposes of emphasizing the differences between the seat assembly 510 and the seat assemblies 10, 310, 410. The seat assembly 510 differs from the seat assemblies 10, 310, 410 in that the at least one of the first actuator 560 or the first elastic member 560 includes a tension spring 568 as part of the actuation assembly 560.

The actuation assembly 560 includes the tension spring 568 as well as gears 562, 568 similar to gears 462, 468 described with reference to FIGS. 19A-19C for optional connection to a drive motor (i.e. drive motor 470). A first end 570 of the tension spring 568 is coupled to the seat back frame 514 via a hook of the first end 570 arranged within coupling holes 572 in the seat back frame 514. A second end 569 of the tension spring 568 opposite the first end 570 is coupled to a connection plate 550 that is coupled to and extends radially away from the pivot rod 532. A first connection point at which the tension spring 568 couples to the frame 514 (i.e. the first end 570) is above a second connection point at which the tension spring 568 couples to the connection plate 550 (i.e. the second end 569).

In response to the armrest 524 being in the deployed position, the tension spring 568 is in the starting position in which the spring 568 is at rest and the first connection point 570 is a first distance from the second connection point 569. In response to the armrest 524 being in the stowed position, the tension spring 568 is in the engaged position in which the spring 568 is stretched such that the first connection point 570 is located a second distance away from the first connection point 569 that is greater than the first distance. As a result, the spring 568 is tensioned. Another way to describe this is that movement of the armrest 524 toward the stowed position causes the pivot rod 532 to rotate in a first rotational direction, which progressively stretches the tension spring 568. As a result, in response to the armrest 524 having been moved away from the deployed position to the stowed position or any position between the stowed position and the deployed position, the stretching of the tension spring 568 biases the spring 568 toward the starting position so as to bias the armrest 524 toward the deployed position.

Similar to the connection plate 50 described above, a first end of the connection plate 550 is coupled to and extends radially away from a first terminal end of the pivot rod 532 opposite a second terminal end of the pivot rod 532 which is coupled to the inner frame member 536 of the armrest 524. The second end 569 of the tension spring 568 is spaced apart in a rearward direction from the pivot rod 532 and is coupled to a second end of the connection plate 550.

In some embodiments, the armrest 524 is configured to return to the deployed position via the biasing of the tension spring 568 in response to a spring force of the tension spring 568 being greater than a movement force being applied to the armrest 524 for moving the armrest 524 from the deployed position toward the stowed position. A person skilled in the art will understand that the strength of the tension spring 568 can be selected prior to installation or the spring 568 can be interchanged during maintenance of the vehicle 100 based on usage scenarios and design requirements of the vehicle 100.

Another embodiment of a seat assembly 610 is shown in FIGS. 21A-21F. The seat assembly 610 is similar to the seat assemblies 10, 310, 410, 510 shown in FIGS. 1-20C, and described herein. Accordingly, similar reference numbers in the 600 series indicate features that are common between the seat assembly 610 and the seat assemblies 10, 310, 410, 510. The descriptions of the seat assemblies 10, 310, 410, 510 are incorporated by reference to apply to the seat assembly 610, except in instances when they conflict with the specific description and the drawings of the seat assembly 610. A person skilled in the art will understand that the components of the seat assembly 610, such as the armrest assembly 620, may be utilized in place of the components of the previously described seat assemblies, or in conjunction therewith. Also, the components of the seat assembly 610, such as the armrest assembly 620, may be utilized on an opposing side of the previously described seat assemblies (i.e. one type of armrest assembly on the passenger side and a different type of armrest assembly on the driver side).

As shown in FIGS. 21A-21F, the seat assembly 610 is formed similarly to the seat assemblies 10, 310, 410, 510 described above, The seat assembly 610 differs from the seat assemblies 10, 310, 410, 610 in that the at least one of the first actuator 660 or the first elastic member 660 includes a torsion spring 674 as part of the actuation assembly 660, the torsion spring 674 being arranged within an interior space 642A defined by the mounting bracket 642.

The actuation assembly 660 includes the torsion spring 674 as well as gears 662, 668 similar to gears 462, 468, 562, 568 described with reference to FIGS. 19A-20C for optional connection to a drive motor (i.e. drive motor 470). As can be seen in FIGS. 20C and 20F which do not show the mounting bracket 642 for viewing purposes, the torsion spring 674 includes a central coil 676 that has an outer coil 676A and an inner coil 676B and that is wrapped around the pivot rod 632 of the armrest 624. The outer coil 676A and the inner coil 676B meet a respective first ends to define a looped portion 675 of the torsion spring 674, also referred to as a first end 675 of the torsion spring 674. The outer coil 676A and the inner coil 676B each define a second end 678A, 678B which extend tangentially away from the pivot rod 632, as shown in FIGS. 21C-21F, these second ends 678A, 678B also defining a second end 678 of the torsion spring 674.

As shown in FIGS. 21C-21F, the pivot rod 632 includes a first protrusion 635 extending radially away from the pivot rod 632. The first protrusion 635 is generally diametrically opposite of the second end 678 of the torsion spring 674. The looped portion 675 of the torsion spring 674 (i.e. the first end 675) is coupled to the first protrusion 635 of the pivot rod 632. Specifically, the looped portion 675 of the torsion spring 674 (i.e. the first end 675) is coupled to a forward-facing surface 635A of the first protrusion 635.

As can be seen in detail in FIG. 21B, the mounting bracket 642 is formed slightly differently than the mounting bracket 42 described above in order to accommodate and function with the torsion spring 674. Specifically, the mounting bracket 642 includes a first wall 643, a second wall 644 spaced apart from the first wall 643, and a forward wall 645 extending between and interconnecting the first and second walls 643, 644. The first support bar 614A of the seat back frame 614 is coupled to at least one of the first and second walls 643, 644. For engaging the torsion spring 674, the first wall 643 includes a first inner protrusion 649A extending away from an inner surface 643A of the first wall 643 and the second wall 644 includes a second inner protrusion 649B extending away from an inner surface 644A of the second wall 644. The second ends 678A, 678B of the outer coil 676A and the inner coil 676B of the of the torsion spring 674 (i.e. the second end 678 of the torsion spring 674) each contact and engage a respective one of the first and second inner protrusions 649A, 649B, in particular a forward-facing surface 649C, 649D of the first and second inner protrusions 649A, 649B.

In operation, when the pivot rod 632 of the armrest 624 is rotated in the first rotational direction from the deployed position toward the stowed position, the coupling of the looped portion 675 with the first protrusion 635 causes the second ends 678A, 678B (i.e. the second end 678 of the torsion spring 674) engage the first and second inner protrusions 649A, 649B such that the torsion spring 674 is twisted and stores mechanical energy therein. The stored mechanical energy from the twisting of the torsion spring 674 biases the pivot rod 632 in the second rotational direction opposite the first rotational direction so as to bias the armrest 624 toward the deployed position.

In some embodiments, the armrest 624 is configured to return to the deployed position via the biasing of the torsion spring 674 in response to a spring force of the torsion spring 674 being greater than a movement force being applied to the armrest 624 for moving the armrest 624 from the deployed position toward the stowed position. A person skilled in the art will understand that the strength of the torsion spring 674 can be selected prior to installation or the spring 674 can be interchanged during maintenance of the vehicle 100 based on usage scenarios and design requirements of the vehicle 100.

Another embodiment of a seat assembly 710 is shown in FIGS. 22A-22C. The seat assembly 710 is similar to the seat assemblies 10, 310, 410, 510, 610 shown in FIGS. 1-21F, and described herein. Accordingly, similar reference numbers in the 700 series indicate features that are common between the seat assembly 710 and the seat assemblies 10, 310, 410, 510, 610. The descriptions of the seat assemblies 10, 310, 410, 510, 610 are incorporated by reference to apply to the seat assembly 710, except in instances when they conflict with the specific description and the drawings of the seat assembly 710. A person skilled in the art will understand that the components of the seat assembly 710, such as the armrest assembly 720, may be utilized in place of the components of the previously described seat assemblies, or in conjunction therewith. Also, the components of the seat assembly 710, such as the armrest assembly 720, may be utilized on an opposing side of the previously described seat assemblies (i.e. one type of armrest assembly on the passenger side and a different type of armrest assembly on the driver side).

As shown in FIGS. 22A-22C, the seat assembly 710 is formed similarly to the seat assemblies 10, 310, 410, 510, 610 described above, in particular with the components such as the armrest assembly 720 and the mounting plate 742 being formed similarly. It is noted that simplified versions of the inner frame member 436 and the mounting bracket 442 are shown for the purposes of emphasizing the differences between the seat assembly 710 and the seat assemblies 10, 310, 410, 510, 610. The seat assembly 710 differs from the seat assemblies 10, 310, 410, 510, 610 in that the at least one of the first actuator 760 or the first elastic member 760 includes a clock spring 760.

As can be seen in FIGS. 22A-22C, the clock spring 760 is wound around itself in a spiral shape around the pivot rod 732 of the armrest 724. The mounting bracket 742 includes a first wall 743, a second wall 744 spaced apart from the first wall 743. The first wall 743 includes a first outer protrusion 749C extending away from the first wall 743 in a direction away from the armrest 724. The clock spring 760 is arranged on an inner end of the pivot rod 732 such that the clock spring 760 is arranged adjacent to an inner wall 743 of the mounting bracket 742. The clock spring 760 includes a first end 764 coupled to the pivot rod 732 and a second end 763 opposite the first end 764 that includes a hook that wraps around and engages the first outer protrusion 749C.

In response to the armrest 724 having been moved away from the deployed position to the stowed position or any position between the stowed position and the deployed position which causes rotation of the pivot rod in the first rotational direction, stretching of the clock spring 760 biases the pivot rod 732 in the second rotational direction opposite the first rotational direction so as to bias the armrest 724 toward the deployed position.

In some embodiments, the armrest 724 is configured to return to the deployed position via the biasing of the clock spring 760 in response to a spring force of the clock spring 760 being greater than a movement force being applied to the armrest 724 for moving the armrest 724 from the deployed position toward the stowed position. A person skilled in the art will understand that the strength of the clock spring 760 can be selected prior to installation or the spring 760 can be interchanged during maintenance of the vehicle 100 based on usage scenarios and design requirements of the vehicle 100.

Another embodiment of a seat assembly 810 is shown in FIGS. 23A and 23B. The seat assembly 810 is similar to the seat assemblies 10, 310, 410, 510, 610, 710 shown in FIGS. 1-22C, and described herein. Accordingly, similar reference numbers in the 800 series indicate features that are common between the seat assembly 810 and the seat assemblies 10, 310, 410, 510, 610, 710. The descriptions of the seat assemblies 10, 310, 410, 510, 610, 710 are incorporated by reference to apply to the seat assembly 810, except in instances when they conflict with the specific description and the drawings of the seat assembly 810. A person skilled in the art will understand that the components of the seat assembly 810, such as the armrest assembly 820, may be utilized in place of the components of the previously described seat assemblies, or in conjunction therewith. Also, the components of the seat assembly 810, such as the armrest assembly 820, may be utilized on an opposing side of the previously described seat assemblies (i.e. one type of armrest assembly on the passenger side and a different type of armrest assembly on the driver side).

As shown in FIGS. 23A and 23B, the seat assembly 810 is formed similarly to the seat assemblies 10, 310, 410, 510, 610, 710 described above, in particular with the components such as the armrest assembly 820, the mounting plate 842, and the connection plate 850 being formed similarly. It is noted that simplified versions of the inner frame member 836, the mounting bracket 842, and the connection plate 850 are shown for the purposes of emphasizing the differences between the seat assembly 810 and the seat assemblies 10, 310, 410, 510, 610, 710. The seat assembly 810 differs from the seat assemblies 10, 310, 410, 510, 610, 710 in that the at least one of the first actuator 860 or the first elastic member 860 includes a guided coil spring 860.

As can be seen in FIGS. 23A and 23B, the guided coil spring 860 includes a hollow cylinder 862, a guide rod 864 arranged partially inside the hollow cylinder 862 and extending outwardly away from the hollow cylinder 862, and a coil spring 864S surrounding the guide rod 864 having a first end 864S1 coupled to a first end 866 of the guide rod 864 and a second end 864S2 opposite the first end 864S1 coupled to a first outer end 862A of the hollow cylinder 862. The hollow cylinder 862 guides movement of the guide rod 864 therein. The first end 866 of the guide rod 864 is pivotably coupled to the seat back frame 814, in particular to a second support bar 814D via a spherical bearing 870 and a fastener 868, and a second end 865 of the hollow cylinder 862 is pivotably coupled to the connection plate 850 via a spherical bearing 869 and a fastener 867.

In response to the armrest 824 being in the deployed position, the guided coil spring 860 is in the starting position in which the guide rod 864 is extended away from the hollow cylinder 862 such that the first end 866 of the piston rod 864 is located a first distance away from the hollow cylinder 862. In response to the armrest 824 being in the stowed position, the guided coil spring 860 is in the engaged position in which the guide rod 864 is retracted toward the hollow cylinder 862 and the coil spring 864S is compressed such that the first end 866 of the guide rod 864 is located a second distance away from the hollow cylinder 862 that is less than the first distance. Another way to describe this is that movement of the armrest 824 toward the stowed position progressively compresses the coil spring 864S such that, in response to the armrest 824 having been moved away from the deployed position to the stowed position or any position between the stowed position and the deployed position, the compression of the coil spring 864S biases the hollow cylinder 862 away from the second end 866 of the guide rod 864 so as to bias the guided coil spring 860 toward the starting position, thus biasing the armrest 824 toward the deployed position.

In some embodiments, the armrest 824 is configured to return to the deployed position via the biasing of the guided coil spring 860 in response to a spring force of the coil spring 864S being greater than a movement force being applied to the armrest 824 for moving the armrest 824 from the deployed position toward the stowed position. A person skilled in the art will understand that the strength of the coil spring 864S of the clock spring 860 can be selected prior to installation or the spring 860 can be interchanged during maintenance of the vehicle 100 based on usage scenarios and design requirements of the vehicle 100.

Another embodiment of a seat assembly 900, also referred to as a vehicle system 900 herein, is shown in FIGS. 24A-24C. The seat assembly 900 is similar to the seat assemblies 10, 310, 410, 510, 610, 710, 810 shown in FIGS. 1-23B, and described herein. Accordingly, similar reference numbers in the 900 series indicate features that are common between the seat assembly 900 and the seat assemblies 10, 310, 410, 510, 610, 710, 810. The descriptions of the seat assemblies 10, 310, 410, 510, 610, 710, 810 are incorporated by reference to apply to the seat assembly 900, except in instances when they conflict with the specific description and the drawings of the seat assembly 900. A person skilled in the art will understand that the components of the seat assembly 900, in particular the control system 904, may be utilized along with any of the previously described seat assemblies 10, 310, 410, 510, 610, 710, 810 or any combination of the previously described seat assemblies 10, 310, 410, 510, 610, 710, 810.

As shown in FIGS. 24A and 24B, the seat assembly 900 includes a control system 904 having at least one controller 908, the control system 904 being operable to control various components of the seat assembly 900, in particular the actuator 60 or elastic member 60 and in turn the armrest 20. Specifically, as shown in FIG. 24A, the controller 908 is operably connected to the actuator 60 or the elastic member 60 and configured to control the actuator 60 or the elastic member 60. In some embodiments, the controller 908 may be advantageous in controlling the types of actuators described above that are selectively actuated, such as the gas spring 60, the linear actuator 360, and the rotary motor 460.

It is noted that although the remainder of the description of the control system 904 refers to the actuators 60 and not elastic members 60, a person skilled in the art will understand that the controller 908 can potentially be utilized with the elastic members 60 such as the springs described above, for example, in possible implementations in which the spring has a release mechanism to allow for the spring to release and thus return the armrest 24 to the deployed position. Moreover, it is noted that although only the actuator 60 is mentioned in the remainder of the description of the control system 904, the control system 904 may be utilized with any of the previously described seat assemblies 10, 310, 410, 510, 610, 710, 810 and their respective actuators or elastic members.

The controller 908 is shown in FIG. 24C. The controller 908 may include a memory 908M, and a processor 908P. The memory 908M and processor 908P are in communication with each other. The processor 908P may be embodied as any type of computational processing tool or equipment capable of performing the functions described herein. For example, the processor 908P may be embodied as a single or multi-core processor(s), digital signal processor, microcontroller, or other processor or processing/controlling circuit.

The memory 908M may be embodied as any type of volatile or non-volatile memory or data storage capable of performing the functions described herein, and may include additional storage 908S. Moreover, the controller 908 may also include additional or alternative components, such as those commonly found in a computer (e.g., various input/output devices, resistors, capacitors, etc.). In other embodiments, one or more of the illustrative controllers 908 of components may be incorporated in, or otherwise form a portion of, another component. For example, the memory 908M, or portions thereof, may be incorporated in the processor 908P.

In operation, the memory 908M may store various data and software used during operation of the controller 908 such as operating systems, applications, programs, libraries, and drivers. The memory 908M is communicatively coupled to the processor 908P via an I/O subsystem, which may be embodied as circuitry and/or components to facilitate input/output operations with the processor 908P, the memory 908M, and other components of the controller 908. In one embodiment, the memory 908M may be directly coupled to the processor 908P, for example via an integrated memory controller hub. Additionally, in some embodiments, the I/O subsystem may form a portion of a system-on-a-chip (SoC) and be incorporated, along with the processor 908P, the memory 908M, and/or other components of the controller 908, on a single integrated circuit chip (not shown).

The components of the communication network 908C may be configured to use any one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.) to effect such communication among and between system components and devices as described above, including but not limited to between a user interface 908UI and the controller 908. An external operator 908EO may control the controller 908, and in some embodiments, control the controller 908 via the user interface 908UI.

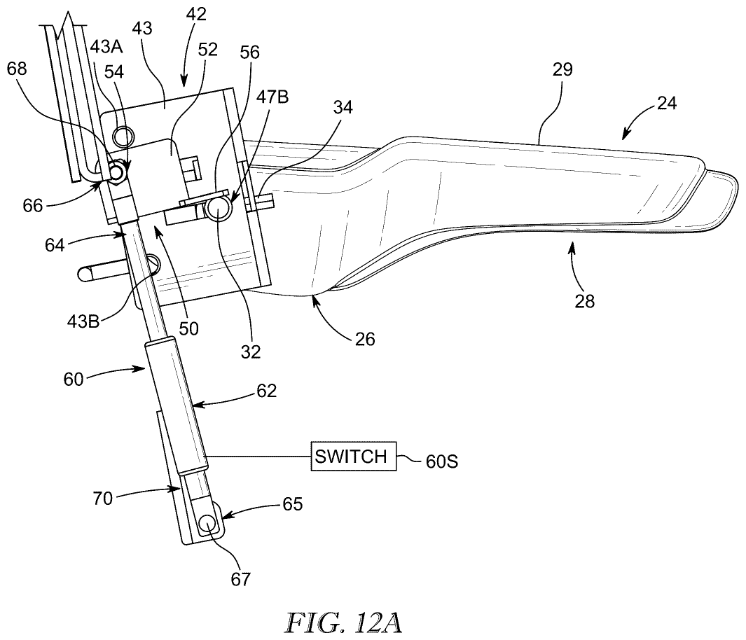

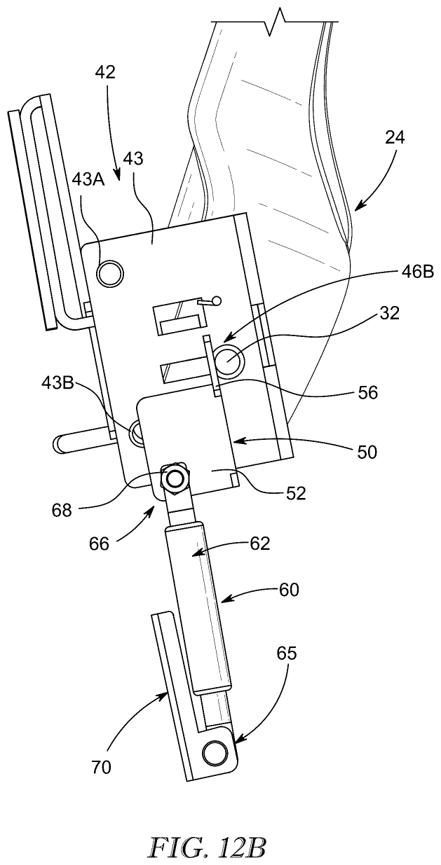

Illustratively, the controller 908 is configured to control the first actuator 60 so as to move the armrest 24 to the deployed position in response to the armrest 24 having been moved away from the deployed position to the stowed position or any position between the stowed position and the deployed position. For example, the gas spring 60 may include a switch 60S (FIG. 12A) operably connected to the controller 908 and configured to control movement of gas spring between and including the starting position and the engaged position. The controller 908 can also be operably connected to the motor 372 of the linear actuator 360 or the drive motor 470 of the rotatory motor 460 so as to control the actuators 360, 460 and thus movement of the armrest 24. In some embodiments, the linear actuator 360 may be one of mechanical, pneumatic, hydraulic, or electric.

In some embodiments, the vehicle system 900 (seat assembly 900) further includes at least one sensor 912, 914, 916, 917, 918, 919 as shown in FIGS. 24A and 24B. In some embodiments, at least one sensor includes a force sensor 912, 914 configured to measure a movement force being applied to the armrest 24 for moving the armrest 24 from the deployed position toward the stowed position. In some embodiments, at least one sensor includes a rotary position sensor 912, 914 configured to measure a rotational position of at least one of the pivot rod 32 or the armrest 24 so as to determine whether the armrest 24 has been moved away from the deployed position toward the stowed position. The force and rotary position sensors 912, 914 can be arranged proximate to the armrest 24 in order to effectively measure their respective parameters, as shown in FIG. 24A.

Illustratively, the controller 908 is configured to control the actuator 60 in response to the armrest 24 having been moved away from the deployed position to the stowed position or any position between the stowed position and the deployed position via application of the movement force and in response to the movement force being applied to the armrest 24 being less than a predetermined force value as detected by the force sensor 912, 914 such that the actuator 60 moves the armrest 24 back to the deployed position.

In some embodiments, the controller 908 is configured to automatically control the actuator 60 to return the armrest 24 back to the deployed position in response to the movement force being less than the predetermined force value. In some embodiments, the predetermined force value may be preset via the controller 908. In some embodiments, the predetermined force value may be zero (i.e. an occupant completely letting go of the armrest 24 and allowing it to return to the deployed position).

In some exemplary embodiments, the controller 908 is configured to control the actuator 60 in response to the rotary position sensor 912, 914 detecting that the armrest 24 has been moved away from the deployed position to the stowed position or any position between the stowed position and the deployed position such that the actuator 60 moves the armrest 24 back to the deployed position. In some embodiments, the vehicle system 900 (seat assembly 900) further includes a touch sensor 912T arranged in the armrest 24 and configured to detect whether an occupant 200 is touching the armrest 24. This can ensure that the controller 908 does not return the armrest 24 to the deployed position while the occupant is still attempting to move the armrest 24 toward the stowed position. The controller can be configured to automatically control the actuator 60 to return the armrest 24 back to the deployed position in response to the armrest 24 having been moved away from the deployed position to the stowed position or any position between the stowed position and the deployed position and the touch sensor 912T detecting that the occupant 200 has not touched the armrest 24 for a predetermined period of time. The predetermined period of time may be any reasonable time for which an occupant will likely have let go of the armrest 24 to allow it to return to the deployed position, such as two, three, four, or five seconds. In some embodiments, the controller 908 can be restricted from returning the armrest 24 to the deployed position unless certain criteria are met in order to ensure safe operation of the armrest 24, such as the occupant 200 being seated on the seat frame assembly 12, as described below.

In some embodiments, the seat assembly 10 further includes at least one sensor 916, 917, 918, 919 configured to detect whether an occupant 200 is seated on the seat frame assembly 12 and within an outer boundary of a seating area of the seat assembly 10. This seating area may be delimited by the edges of the cushioned covers 15A, 15B, 16A, 16B and the passenger and driver side armrests 24. The controller is configured to control the actuator 60 in response to the armrest 24 having been moved away from the deployed position to the stowed position or any position between the stowed position and the deployed position and in response to the at least one sensor 916, 917, 918, 919 detecting that the occupant 200 is seated on the seat assembly 10 and within the outer boundary of the seating area such that the actuator 60 moves the armrest 24 back to the deployed position.

In some embodiments, the sensor 916, 917, 918, 919 includes at least one of a camera (shown as camera 922 in FIG. 24B), a pressure sensor configured to detect pressure of the occupant being seated on the seat assembly, a laser, an RFID chip, an infrared sensor, a proximity sensor, an image recognition, an acoustic sensor, or a vibratory sensor. In some embodiments, these sensors may also be used in conjunction with or in place of the sensors 912, 914 described above, such as a proximity sensor configured to detect whether the occupant has moved their limbs out of the movement path of the armrest 24 so as to permit the controller 908 to return the armrest 24 to the deployed position.

In some exemplary embodiments, the controller 908 is configured to automatically control the actuator 60 to return the armrest 24 back to the deployed position in response to the at least one sensor 916, 917, 918, 919 detecting that the occupant 200 is seated on the seat assembly 10 and within the outer boundary of the seating area.

The vehicle system 900 can further include an engine ignition switch 130 and a drivetrain 140 of the vehicle 100 that are each operably connected to the controller 908, as shown in FIG. 24A. In some embodiments, the controller 908 is configured to restrict at least one of a switching capability of the engine ignition switch 130 or restrict selective engagement of the drivetrain 140 in response to the armrests 24 having been moved away from the deployed position to the stowed position or any position between the stowed position and the deployed position. This ensures that the vehicle 100 cannot be operated unless both armrests 24 are in their deployed positions, thus meeting the safety standards described above. The controller 908 can be further configured to enable at least one of the switching capability of the engine ignition switch 130 or selective engagement of the drivetrain 140 in response to the armrest 24 having been moved from the stowed position or any position between the stowed position and the deployed position to the deployed position via the controller 908 actuating the actuator 60.

A method according to a further aspect of the present disclosure includes a first operational step of providing a seat frame assembly 12 of a vehicle including a seat bottom frame 14B′, 14B″″′ and a seat back frame 14 extending upwardly away from the seat bottom frame 14B′, 14B″″′, the seat back frame 14 including a first support bar 14A. The method further includes a second operational step of coupling a mounting bracket 42 of a first armrest assembly 20 to the first support bar 14A of the seat back frame 14.

The method further includes a third operational step of pivotably mounting a first armrest 24 of the armrest assembly 20 on the mounting bracket, the first armrest 24 being configured to be moved between a deployed position and a stowed position, the first armrest 24 including a pivot rod 32 extending through the mounting bracket 42 so as to enable pivoting of the first armrest 24 relative to the mounting bracket 42. The method further includes a fourth operational step of mounting at least one of a first actuator 60 or a first elastic member 60 on the pivot rod 32 of the first armrest 24 and on at least one of the seat frame assembly 12 or the mounting bracket 42, the at least one of a first actuator 60 or a first elastic member 60 configured to move the first armrest 24 to the deployed position in response to the first armrest 24 having been moved away from the deployed position to the stowed position or any position between the stowed position and the deployed position.

An additional method according to a further aspect of the present disclosure includes a first operational step of providing a seat assembly 10 including a seat frame assembly 12 and an armrest assembly 20. The method can further include a second operational step of coupling the armrest assembly 20 to the seat frame assembly 12, the armrest assembly 20 including an armrest 24 pivotably mounted on the seat frame assembly 12 and configured to be moved between a deployed position and a stowed position, the armrest assembly 20 further including an actuator 60 mounted on the armrest 24 and on the seat frame assembly 12.

The method can further include a third operational step of operably connecting a control system 904 including a controller 908 to the actuator 60, the controller 908 being configured to control the actuator 60. The method can further include a fourth operational step of moving the armrest 24 away from the deployed position to the stowed position or any position between the stowed position and the deployed position, and a fifth operational step of controlling, via the controller 908, the actuator 60 so as to move the armrest 24 to the deployed position in response to the armrest 24 having been moved away from the deployed position to the stowed position or any position between the stowed position and the deployed position.

The method can include a further operational step of controlling, via the controller 908, the actuator 60 in response to the armrest 24 having been moved away from the deployed position to the stowed position or any position between the stowed position and the deployed position and in response to a movement force being applied to the armrest 24 for moving the armrest 24 from the deployed position toward the stowed position being less than a predetermined force value such that the actuator 60 moves the armrest 24 back to the deployed position.

The method can include a further operational step of controlling, via the controller 908, the actuator 60 in response to the armrest 24 having been moved away from the deployed position to the stowed position or any position between the stowed position and the deployed position and in response to at least one sensor 916, 917, 918, 919 detecting that an occupant 200 is seated on the seat assembly 10 and within an outer boundary of a seating area such that the actuator 60 moves the armrest 24 back to the deployed position.

The method can include further operational steps of operably connecting the controller to the at least one of an engine ignition switch 130 or a drivetrain 140 of a vehicle 100, restricting, via the controller, at least one of a switching capability of the engine ignition switch 130 or selective engagement of the drivetrain 140 in response to the armrest 24 having been moved away from the deployed position to the stowed position or any position between the stowed position and the deployed position, and enabling, via the controller, at least one of the switching capability of the engine ignition switch 130 or selective engagement of the drivetrain 140 in response to the armrest 24 having been moved from the stowed position or any position between the stowed position and the deployed position to the deployed position via the controller 908 actuating the actuator 60.

It is to be understood that while the invention has been described in this document with respect to a specific but illustrative embodiment, various configurational and size changes may be made within the scope of the invention described and claimed herein. The drawings, although not fully dimensioned, are to scale.

The following numbered clauses include embodiments that are contemplated and non-limiting:
Clause 1. A seat assembly for a vehicle comprises a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket.
Clause 2. The seat assembly of clause 1, any other clause, or combination of clauses, wherein the first armrest assembly further includes at least one of a first actuator or a first elastic member mounted on the pivot rod of the first armrest and on at least one of the seat frame assembly or the mounting bracket, the at least one of the first actuator or the first elastic member configured to move the first armrest to the deployed position in response to the first armrest having been moved away from the deployed position to the stowed position or any position between the stowed position and the deployed position.
Clause 3. The seat assembly of clause 2, any other clause, or combination of clauses, wherein the at least one of the first actuator or the first elastic member is movable between a starting position in which the first armrest is in the deployed position and an engaged position in which the first armrest is in the stowed position or any position between the stowed position and the deployed position.
Clause 4. The seat assembly of clause 3, any other clause, or combination of clauses, wherein the at least one of the first actuator or the first elastic member is configured to generate a force on the first armrest in response to being in the engaged position as to bias the first armrest toward the deployed position.
Clause 5. The seat assembly of clause 4, any other clause, or combination of clauses, wherein, in response to the force being greater than a movement force being applied to the first armrest for moving the first armrest from the deployed position toward the stowed position, the at least one of the first actuator or the first elastic member moves the first armrest into the deployed position.
Clause 6. The seat assembly of clause 5, any other clause, or combination of clauses, wherein the pivot rod rotates in a first rotational direction in response to the first armrest moving toward the stowed position.
Clause 7. The seat assembly of clause 6, any other clause, or combination of clauses, wherein the pivot rod rotates in a second rotational direction opposite the first rotational direction in response to the first armrest moving toward the deployed position.
Clause 8. The seat assembly of clause 7, any other clause, or combination of clauses, wherein the at least one of the first actuator or the first elastic member is configured to generate the force on the first armrest in the second rotational direction in response to being in the engaged position as to bias the first armrest to the deployed position.
Clause 9. The seat assembly of clause 2, any other clause, or combination of clauses, wherein the first armrest includes an inner frame member having a main portion and a cantilevered portion extending away from the main portion.
Clause 10. The seat assembly of clause 9, any other clause, or combination of clauses, wherein the first armrest further includes a cover that encloses the inner frame member.
Clause 11. The seat assembly of clause 10, any other clause, or combination of clauses, wherein the cover is shaped complimentarily to the inner frame member.
Clause 12. The seat assembly of clause 10, any other clause, or combination of clauses, wherein the pivot rod is fixedly coupled to the inner frame member such that movement of the first armrest between the deployed and stowed positions rotates the pivot rod.
Clause 13. The seat assembly of clause 2, any other clause, or combination of clauses, wherein the mounting bracket includes a first wall, a second wall spaced apart from the first wall, and a forward wall extending between and interconnecting the first and second walls.
Clause 14. The seat assembly of clause 13, any other clause, or combination of clauses, wherein the first support bar of the seat back frame is coupled to at least one of the first and second walls.
Clause 15. The seat assembly of clause 14, any other clause, or combination of clauses, wherein the first support bar of the seat back frame extends between the first and second walls and is coupled to both of the first and second walls so as to couple the mounting bracket to the seat back frame.
Clause 16. The seat assembly of clause 15, any other clause, or combination of clauses, wherein the first and second walls include corresponding openings formed therethrough.
Clause 17. The seat assembly of clause 16, any other clause, or combination of clauses, wherein the pivot rod of the first armrest extends through the openings of the first and second walls such that the first armrest is configured to pivot relative to the mounting bracket.
Clause 18. The seat assembly of clause 17, any other clause, or combination of clauses, wherein the first wall of the mounting bracket further includes a first tab extending inwardly away from the first wall.
Clause 19. The seat assembly of clause 18, any other clause, or combination of clauses, wherein the pivot rod includes a movement delimiting extension extending away from an outer surface of the pivot rod.
Clause 20. The seat assembly of clause 19, any other clause, or combination of clauses, wherein the first tab extends into a path along which the movement delimiting extension moves during movement of the first armrest in a first rotational direction from the deployed position to the stowed position such that the movement delimiting extension engages the first tab in response to the first armrest reaching the stowed position such that the first tab delimits movement of the first armrest in the first rotational direction at the stowed position.
Clause 21. The seat assembly of clause 20, any other clause, or combination of clauses, wherein the forward wall includes a second opening formed therethrough and aligned with the movement delimiting extension.
Clause 22. The seat assembly of clause 21, any other clause, or combination of clauses, wherein the movement delimiting extension engages a bottom side of the second opening in response to the first armrest being in the deployed position such that the second opening delimits movement of the first armrest in a second rotational direction opposite the first rotational direction at the deployed position.
Clause 23. The seat assembly of clause 8, any other clause, or combination of clauses, wherein the at least one of the first actuator or the first elastic member includes a gas spring.
Clause 24. The seat assembly of clause 23, any other clause, or combination of clauses, wherein the gas spring includes a hollow cylinder, a piston arranged within the hollow cylinder and movable therein, and a piston rod coupled to the piston and extending outwardly away from the hollow cylinder.
Clause 25. The seat assembly of clause 24, any other clause, or combination of clauses, wherein a first end of the piston rod is movably coupled to the piston and a second end of the piston rod opposite the first end is coupled to the pivot rod of the first armrest.
Clause 26. The seat assembly of clause 25, any other clause, or combination of clauses, wherein the piston rod extends outwardly from a first end of the hollow cylinder.
Clause 27. The seat assembly of clause 26, any other clause, or combination of clauses, wherein a second end of the hollow cylinder opposite the first end is movably coupled to the seat frame assembly.
Clause 28. The seat assembly of clause 27, any other clause, or combination of clauses, wherein, in response to the first armrest being in the deployed position, the gas spring is in the starting position in which the piston rod is extended away from the hollow cylinder such that the second end of the piston rod is located a first distance away from the hollow cylinder,
Clause 29. The seat assembly of clause 28, any other clause, or combination of clauses, wherein, in response to the first armrest being in the stowed position, the gas spring is in the engaged position in which the piston rod is compressed toward the hollow cylinder such that the second end of the piston rod is located a second distance away from the hollow cylinder, and wherein the first distance is greater than the second distance.
Clause 30. The seat assembly of clause 29, any other clause, or combination of clauses, wherein movement of the first armrest toward the stowed position progressively compresses the second end of the piston rod toward the hollow cylinder such that, in response to the first armrest having been moved away from the deployed position to the stowed position or any position between the stowed position and the deployed position, the compression of the piston rod biases the piston rod toward the starting position so as to bias the first armrest toward the deployed position.
Clause 31. The seat assembly of clause 30, any other clause, or combination of clauses, wherein the first armrest is configured to return to the deployed position via the biasing of the gas spring in response to a compression force of the gas spring being greater than a movement force being applied to the first armrest for moving the first armrest from the deployed position toward the stowed position.
Clause 32. The seat assembly of clause 31, any other clause, or combination of clauses, wherein the pivot rod further includes a connection plate.
Clause 33. The seat assembly of clause 32, any other clause, or combination of clauses, wherein a first end of the connection plate is coupled to and extends radially away from the pivot rod.
Clause 34. The seat assembly of clause 33, any other clause, or combination of clauses, wherein the second end of the piston rod is spaced apart in a rearward direction from the pivot rod.
Clause 35. The seat assembly of clause 34, any other clause, or combination of clauses, wherein the connection plate further includes a second end opposite the first end that is coupled to the second end of the piston rod.
Clause 36. The seat assembly of clause 35, any other clause, or combination of clauses, wherein the connection plate includes a base plate and a vertical plate extending upwardly away from the base plate.
Clause 37. The seat assembly of clause 36, any other clause, or combination of clauses, wherein the first end of the connection plate is located at a forward end of the base plate such that the pivot rod is coupled to the forward end of the base plate.
Clause 38. The seat assembly of clause 37, any other clause, or combination of clauses, wherein the second end of the connection plate is located at a rear end of the vertical plate such that the second end of the piston rod is coupled to the rear end of the vertical plate.
Clause 39. The seat assembly of clause 38, any other clause, or combination of clauses, wherein the second end of the piston rod is pivotably coupled to the rear end of the vertical plate so as to enable to the connection plate to pivot relative to the gas spring during movement of the first armrest between the deployed and stowed positions.
Clause 40. The seat assembly of clause 32, any other clause, or combination of clauses, wherein the piston rod extends outwardly from a first end of the hollow cylinder.
Clause 41. The seat assembly of clause 40, any other clause, or combination of clauses, wherein a second end of the hollow cylinder opposite the first end is movably coupled to the seat back frame.
Clause 42. The seat assembly of clause 41, any other clause, or combination of clauses, wherein the seat back frame includes a second support bar spaced apart from the first support bar.
Clause 43. The seat assembly of clause 42, any other clause, or combination of clauses, wherein the second end of the hollow cylinder is movably coupled to the second support bar.
Clause 44. The seat assembly of clause 43, any other clause, or combination of clauses, wherein the first support bar is located on an outer side of the seat back frame such that the first armrest is arranged on an outer side of the vehicle.
Clause 45. The seat assembly of clause 44, any other clause, or combination of clauses, wherein the second support bar is spaced apart from the first support bar in an inward direction away from the outer side of the seat back frame.
Clause 46. The seat assembly of clause 45, any other clause, or combination of clauses, wherein the hollow cylinder is movably coupled to the seat back frame at a first connection point.
Clause 47. The seat assembly of clause 46, any other clause, or combination of clauses, wherein the second end of the piston rod is coupled to the connection plate at a second connection point.
Clause 48. The seat assembly of clause 47, any other clause, or combination of clauses, wherein the first connection point is located below the second connection point at all positions of the connection plate as it rotates relative to the seat back frame during movement of the first armrest.
Clause 49. The seat assembly of clause 48, any other clause, or combination of clauses, wherein the hollow cylinder is movably coupled to the seat back frame at a first connection point.
Clause 50. The seat assembly of clause 49, any other clause, or combination of clauses, wherein the second end of the piston rod is coupled to the connection plate at a second connection point.
Clause 51. The seat assembly of clause 50, any other clause, or combination of clauses, wherein the first connection point is located above the second connection point at all positions of the connection plate as it rotates relative to the seat back frame during movement of the first armrest.
Clause 52. The seat assembly of clause 32, any other clause, or combination of clauses, wherein the piston rod extends outwardly from a first end of the hollow cylinder.
Clause 53. The seat assembly of clause 52, any other clause, or combination of clauses, wherein a second end of the hollow cylinder opposite the first end is movably coupled to the seat bottom frame.
Clause 54. The seat assembly of clause 53, any other clause, or combination of clauses, wherein the hollow cylinder is movably coupled to the seat bottom frame at a first connection point.
Clause 55. The seat assembly of clause 54, any other clause, or combination of clauses, wherein the second end of the piston rod is coupled to the connection plate at a second connection point.
Clause 56. The seat assembly of clause 55, any other clause, or combination of clauses, wherein the first connection point is forward of the second connection point at all positions of the connection plate as it rotates relative to the seat back frame during movement of the first armrest.
Clause 57. The seat assembly of clause 32, any other clause, or combination of clauses, wherein the seat frame assembly further includes a rear frame assembly spaced apart from the seat back frame in the rearward direction.
Clause 58. The seat assembly of clause 57, any other clause, or combination of clauses, wherein the piston rod extends outwardly from a first end of the hollow cylinder.
Clause 59. The seat assembly of clause 58, any other clause, or combination of clauses, wherein a second end of the hollow cylinder opposite the first end is movably coupled to the rear frame assembly.
Clause 60. The seat assembly of clause 59, any other clause, or combination of clauses, wherein the hollow cylinder is movably coupled to the rear frame assembly at a first connection point.
Clause 61. The seat assembly of clause 60, any other clause, or combination of clauses, wherein the second end of the piston rod is coupled to the connection plate at a second connection point.
Clause 62. The seat assembly of clause 61, any other clause, or combination of clauses, wherein the first connection point is rearward of the second connection point at all positions of the connection plate as it rotates relative to the seat back frame during movement of the first armrest.
Clause 63. The seat assembly of clause 8, any other clause, or combination of clauses, wherein the at least one of the first actuator or the first elastic member includes a linear actuator.
Clause 64. The seat assembly of clause 63, any other clause, or combination of clauses, wherein the linear actuator includes a hollow cylinder, a piston rod extending outwardly away from the hollow cylinder, and a motor configured to move the piston rod away from and toward the hollow cylinder.
Clause 65. The seat assembly of clause 64, any other clause, or combination of clauses, wherein a first end of the piston rod is coupled to a connection plate of the pivot rod of the first armrest.
Clause 66. The seat assembly of clause 65, any other clause, or combination of clauses, wherein the piston rod extends outwardly from a first end of the hollow cylinder.
Clause 67. The seat assembly of clause 66, any other clause, or combination of clauses, wherein a second end of the hollow cylinder opposite the first end is movably coupled to the seat frame assembly.
Clause 68. The seat assembly of clause 67, any other clause, or combination of clauses, wherein, in response to the first armrest being in the deployed position, the linear actuator is in the starting position in which the piston rod is extended away from the hollow cylinder such that the second end of the piston rod is located a first distance away from the hollow cylinder.
Clause 69. The seat assembly of clause 68, any other clause, or combination of clauses, wherein, in response to the first armrest being in the stowed position, the linear actuator is in the engaged position in which the piston rod is retracted toward the hollow cylinder such that the second end of the piston rod is located a second distance away from the hollow cylinder, and wherein the first distance is greater than the second distance.
Clause 70. The seat assembly of clause 69, any other clause, or combination of clauses, wherein the motor is operably connected to the piston rod and is configured to selectively move the piston rod away from and toward the hollow cylinder.
Clause 71. The seat assembly of clause 70, any other clause, or combination of clauses, wherein, in response to the first armrest having been moved away from the deployed position to the stowed position or any position between the stowed position and the deployed position, the motor is configured to move the piston rod away from the hollow cylinder until the first armrest returns to the deployed position.
Clause 72. The seat assembly of clause 71, any other clause, or combination of clauses, wherein the motor is configured to automatically move the first armrest to the deployed position in response to the first armrest having been moved away from the deployed position to the stowed position or any position between the stowed position and the deployed position and in response to a movement force being applied to the first armrest for moving the first armrest from the deployed position toward the stowed position is below a predetermined force value.
Clause 73. The seat assembly of clause 72, any other clause, or combination of clauses, wherein the predetermined force value is zero.
Clause 74. The seat assembly of clause 24, any other clause, or combination of clauses, wherein a first end of the piston rod is movably coupled to the piston and a second end of the piston rod opposite the first end is coupled to the seat frame assembly.
Clause 75. The seat assembly of clause 74, any other clause, or combination of clauses, wherein the piston rod extends outwardly from a first end of the hollow cylinder.
Clause 76. The seat assembly of clause 75, any other clause, or combination of clauses, wherein a second end of the hollow cylinder opposite the first end is movably coupled to the pivot rod of the first armrest.
Clause 77. The seat assembly of clause 76, any other clause, or combination of clauses, wherein, in response to the first armrest being in the deployed position, the gas spring is in the starting position in which the piston rod is extended away from the hollow cylinder such that the second end of the piston rod is located a first distance away from the hollow cylinder.
Clause 78. The seat assembly of clause 77, any other clause, or combination of clauses, wherein, in response to the first armrest being in the stowed position, the gas spring is in the engaged position in which the piston rod is compressed toward the hollow cylinder such that the second end of the piston rod is located a second distance away from the hollow cylinder, and wherein the first distance is greater than the second distance.
Clause 79. The seat assembly of clause 78, any other clause, or combination of clauses, wherein the pivot rod further includes a connection plate, wherein a first end of the connection plate is coupled to and extends radially away from a first terminal end of the pivot rod.
Clause 80. The seat assembly of clause 79, any other clause, or combination of clauses, wherein the second end of the hollow cylinder is spaced apart in a rearward direction from the pivot rod.
Clause 81. The seat assembly of clause 80, any other clause, or combination of clauses, wherein the connection plate further includes a second end opposite the first end that is coupled to the second end of the hollow cylinder.
Clause 82. The seat assembly of clause 8, any other clause, or combination of clauses, wherein the at least one of the first actuator or the first elastic member includes a rotary motor.
Clause 83. The seat assembly of clause 82, any other clause, or combination of clauses, wherein the rotary motor includes a drive motor operably connected to the pivot rod of the first armrest and configured to selectively rotate the pivot rod in a first rotational direction toward the stowed position and in a second rotational direction opposite the first rotational direction toward the deployed position.
Clause 84. The seat assembly of clause 83, any other clause, or combination of clauses, wherein, in response to the first armrest having been moved away from the deployed position to the stowed position or any position between the stowed position and the deployed position, the drive motor is configured to rotate the pivot rod in the second rotational direction until the first armrest returns to the deployed position.
Clause 85. The seat assembly of clause 84, any other clause, or combination of clauses, wherein the drive motor is configured to automatically move the first armrest to the deployed position in response to the first armrest having been moved away from the deployed position to the stowed position or any position between the stowed position and the deployed position and in response to a movement force being applied to the first armrest for moving the first armrest from the deployed position toward the stowed position is below a predetermined force value.
Clause 86. The seat assembly of clause 85, any other clause, or combination of clauses, wherein the predetermined force value is zero.
Clause 87. The seat assembly of clause 86, any other clause, or combination of clauses, wherein the mounting bracket includes a gear rod extending away from a wall of the mounting bracket and parallel to the pivot rod.
Clause 88. The seat assembly of clause 87, any other clause, or combination of clauses, wherein the rotary motor further includes a first gear fixedly coupled to the pivot rod and a second gear rotatably coupled to the gear rod.
Clause 89. The seat assembly of clause 88, any other clause, or combination of clauses, wherein the second gear is configured to engage the first gear such that rotation of the second gear in the second rotational direction rotates the first gear in the first rotational direction and rotation of the second gear in the first rotational direction rotates the first gear in the second rotational direction.
Clause 90. The seat assembly of clause 89, any other clause, or combination of clauses, wherein the drive motor is coupled to the second gear and is configured to rotate the second gear in the first rotational direction so as to rotate the first gear in the second rotational direction so as to move the first armrest toward the deployed position.
Clause 91. The seat assembly of clause 90, any other clause, or combination of clauses, wherein the first gear has a first diameter and a first set of gear teeth, wherein the second gear has a second diameter and a second set of gear teeth.
Clause 92. The seat assembly of clause 91, any other clause, or combination of clauses, wherein the first diameter is greater than the second diameter and the first set of gear teeth has more gear teeth than the second set of gear teeth.
Clause 93. The seat assembly of clause 8, any other clause, or combination of clauses, wherein the at least one of the first actuator or the first elastic member includes a tension spring.
Clause 94. The seat assembly of clause 93, any other clause, or combination of clauses, wherein a first end of the tension spring is coupled to the seat back frame and a second end of the tension spring opposite the first end is coupled to a connection plate that is coupled to and extends radially away from the pivot rod.
Clause 95. The seat assembly of clause 94, any other clause, or combination of clauses, wherein, in response to the first armrest being in the deployed position, the tension spring is in the starting position in which the spring is at rest and a first connection point at which the first end of the tension spring is coupled to the seat back frame is a first distance from a second connection point at which the second end of the tension spring is coupled to the connection plate.
Clause 96. The seat assembly of clause 95, any other clause, or combination of clauses, wherein, in response to the first armrest being in the stowed position, the tension spring is in the engaged position in which the tension spring is stretched such that the first connection point is located a second distance away from the first connection point, and wherein the first distance is less than the second distance.
Clause 97. The seat assembly of clause 96, any other clause, or combination of clauses, wherein movement of the first armrest toward the stowed position which causes the pivot rod to rotate in a first rotational direction progressively stretches the tension spring such that, in response to the first armrest having been moved away from the deployed position to the stowed position or any position between the stowed position and the deployed position, the stretching of the tension spring biases the tension spring toward the starting position so as to bias the first armrest toward the deployed position.
Clause 98. The seat assembly of clause 97, any other clause, or combination of clauses, wherein a first end of the connection plate is coupled to and extends radially away from a first terminal end of the pivot rod.
Clause 99. The seat assembly of clause 98, any other clause, or combination of clauses, wherein the second end of the tension spring is spaced apart in a rearward direction from the pivot rod.
Clause 100. The seat assembly of clause 99, any other clause, or combination of clauses, wherein the connection plate further includes a second end opposite the first end that is coupled to the second end of the tension spring.
Clause 101. The seat assembly of clause 100, any other clause, or combination of clauses, wherein the first connection point is above the second connection point.
Clause 102. The seat assembly of clause 101, any other clause, or combination of clauses, wherein the first armrest is configured to return to the deployed position via the biasing of the tension spring in response to a spring force of the tension spring being greater than a movement force being applied to the first armrest for moving the first armrest from the deployed position toward the stowed position.
Clause 103. The seat assembly of clause 8, any other clause, or combination of clauses, wherein the at least one of the first actuator or the first elastic member includes a torsion spring.
Clause 104. The seat assembly of clause 103, any other clause, or combination of clauses, wherein the torsion spring includes a central coil that is wrapped around the pivot rod and includes a first end and a second end opposite the first end.
Clause 105. The seat assembly of clause 104, any other clause, or combination of clauses, wherein the pivot rod of the first armrest includes a first protrusion extending radially away from the pivot rod.
Clause 106. The seat assembly of clause 105, any other clause, or combination of clauses, wherein the first end of the torsion spring is coupled to the first protrusion.
Clause 107. The seat assembly of clause 106, any other clause, or combination of clauses, wherein the mounting bracket includes a first wall, a second wall spaced apart from the first wall, and a forward wall extending between and interconnecting the first and second walls.
Clause 108. The seat assembly of clause 107, any other clause, or combination of clauses, wherein the first support bar of the seat back frame is coupled to at least one of the first and second walls.
Clause 109. The seat assembly of clause 108, any other clause, or combination of clauses, wherein the first wall includes a first inner protrusion extending away from an inner surface of the first wall and the second wall includes a second inner protrusion extending away from an inner surface of the second wall.
Clause 110. The seat assembly of clause 109, any other clause, or combination of clauses, wherein the second end of the torsion spring contacts and engages the first and second inner protrusions.
Clause 111. The seat assembly of clause 110, any other clause, or combination of clauses, wherein the first end of the torsion spring includes a looped portion that loops around and is coupled to a forward-facing surface of the first protrusion of the pivot rod.
Clause 112. The seat assembly of clause 111, any other clause, or combination of clauses, wherein the second end of the torsion spring contacts a forward-facing surface of the first and second inner protrusions.
Clause 113. The seat assembly of clause 112, any other clause, or combination of clauses, wherein, in response to the first armrest having been moved away from the deployed position to the stowed position or any position between the stowed position and the deployed position which causes rotation of the pivot rod in a first rotational direction, the coupling of the looped portion with the first protrusion causes the second end to engage the first and second inner protrusions such that the torsion spring is twisted and stores mechanical energy therein.
Clause 114. The seat assembly of clause 113, any other clause, or combination of clauses, wherein the stored mechanical energy from the twisting of the torsion spring biases the pivot rod in a second rotational direction opposite the first rotational direction so as to bias the first armrest toward the deployed position.
Clause 115. The seat assembly of clause 114, any other clause, or combination of clauses, wherein the first armrest is configured to return to the deployed position via the biasing of the torsion spring in the second rotational direction in response to a spring force of the torsion spring being greater than a movement force being applied to the first armrest for moving the first armrest from the deployed position toward the stowed position.
Clause 115. The seat assembly of clause 8, any other clause, or combination of clauses, wherein the at least one of the first actuator or the first elastic member includes a clock spring.
Clause 116. The seat assembly of clause 115, any other clause, or combination of clauses, wherein the clock spring is wound around itself in a spiral shape around the pivot rod and includes a first end coupled to the pivot rod of the first armrest and a second end opposite the first end.
Clause 117. The seat assembly of clause 116, any other clause, or combination of clauses, wherein the mounting bracket includes a first wall, a second wall spaced apart from the first wall, and a forward wall extending between and interconnecting the first and second walls.
Clause 118. The seat assembly of clause 117, any other clause, or combination of clauses, wherein the first support bar of the seat back frame is coupled to at least one of the first and second walls.
Clause 119. The seat assembly of clause 118, any other clause, or combination of clauses, wherein the first wall includes a first outer protrusion extending away from the first wall in a direction away from the first armrest.
Clause 120. The seat assembly of clause 119, any other clause, or combination of clauses, wherein the second end of the clock spring is coupled to the first outer protrusion.
Clause 121. The seat assembly of clause 120, any other clause, or combination of clauses, wherein, in response to the first armrest having been moved away from the deployed position to the stowed position or any position between the stowed position and the deployed position which causes rotation of the pivot rod in a first rotational direction, stretching of the clock spring biases the pivot rod in a second rotational direction opposite the first rotational direction so as to bias the first armrest toward the deployed position.
Clause 122. The seat assembly of clause 121, any other clause, or combination of clauses, wherein the first armrest is configured to return to the deployed position via the biasing of the clock spring in the second rotational direction in response to a spring force of the clock spring being greater than a movement force being applied to the first armrest for moving the first armrest from the deployed position toward the stowed position.
Clause 122. The seat assembly of clause 8, any other clause, or combination of clauses, wherein the at least one of the first actuator or the first elastic member includes a guided coil spring.
Clause 123. The seat assembly of clause 122, any other clause, or combination of clauses, wherein the guided coil spring includes a hollow cylinder, a guide rod arranged partially inside the hollow cylinder and extending outwardly away from the hollow cylinder, and a coil spring surrounding the guide rod and having a first end coupled to a first end of the guide rod and a second end opposite the first end and coupled to a first outer end of the hollow cylinder, and wherein the hollow cylinder guides movement of the guide rod therein.
Clause 124. The seat assembly of clause 123, any other clause, or combination of clauses, wherein the first end of the guide rod is coupled to the seat back frame.
Clause 125. The seat assembly of clause 124, any other clause, or combination of clauses, wherein a second end of the hollow cylinder opposite the first end is movably coupled to a connection plate of the pivot rod of the first armrest.
Clause 126. The seat assembly of clause 125, any other clause, or combination of clauses, wherein, in response to the first armrest being in the deployed position, the guided coil spring is in the starting position in which the guide rod is extended away from the hollow cylinder such that the first end of the piston rod is located a first distance away from the hollow cylinder,
Clause 127. The seat assembly of clause 126, any other clause, or combination of clauses, wherein, in response to the first armrest being in the stowed position, the guided coil spring is in the engaged position in which the guide rod is retracted toward the hollow cylinder and the coil spring is compressed such that the first end of the guide rod is located a second distance away from the hollow cylinder, and wherein the first distance is greater than the second distance.
Clause 128. The seat assembly of clause 127, any other clause, or combination of clauses, wherein movement of the first armrest toward the stowed position progressively compresses the coil spring such that, in response to the first armrest having been moved away from the deployed position to the stowed position or any position between the stowed position and the deployed position, the compression of the coil spring biases the guided coil spring toward the starting position so as to bias the first armrest toward the deployed position.
Clause 129. The seat assembly of clause 128, any other clause, or combination of clauses, wherein the first armrest is configured to return to the deployed position via the biasing of the coil spring in response to a spring force of the coil spring being greater than a movement force being applied to the first armrest for moving the first armrest from the deployed position toward the stowed position.
Clause 130. An armrest assembly for a vehicle comprises a mounting bracket configured to be coupled to a seat frame assembly of the vehicle, a first armrest pivotably mounted on the mounting bracket and configured to be moved between a deployed position and a stowed position, the first armrest including a pivot rod extending through the mounting bracket so as to enable pivoting of the first armrest relative to the mounting bracket, and at least one of a first actuator or a first elastic member mounted on the pivot rod of the first armrest and configured to be mounted on at least one of the seat frame assembly of the vehicle or the mounting bracket, the at least one of the first actuator or the first elastic member configured to move the first armrest to the deployed position in response to the first armrest having been moved away from the deployed position to the stowed position or any position between the stowed position and the deployed position.
Clause 131. The armrest assembly of clause 130, any other clause, or combination of clauses, wherein the at least one of the first actuator or the first elastic member is movable between a starting position in which the first armrest is in the deployed position and an engaged position in which the first armrest is in the stowed position or any position between the stowed position and the deployed position.
Clause 132. The armrest assembly of clause 131, any other clause, or combination of clauses, wherein the at least one of the first actuator or the first elastic member is configured to generate a force on the first armrest in response to being in the engaged position as to bias the first armrest toward the deployed position.
Clause 133. The armrest assembly of clause 132, any other clause, or combination of clauses, wherein, in response to the force being greater than a movement force being applied to the first armrest for moving the first armrest from the deployed position toward the stowed position, the at least one of the first actuator or the first elastic member moves the first armrest into the deployed position.
Clause 134. The armrest assembly of clause 132, any other clause, or combination of clauses, wherein the pivot rod rotates in a first rotational direction in response to the first armrest moving toward the stowed position.
Clause 135. The armrest assembly of clause 134, any other clause, or combination of clauses, wherein the pivot rod rotates in a second rotational direction opposite the first rotational direction in response to the first armrest moving toward the deployed position.
Clause 136. The armrest assembly of clause 135, any other clause, or combination of clauses, wherein the at least one of the first actuator or the first elastic member is configured to generate the force on the first armrest in the second rotational direction in response to being in the engaged position as to bias the first armrest to the deployed position.
Clause 137. The armrest assembly of clause 136, any other clause, or combination of clauses, wherein the at least one of the first actuator or the first elastic member includes a gas spring.
Clause 138. The armrest assembly of clause 137, any other clause, or combination of clauses, wherein the gas spring includes a hollow cylinder, a piston arranged within the hollow cylinder and movable therein, and a piston rod coupled to the piston and extending outwardly away from the hollow cylinder.
Clause 139. The armrest assembly of clause 138, any other clause, or combination of clauses, wherein a first end of the piston rod is movably coupled to the piston and a second end of the piston rod opposite the first end is coupled to the pivot rod of the first armrest.
Clause 140. The armrest assembly of clause 139, any other clause, or combination of clauses, wherein the piston rod extends outwardly from a first end of the hollow cylinder.
Clause 141. The armrest assembly of clause 140, any other clause, or combination of clauses, wherein a second end of the hollow cylinder opposite the first end is movably coupled to the seat frame assembly.
Clause 142. The armrest assembly of clause 141, any other clause, or combination of clauses, wherein, in response to the first armrest being in the deployed position, the gas spring is in the starting position in which the piston rod is extended away from the hollow cylinder such that the second end of the piston rod is located a first distance away from the hollow cylinder.
Clause 143. The armrest assembly of clause 142, any other clause, or combination of clauses, wherein, in response to the first armrest being in the stowed position, the gas spring is in the engaged position in which the piston rod is compressed toward the hollow cylinder such that the second end of the piston rod is located a second distance away from the hollow cylinder, and wherein the first distance is greater than the second distance.
Clause 144. The armrest assembly of clause 143, any other clause, or combination of clauses, wherein movement of the first armrest toward the stowed position progressively compresses the second end of the piston rod toward the hollow cylinder such that, in response to the first armrest having been moved away from the deployed position to the stowed position or any position between the stowed position and the deployed position, the compression of the piston rod biases the piston rod toward the starting position so as to bias the first armrest toward the deployed position.
Clause 145. The armrest assembly of clause 144, any other clause, or combination of clauses, wherein the first armrest is configured to return to the deployed position via the biasing of the gas spring in response to a compression force of the gas spring being greater than a movement force being applied to the first armrest for moving the first armrest from the deployed position toward the stowed position.
Clause 146. A method comprises providing a seat frame assembly of a vehicle including a seat bottom frame and a seat back frame extending upwardly away from the seat bottom frame, the seat back frame including a first support bar, coupling a mounting bracket of a first armrest assembly to the first support bar of the seat back frame, pivotably mounting a first armrest of the first armrest assembly on the mounting bracket, the first armrest being configured to be moved between a deployed position and a stowed position, the first armrest including a pivot rod extending through the mounting bracket so as to enable pivoting of the first armrest relative to the mounting bracket, and mounting at least one of a first actuator or a first elastic member on the pivot rod of the first armrest and on at least one of the seat frame assembly or the mounting bracket, the at least one of a first actuator or a first elastic member configured to move the first armrest to the deployed position in response to the first armrest having been moved away from the deployed position to the stowed position or any position between the stowed position and the deployed position.
Clause 147. A seat assembly for a vehicle comprises a seat frame assembly, and a first armrest assembly coupled to the seat frame assembly and including a first armrest pivotably mounted on the seat frame assembly and configured to be moved between a deployed position and a stowed position, the first armrest assembly further including at least one of a first actuator or a first elastic member mounted on the first armrest and on the seat frame assembly.
Clause 148. The seat assembly of clause 147, any other clause, or combination of clauses, wherein the at least one of the first actuator or the first elastic member configured to move the first armrest to the deployed position in response to the first armrest having been moved away from the deployed position to the stowed position or any position between the stowed position and the deployed position.
Clause 149. The seat assembly of clause 148, any other clause, or combination of clauses, wherein the seat frame assembly includes a seat bottom frame and a seat back frame extending upwardly away from the seat bottom frame, the seat back frame including a first support bar,
Clause 150. The seat assembly of clause 149, any other clause, or combination of clauses, wherein the first armrest assembly further includes a mounting bracket coupled to the first support bar of the seat back frame, the first armrest being pivotably mounted on the mounting bracket, the first armrest including a pivot rod extending through the mounting bracket so as to enable pivoting of the first armrest relative to the mounting bracket.
Clause 151. The seat assembly of clause 150, any other clause, or combination of clauses, wherein the at least one of the first actuator or the first elastic member is movable between a starting position in which the first armrest is in the deployed position and an engaged position in which the first armrest is in the stowed position or any position between the stowed position and the deployed position.
Clause 152. The seat assembly of clause 151, any other clause, or combination of clauses, wherein the at least one of the first actuator or the first elastic member is configured to generate a force on the first armrest in response to being in the engaged position as to bias the first armrest toward the deployed position.
Clause 153. The seat assembly of clause 152, any other clause, or combination of clauses, wherein, in response to the force being greater than a movement force being applied to the first armrest for moving the first armrest from the deployed position toward the stowed position, the at least one of the first actuator or the first elastic member moves the first armrest into the deployed position.
Clause 154. The seat assembly of clause 153, any other clause, or combination of clauses, wherein the pivot rod rotates in a first rotational direction in response to the first armrest moving toward the stowed position
Clause 155. The seat assembly of clause 154, any other clause, or combination of clauses, wherein the pivot rod rotates in a second rotational direction opposite the first rotational direction in response to the first armrest moving toward the deployed position.
Clause 156. The seat assembly of clause 155, any other clause, or combination of clauses, wherein the at least one of the first actuator or the first elastic member is configured to generate the force on the first armrest in the second rotational direction in response to being in the engaged position as to bias the first armrest to the deployed position.
Clause 157. A vehicle system comprises a seat assembly including a seat frame assembly, a first armrest assembly coupled to the seat frame assembly and including a first armrest pivotably mounted on the seat frame assembly and configured to be moved between a deployed position and a stowed position, the first armrest assembly further including a first actuator mounted on the first armrest and on the seat frame assembly, and a control system including a controller operably connected to the first actuator and configured to control the first actuator.
Clause 158. The vehicle system of clause 157, any other clause, or combination of clauses, wherein the controller is configured to control the first actuator so as to move the first armrest to the deployed position in response to the first armrest having been moved away from the deployed position to the stowed position or any position between the stowed position and the deployed position.
Clause 159. The vehicle system of clause 158, any other clause, or combination of clauses, wherein the first actuator is movable between a starting position in which the first armrest is in the deployed position and an engaged position in which the first armrest is in the stowed position or any position between the stowed position and the deployed position.
Clause 160. The vehicle system of clause 159, any other clause, or combination of clauses, wherein the first actuator includes at least one of a gas spring, a linear actuator, or a motor.
Clause 161. The vehicle system of clause 160, any other clause, or combination of clauses, wherein the first actuator is a gas spring, and wherein the gas spring includes a switch operably connected to the controller and configured to control movement of gas spring between and including the starting position and the engaged position.
Clause 162. The vehicle system of clause 161, any other clause, or combination of clauses, wherein the first actuator is a linear actuator, and wherein the linear actuator is one of mechanical, pneumatic, hydraulic, or electric.
Clause 163. The vehicle system of clause 160, any other clause, or combination of clauses, wherein the seat assembly further includes at least one sensor.
Clause 164. The vehicle system of clause 163, any other clause, or combination of clauses, wherein the at least one sensor includes at least one of (i) a force sensor configured to measure a movement force being applied to the first armrest for moving the first armrest from the deployed position toward the stowed position or (ii) a rotary position sensor configured to measure a rotational position of at least one of the pivot rod or the first armrest so as to determine whether the first armrest has been moved away from the deployed position toward the stowed position.
Clause 165. The vehicle system of clause 164, any other clause, or combination of clauses, wherein the controller is configured to control the first actuator in response to the first armrest having been moved away from the deployed position to the stowed position or any position between the stowed position and the deployed position via application of the movement force and in response to the movement force being applied to the first armrest being less than a predetermined force value as detected by the force sensor such that the first actuator moves the first armrest back to the deployed position.
Clause 166. The vehicle system of clause 165, any other clause, or combination of clauses, wherein the controller is configured to automatically control the first actuator to return the first armrest back to the deployed position in response to the movement force being less than the predetermined force value.
Clause 167. The vehicle system of clause 164, any other clause, or combination of clauses, wherein the controller is configured to control the first actuator in response to the rotary position sensor detecting that the first armrest has been moved away from the deployed position to the stowed position or any position between the stowed position and the deployed position such that the first actuator moves the first armrest back to the deployed position.
Clause 168. The vehicle system of clause 167, any other clause, or combination of clauses, wherein the seat assembly further includes a touch sensor arranged in the armrest and configured to detect whether an occupant is touching the armrest.
Clause 169. The vehicle system of clause 168, any other clause, or combination of clauses, wherein the controller is configured to automatically control the first actuator to return the first armrest back to the deployed position in response to the first armrest having been moved away from the deployed position to the stowed position or any position between the stowed position and the deployed position and the touch sensor detecting that the occupant has not touched the first armrest for a predetermined period of time.
Clause 170. The vehicle system of clause 159, any other clause, or combination of clauses, wherein the seat assembly further includes at least one sensor configured to detect whether an occupant is seated on the seat frame assembly and within an outer boundary of a seating area of the seat assembly that is delimited at least in part by the first armrest.
Clause 171. The vehicle system of clause 170, any other clause, or combination of clauses, wherein the controller is configured to control the first actuator in response to the first armrest having been moved away from the deployed position to the stowed position or any position between the stowed position and the deployed position and in response to the at least one sensor detecting that an occupant is seated on the seat assembly and within the outer boundary of the seating area such that the first actuator moves the first armrest back to the deployed position.
Clause 172. The vehicle system of clause 171, any other clause, or combination of clauses, wherein the controller is configured to automatically control the first actuator to return the first armrest back to the deployed position in response to the at least one sensor detecting that an occupant is seated on the seat assembly and within the outer boundary of the seating area.
at least one of an engine ignition switch or a drivetrain,
Clause 173. The vehicle system of clause 170, any other clause, or combination of clauses, further comprising at least one of an engine ignition switch or a drivetrain.
Clause 174. The vehicle system of clause 173, any other clause, or combination of clauses, wherein the controller is operably connected to the at least one of the engine ignition switch or the drivetrain.
Clause 175. The vehicle system of clause 174, any other clause, or combination of clauses, wherein the controller is configured to restrict at least one of a switching capability of the engine ignition switch or restrict selective engagement of the drivetrain in response to the first armrest having been moved away from the deployed position to the stowed position or any position between the stowed position and the deployed position, and is further configured to enable at least one of the switching capability of the engine ignition switch or selective engagement of the drivetrain in response to the first armrest having been moved from the stowed position or any position between the stowed position and the deployed position to the deployed position via the controller actuating the first actuator.
Clause 176. The vehicle system of clause 175, any other clause, or combination of clauses, wherein the at least one sensor includes at least one of a camera, a pressure sensor configured to detect pressure of the occupant being seated on the seat assembly, a laser, an RFID chip, an infrared sensor, a proximity sensor, an image recognition, an acoustic sensor, or a vibratory sensor.
Clause 177. A method comprises providing a seat assembly including a seat frame assembly and a first armrest assembly, coupling the first armrest assembly to the seat frame assembly, the first armrest assembly including a first armrest pivotably mounted on the seat frame assembly and configured to be moved between a deployed position and a stowed position, the first armrest assembly further including a first actuator mounted on the first armrest and on the seat frame assembly, operably connecting a control system including a controller to the first actuator, the controller configured to control the first actuator, moving the first armrest away from the deployed position to the stowed position or any position between the stowed position and the deployed position; and controlling, via the controller, the first actuator so as to move the first armrest to the deployed position in response to the first armrest having been moved away from the deployed position to the stowed position or any position between the stowed position and the deployed position.
Clause 178. The method of clause 176, any other clause, or combination of clauses, further comprising controlling, via the controller, the first actuator in response to the first armrest having been moved away from the deployed position to the stowed position or any position between the stowed position and the deployed position and in response to a movement force being applied to the first armrest for moving the first armrest from the deployed position toward the stowed position being less than a predetermined force value such that the first actuator moves the first armrest back to the deployed position.
Clause 179. The method of clause 178, any other clause, or combination of clauses, further comprising controlling, via the controller, the first actuator in response to the first armrest having been moved away from the deployed position to the stowed position or any position between the stowed position and the deployed position and in response to at least one sensor detecting that an occupant is seated on the seat assembly and within an outer boundary of a seating area such that the first actuator moves the first armrest back to the deployed position.
Clause 180. The method of clause 179, any other clause, or combination of clauses, further comprising operably connecting the controller to the at least one of an engine ignition switch or a drivetrain of a vehicle, restricting, via the controller, at least one of a switching capability of the engine ignition switch or selective engagement of the drivetrain in response to the first armrest having been moved away from the deployed position to the stowed position or any position between the stowed position and the deployed position, and enabling, via the controller, at least one of the switching capability of the engine ignition switch or selective engagement of the drivetrain in response to the first armrest having been moved from the stowed position or any position between the stowed position and the deployed position to the deployed position via the controller actuating the first actuator.
Clause 181. A vehicle system comprises at least one of an engine ignition switch or a drivetrain of a vehicle, a seat assembly including, a seat frame assembly, a first armrest assembly coupled to the seat frame assembly and including a first armrest pivotably mounted on the seat frame assembly and configured to be moved between a deployed position and a stowed position, the first armrest assembly further including at least one sensor configured to detect whether the first armrest is in the deployed position or not in the deployed position, and a control system including a controller operably connected to the at least one sensor and operably connected to the at least one of the engine ignition switch or the drivetrain of the vehicle.
Clause 182. The vehicle system of clause 181, any other clause, or combination of clauses, wherein the controller is configured to restrict at least one of a switching capability of the engine ignition switch or restrict selective engagement of the drivetrain in response to the at least one sensor detecting that the first armrest having been moved away from the deployed position to the stowed position or any position between the stowed position and the deployed position, and is further configured to enable at least one of the switching capability of the engine ignition switch or selective engagement of the drivetrain in response to the first armrest having been moved from the stowed position or any position between the stowed position and the deployed position to the deployed position.
Clause 183. A seat assembly for a vehicle comprises a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket, wherein the first armrest assembly further includes a gas spring mounted on the pivot rod of the first armrest and on at least one of the seat frame assembly or the mounting bracket, the gas spring configured to move the first armrest to the deployed position in response to the first armrest having been moved away from the deployed position to the stowed position or any position between the stowed position and the deployed position.
Clause 184. A seat assembly for a vehicle comprises a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket, wherein the first armrest assembly further includes a linear actuator mounted on the pivot rod of the first armrest and on at least one of the seat frame assembly or the mounting bracket, the linear actuator configured to move the first armrest to the deployed position in response to the first armrest having been moved away from the deployed position to the stowed position or any position between the stowed position and the deployed position.
Clause 185. A seat assembly for a vehicle comprises a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket, wherein the first armrest assembly further includes a rotary motor mounted on the pivot rod of the first armrest and on at least one of the seat frame assembly or the mounting bracket, the rotary motor configured to move the first armrest to the deployed position in response to the first armrest having been moved away from the deployed position to the stowed position or any position between the stowed position and the deployed position.
Clause 186. A seat assembly for a vehicle comprises a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket, wherein the first armrest assembly further includes a tension spring mounted on the pivot rod of the first armrest and on at least one of the seat frame assembly or the mounting bracket, the tension spring configured to move the first armrest to the deployed position in response to the first armrest having been moved away from the deployed position to the stowed position or any position between the stowed position and the deployed position.
Clause 186. A seat assembly for a vehicle comprises a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket, wherein the first armrest assembly further includes a torsion spring mounted on the pivot rod of the first armrest and on at least one of the seat frame assembly or the mounting bracket, the torsion spring configured to move the first armrest to the deployed position in response to the first armrest having been moved away from the deployed position to the stowed position or any position between the stowed position and the deployed position.
Clause 187. A seat assembly for a vehicle comprises a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket, wherein the first armrest assembly further includes a clock spring mounted on the pivot rod of the first armrest and on at least one of the seat frame assembly or the mounting bracket, the clock spring configured to move the first armrest to the deployed position in response to the first armrest having been moved away from the deployed position to the stowed position or any position between the stowed position and the deployed position.
Clause 188. A seat assembly for a vehicle comprises a seat frame assembly including a seat bottom frame and a seat back frame extending upwardly away from the seat bottom frame, the seat back frame including a first support bar, and a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket, wherein the first armrest assembly further includes a guided coil spring mounted on the pivot rod of the first armrest and on at least one of the seat frame assembly or the mounting bracket, the guided coil spring configured to move the first armrest to the deployed position in response to the first armrest having been moved away from the deployed position to the stowed position or any position between the stowed position and the deployed position.
Clause 189. A seat assembly for a vehicle comprises a seat frame assembly including a seat bottom frame and a seat back frame extending upwardly away from the seat bottom frame, and a first armrest assembly coupled to the seat frame assembly and including a mounting bracket coupled to the seat bottom frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket, wherein the first armrest assembly further includes at least one of a first actuator or a first elastic member mounted on the pivot rod of the first armrest and on at least one of the seat frame assembly or the mounting bracket, the at least one of the first actuator or the first elastic member configured to move the first armrest to the deployed position in response to the first armrest having been moved away from the deployed position to the stowed position or any position between the stowed position and the deployed position.
Clause 190. The seat assembly of clause 189, any other clause, or combination of clauses, wherein the seat bottom frame includes a first support bar and a first support post that extends upwardly away from the seat bottom frame, and wherein the mounting bracket is arranged on the first support post.
Clause 191. The seat assembly of clause 190, any other clause, or combination of clauses, wherein the first support post includes a first portion that extends generally horizontally away from the first support bar of the seat bottom frame and a vertical portion that extends upwardly away from a terminal end of the first portion.
Clause 192. The seat assembly of clause 191, any other clause, or combination of clauses, wherein the vertical portion is parallel with the seat back frame.

1. A seat assembly for a vehicle, comprising:
a seat frame assembly including a seat bottom frame and a seat back frame extending upwardly away from the seat bottom frame, the seat back frame including a first support bar; and
a first armrest assembly coupled to the seat frame assembly and including a mounting bracket coupled to the first support bar of the seat back frame and a first armrest pivotably mounted on the mounting bracket and configured to be moved between a deployed position and a stowed position, the first armrest including a pivot rod extending through the mounting bracket so as to enable pivoting of the first armrest relative to the mounting bracket,
wherein the first armrest assembly further includes at least one of a first actuator or a first elastic member mounted on the pivot rod of the first armrest and on at least one of the seat frame assembly or the mounting bracket, the at least one of the first actuator or the first elastic member configured to move the first armrest to the deployed position in response to the first armrest having been moved away from the deployed position to the stowed position or any position between the stowed position and the deployed position.

2. The seat assembly of claim 1, wherein the at least one of the first actuator or the first elastic member is movable between a starting position in which the first armrest is in the deployed position and an engaged position in which the first armrest is in the stowed position or any position between the stowed position and the deployed position.

3. The seat assembly of claim 2, wherein the at least one of the first actuator or the first elastic member is configured to generate a force on the first armrest in response to being in the engaged position as to bias the first armrest toward the deployed position, and wherein, in response to the force being greater than a movement force being applied to the first armrest for moving the first armrest from the deployed position toward the stowed position, the at least one of the first actuator or the first elastic member moves the first armrest into the deployed position.

4. The seat assembly of claim 3, wherein the pivot rod rotates in a first rotational direction in response to the first armrest moving toward the stowed position, and wherein the pivot rod rotates in a second rotational direction opposite the first rotational direction in response to the first armrest moving toward the deployed position.

5. The seat assembly of claim 4, wherein the at least one of the first actuator or the first elastic member is configured to generate the force on the first armrest in the second rotational direction in response to being in the engaged position as to bias the first armrest to the deployed position.

6. The seat assembly of claim 1, wherein the at least one of the first actuator or the first elastic member includes a gas spring.

7. The seat assembly of claim 6, wherein the gas spring includes a hollow cylinder, a piston arranged within the hollow cylinder and movable therein, and a piston rod coupled to the piston and extending outwardly away from the hollow cylinder.

8. The seat assembly of claim 7, wherein the first armrest is configured to return to the deployed position via the biasing of the gas spring in response to a compression force of the gas spring being greater than a movement force being applied to the first armrest for moving the first armrest from the deployed position toward the stowed position.

9. The seat assembly of claim 1, wherein the pivot rod further includes a connection plate, wherein a first end of the connection plate is coupled to and extends radially away from the pivot rod, wherein the first actuator or the first elastic member includes a first end and a second end opposite the first end, wherein the second end of the first actuator or the first elastic member is spaced apart in a rearward direction from the pivot rod, and wherein the connection plate further includes a second end opposite the first end that is coupled to the second end of the first actuator or the first elastic member.

10. The seat assembly of claim 9, wherein the second end of the first actuator or the first elastic member is pivotably coupled to the second end of the connection plate so as to enable to the connection plate to pivot relative to the first actuator or the first elastic member during movement of the first armrest between the deployed and stowed positions.

11. The seat assembly of claim 1, wherein the mounting bracket includes a first wall, a second wall spaced apart from the first wall, and a forward wall extending between and interconnecting the first and second walls, and wherein the first support bar of the seat back frame is coupled to at least one of the first and second walls.

12. The seat assembly of claim 11, wherein the first support bar of the seat back frame extends between the first and second walls and is coupled to both of the first and second walls so as to couple the mounting bracket to the seat back frame.

13. The seat assembly of claim 12, wherein the first and second walls include corresponding openings formed therethrough, and wherein the pivot rod of the first armrest extends through the openings of the first and second walls such that the first armrest is configured to pivot relative to the mounting bracket.

14. An armrest assembly for a vehicle, comprising:
a mounting bracket configured to be coupled to a seat frame assembly of the vehicle;
a first armrest pivotably mounted on the mounting bracket and configured to be moved between a deployed position and a stowed position, the first armrest including a pivot rod extending through the mounting bracket so as to enable pivoting of the first armrest relative to the mounting bracket; and
at least one of a first actuator or a first elastic member mounted on the pivot rod of the first armrest and configured to be mounted on at least one of the seat frame assembly of the vehicle or the mounting bracket, the at least one of the first actuator or the first elastic member configured to move the first armrest to the deployed position in response to the first armrest having been moved away from the deployed position to the stowed position or any position between the stowed position and the deployed position.

15. The armrest assembly of claim 14, wherein the at least one of the first actuator or the first elastic member is configured to generate a force on the first armrest in response to being in the engaged position as to bias the first armrest toward the deployed position, and wherein, in response to the force being greater than a movement force being applied to the first armrest for moving the first armrest from the deployed position toward the stowed position, the at least one of the first actuator or the first elastic member moves the first armrest into the deployed position.

16. The armrest assembly of claim 15, wherein the at least one of the first actuator or the first elastic member includes a gas spring, and wherein the first armrest is configured to return to the deployed position via the biasing of the gas spring in response to a compression force of the gas spring being greater than a movement force being applied to the first armrest for moving the first armrest from the deployed position toward the stowed position.

17. The armrest assembly of claim 15, wherein the at least one of the first actuator or the first elastic member includes a linear actuator, wherein the linear actuator includes a hollow cylinder, a piston rod extending outwardly away from the hollow cylinder, and a motor configured to move the piston rod away from and toward the hollow cylinder, and wherein the motor is operably connected to the piston rod and is configured to selectively move the piston rod away from and toward the hollow cylinder, and wherein, in response to the first armrest having been moved away from the deployed position to the stowed position or any position between the stowed position and the deployed position, the motor is configured to move the piston rod away from the hollow cylinder until the first armrest returns to the deployed position.

18. The armrest assembly of claim 15, wherein the at least one of the first actuator or the first elastic member includes a tension spring, wherein a first end of the tension spring is coupled to the seat back frame and a second end of the tension spring opposite the first end is coupled to a connection plate that is coupled to and extends radially away from the pivot rod, and wherein, in response to the first armrest being in the deployed position, the tension spring is in the starting position in which the spring is at rest and a first connection point at which the first end of the tension spring is coupled to the seat back frame is a first distance from a second connection point at which the second end of the tension spring is coupled to the connection plate, wherein, in response to the first armrest being in the stowed position, the tension spring is in the engaged position in which the tension spring is stretched such that the first connection point is located a second distance away from the first connection point, and wherein the first distance is less than the second distance.

19. The armrest assembly of claim 15, wherein the at least one of the first actuator or the first elastic member includes a torsion spring, wherein the torsion spring includes a central coil that is wrapped around the pivot rod and includes a first end and a second end opposite the first end, and wherein the first armrest is configured to return to the deployed position via the biasing of the torsion spring in response to a spring force of the torsion spring being greater than a movement force being applied to the first armrest for moving the first armrest from the deployed position toward the stowed position.

20. A method, comprising:
providing a seat frame assembly of a vehicle including a seat bottom frame and a seat back frame extending upwardly away from the seat bottom frame, the seat back frame including a first support bar;
coupling a mounting bracket of a first armrest assembly to the first support bar of the seat back frame;
pivotably mounting a first armrest of the first armrest assembly on the mounting bracket, the first armrest being configured to be moved between a deployed position and a stowed position, the first armrest including a pivot rod extending through the mounting bracket so as to enable pivoting of the first armrest relative to the mounting bracket; and
mounting at least one of a first actuator or a first elastic member on the pivot rod of the first armrest and on at least one of the seat frame assembly or the mounting bracket, the at least one of a first actuator or a first elastic member configured to move the first armrest to the deployed position in response to the first armrest having been moved away from the deployed position to the stowed position or any position between the stowed position and the deployed position.
